(19) United States
(12) Patent Application Publication
(10) Pub. No.: US 2026/0216954 A1
(43) Pub. Date: Jul. 30, 2026

(54) METHODS FOR FABRICATING FIBER-REINFORCED ADDITIVELY MANUFACTURED OBJECTS

(71) Applicant: Align Technology, Inc., San Jose, CA (US)

(72) Inventors: Jan Bornemann, Wien (AT); Yan Chen, Cupertino, CA (US); Umesh Upendra Choudhary, Scotts Valley, CA (US); Jun Sato, San Jose, CA (US); Jürgen Stampfl, Wien (AT); John Y. Morton, San Jose, CA (US); Yuxiang Wang, Newark, CA (US)

(21) Appl. No.: 19/465,840

(22) Filed: Jan. 30, 2026

Related U.S. Application Data
(60) Provisional application No. 63/751,461, filed on Jan. 30, 2025.
(60) Provisional application No. 63/836,080, filed on Jun. 30, 2025.
(60) Provisional application No. 63/836,098, filed on Jun. 30, 2025.
(60) Provisional application No. 63/912,824, filed on Nov. 6, 2025.

(51) Int. Cl. B29C 64/165; A61C 13/00; B29C 64/124; B29C 64/277; B29C 64/314; B29K 309/08; B29L 31/00; B33Y 10/00; B33Y 30/00; B33Y 40/10; B33Y 80/00

(52) U.S. Cl. CPC B29C 64/165; A61C 13/0019; B29C 64/124; B29C 64/277; B29C 64/314; B33Y 10/00; B33Y 30/00; B33Y 40/10; B33Y 80/00; B29K 2309/08; B29K 2995/0056; B29L 2031/753

(57) ABSTRACT

Fiber-reinforced additively manufactured objects and associated systems and methods are provided herein. A method can include depositing a curable material. The method can further include applying first energy to the curable material to form an object portion on a build platform. The method can further include depositing a fiber onto or into the object portion, where the fiber is optically transparent and biocompatible. The method can further include applying second energy to the fiber to affix the fiber to the object portion.

### CROSS-REFERENCE TO RELATED APPLICATION(S)

The present application claims the benefit of priority to U.S. Provisional Application No. 63/751,461, filed Jan. 30, 2025, U.S. Provisional Application No. 63/836,080, filed Jun. 30, 2025, U.S. Provisional Application No. 63/836,098, filed Jun. 30, 2025, and U.S. Provisional Application No. 63/912,824, filed Nov. 6, 2025, the disclosures of which are incorporated by reference herein in their entirety.

### TECHNICAL FIELD

The present technology generally relates to additive manufacturing, and in particular, to fiber-reinforced additively manufactured objects.

### BACKGROUND

Additive manufacturing encompasses a variety of technologies that involve building up 3D objects from multiple layers of material. However, conventional additive manufacturing techniques may not be capable of producing objects with sufficient mechanical properties for certain applications. For instance, stress relaxation can be a significant issue for additively manufactured dental appliances since these components are exposed to the warm, humid environment of the oral cavity for prolonged periods. Fiber reinforcement offers one approach to producing parts with improved mechanical properties. However, conventional extrusion-based systems for fiber reinforcement typically have poor surface quality and low feature resolution.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a partially schematic diagram providing a general overview of an additive manufacturing process, in accordance with embodiments of the present technology.

FIG. 2 is a partially schematic diagram providing a general overview of system for fabricating fiber-reinforced objects, in accordance with embodiments of the present technology.

FIGS. 3A-3D illustrate a representative example of a system for fabricating fiber-reinforced objects, in accordance with embodiments of the present technology.

FIG. 4 illustrates a representative example of a system for fabricating fiber-reinforced objects, in accordance with embodiments of the present technology.

FIG. 5 illustrates a representative example of a system for fabricating fiber-reinforced objects, in accordance with embodiments of the present technology.

FIG. 6 is a flow diagram illustrating a method for fabricating a fiber-reinforced object, in accordance with embodiments of the present technology.

FIG. 7 is a flow diagram illustrating a method for fabricating a fiber-reinforced dental appliance, in accordance with embodiments of the present technology.

FIG. 8A is a representative example of an object portion including a material matrix reinforced by a plurality of fibers, in accordance with embodiments of the present technology.

FIG. 8B is a closeup view of an individual fiber of FIG. 8A, in accordance with embodiments of the present technology.

FIGS. 9A and 9B illustrate an example dental appliance configured in accordance with embodiments of the present technology.

FIG. 10 illustrates an example dental appliance configured in accordance with embodiments of the present technology.

FIGS. 11A-11C illustrate example dental appliances configured in accordance with embodiments of the present technology.

FIG. 12 illustrates another example dental appliance configured in accordance with embodiments of the present technology.

FIG. 13 illustrates a portion of another example dental appliance configured in accordance with embodiments of the present technology.

FIGS. 14A and 14B illustrate another example dental appliance configured in accordance with embodiments of the present technology.

FIG. 14C illustrates another example dental appliance configured in accordance with embodiments of the present technology.

FIGS. 15A and 15B illustrate additional examples of dental appliances configured in accordance with embodiments of the present technology.

FIG. 16 illustrates a portion of another example dental appliance configured in accordance with embodiments of the present technology.

FIG. 17 illustrates another example dental appliance configured in accordance with embodiments of the present technology.

FIGS. 18A-18E illustrate an example attachment placement appliance configured in accordance with embodiments of the present technology.

FIG. 19A illustrates an example dental appliance configured in accordance with embodiments of the present technology.

FIG. 19B illustrates another example of a projection that can be included in the dental appliance of FIG. 19A, in accordance with embodiments of the present technology.

FIG. 20 illustrates an example dental appliance configured in accordance with embodiments of the present technology.

FIGS. 21A-21C illustrate example palatal expanders configured in accordance with embodiments of the present technology.

FIG. 22 illustrates another example dental appliance configured in accordance with embodiments of the present technology.

FIG. 23 illustrates another example dental appliance configured in accordance with embodiments of the present technology.

FIG. 24 illustrates a portion of another example dental appliance configured in accordance with embodiments of the present technology.

FIG. 25 illustrates a portion of an example dental appliance configured in accordance with embodiments of the present technology.

FIG. 26 illustrates an example palatal expander configured in accordance with embodiments of the present technology.

FIGS. 27A-27D illustrate examples of 3D structures composed of a plurality of interwoven fibers, in accordance with embodiments of the present technology.

FIG. 28A illustrates an example dental appliance coupled to a plurality of support structures configured in accordance with embodiments of the present technology.

FIG. 28B is a close-up view of the support structures of FIG. 28A.

FIG. 29A illustrates a representative example of a tooth repositioning appliance configured in accordance with embodiments of the present technology.

FIG. 29B illustrates a tooth repositioning system including a plurality of appliances, in accordance with embodiments of the present technology.

FIG. 29C illustrates a method of orthodontic treatment using a plurality of appliances, in accordance with embodiments of the present technology.

FIG. 30 illustrates a method for designing an orthodontic appliance, in accordance with embodiments of the present technology.

FIG. 31 illustrates a method for digitally planning an orthodontic treatment and/or design or fabrication of an appliance, in accordance with embodiments of the present technology.

FIGS. 32A and 32B are graphs illustrating the stress relaxation of coupons having varying fiber content.

FIG. 33 is a graph illustrating the stress-strain response of coupons having varying fiber content.

### DETAILED DESCRIPTION

The present technology relates to fiber-reinforced additively manufactured objects and associated systems and methods. In some embodiments, for example, a dental appliance (e.g., an aligner, retainer, palatal expander, attachment placement device) is provided. The dental appliance can include a shell composed of a plurality of additively manufactured layers (e.g., polymeric layers). The shell can include a plurality of cavities shaped to receive a patient's dentition. The dental appliance can also include a fiber coupled to a portion of the shell to reinforce the portion. The fiber may have a desired length. For instance, the fiber may have a desired length that exceeds a predetermined length to effectively strengthen or stiffen a material matrix of the portion of the shell. In some embodiments, the fiber has a length greater than or equal to 5 mm. The fiber may be composed of a material that is optically transparent. Further, the fiber may be biocompatible, e.g., the fiber may be used in an oral environment with substantially no adverse effects on the patient.

In some embodiments, a system for additive manufacturing includes a material source configured to deposit a curable material (e.g., a resin). The curable material may be deposited on a substrate, such as a carrier film. The system can further include a first energy source configured to apply first energy to the curable material to form an object portion (e.g., an object layer) on a build platform (e.g., according to an additive manufacturing process). The system can further include a fiber source configured to deposit a fiber (e.g., a biocompatible glass fiber) onto and/or into the object portion. In some embodiments, the fiber is a continuous fiber. The system can further include a second energy source configured to apply second energy to affix the fiber to the object portion. The system can be configured to repeat this process to build up a fiber-reinforced object, where fiber is selectively positioned within and/or across one or more object portions. In some embodiments, the fiber-reinforced object is a dental appliance, and the fiber improves the mechanical properties of the dental appliance.

As another example, a method of the present technology can include depositing a curable material (e.g., a resin). The curable material can be deposited on a substrate, such as a carrier film. The method can further include applying first energy to the curable material to form an object portion (e.g., an object layer) on a build platform (e.g., according to an additive manufacturing process). The method can further include depositing a fiber (e.g., a biocompatible glass fiber) onto and/or into the object portion. In some embodiments, the fiber is a continuous fiber. The method can further include applying second energy to the fiber to affix the fiber to the object portion. This process can be repeated to build up a fiber-reinforced object, where fiber is selectively positioned within and/or across one or more object portions. In some embodiments, the fiber-reinforced object is a dental appliance, and the fiber improves the mechanical properties of the dental appliance.

As a further example, a method of the present technology can include fabricating a plurality of additive manufacturing layers to form a portion of an appliance shell (e.g., of a dental appliance). The appliance shell may include a plurality of cavities shaped to receive a patient's dentition. The method may further include fabricating a fiber coupled to the portion of the appliance shell to reinforce the portion. The fiber may have a desired length. For instance, the fiber may have a desired length that exceeds a predetermined length to effectively strengthen or stiffen a material matrix of the portion of the shell. In some embodiments, the fiber has a length greater than or equal to 5 mm. The fiber may be composed of a material that is optically transparent. Further, the fiber may be biocompatible, e.g., the fiber may be used in an oral environment with substantially no adverse effects on the patient.

The present technology can provide numerous advantages compared to conventional additively manufactured objects and associated systems and methods. For example, objects produced using conventional stereolithography systems for additive manufacturing may have high surface quality and excellent feature resolution, but limited mechanical properties. Fiber reinforcement can improve mechanical properties, but conventional systems for fiber-based additive manufacturing also exhibit shortcomings. Such systems are generally based on a fused deposition modeling (FDM) or fused filament fabrication (FFF) process, whereby a thermoplastic material is applied to a build platform using a heated nozzle and a second nozzle deposits a continuous fiber coated with matrix material onto the surface of the component. In addition to FDM/FFF-based systems, there are also systems that use a liquid resin as the matrix material. Generally, only one nozzle is used to apply the matrix material together with the continuous fiber on a build platform. The resin is cured by light or heat, forming the fiber-reinforced component layer by layer. In these systems, the geometry of the component is produced by extruding the material, which typically results in poor surface quality and low feature resolution.

To overcome these and other challenges, the present technology provides fiber-reinforced additively manufactured objects and associated systems and methods, in which the fabrication of the object is carried out primarily or entirely by an additive manufacturing process (e.g., stereolithography), and the fiber is selectively introduced to increase the strength of the object. The fiber may be introduced using a fiber system that feeds, cuts, infiltrates, and/or affixes the fibers to the object portion or build platform. For instance, the fiber system may include a fiber source having an angled nozzle outlet and an energy source (e.g., a laser) positioned substantially vertically relative to the build surface, which may improve precision. The systems and methods described herein can be used to provide additively manufactured objects (e.g., dental appliances) with improved mechanical properties, higher surface quality, and/or higher feature resolution.

Moreover, the additively manufactured objects described herein can use fibers that are sufficiently long to effectively increase the strength, stiffness, and/or creep resistance of the surrounding material. In particular, the use of long, continuous fibers as described herein allow a significant amount of the stresses applied to the surrounding material to be guided into the fiber, in contrast to devices using chopped, disconnected short fibers that only allow limited stress transfer and thus provide suboptimal reinforcement. Short fibers may also be prone to leaving fiber fragments that protrude out of the external surface of the objects, which may irritate oral tissue in the case of dental appliances. Moreover, the fibers described herein can be composed of biocompatible and optically transparent materials (e.g., biocompatible glass) that can be produced economically in a wide variety of lengths and diameters, thus providing mechanical reinforcement without presenting substantial adverse effects to the oral cavity and without compromising the aesthetics of objects such as transparent dental appliances.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Additive Manufacturing Systems and Methods for Fiber Reinforcement

The present technology relates to fiber-reinforced additively manufactured objects and associated systems and methods. In some embodiments, for example, a system for additively manufacturing fiber-reinforced objects includes a material source for depositing a curable material (e.g., a resin) and a fiber source for depositing a fiber (e.g., a biocompatible glass fiber). In some examples, the curable material can be at least partially cured to form an object portion using a first energy source, and the fiber source may deposit the fiber onto and/or into the object portion. Further, the fiber can be affixed to the object portion using a second energy source. As used herein, a fiber can refer to a single fiber filament, a fiber strand including a plurality of fiber filaments, and/or a plurality of fiber strands.

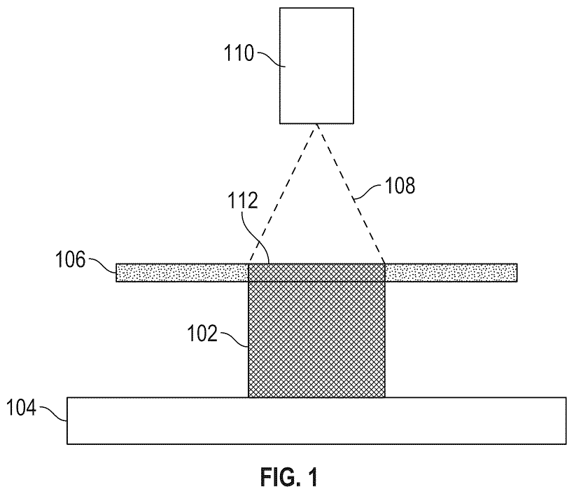

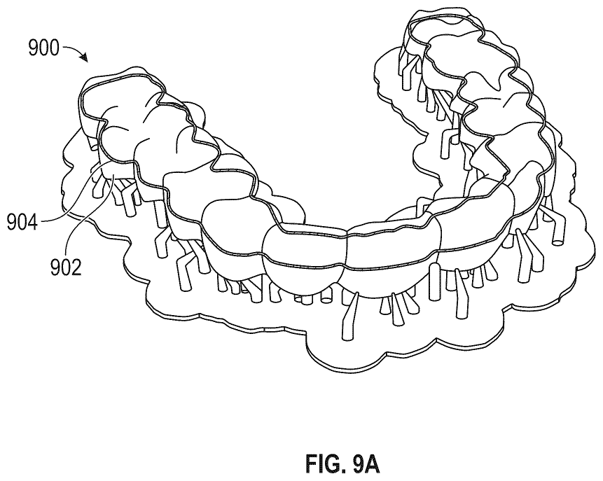

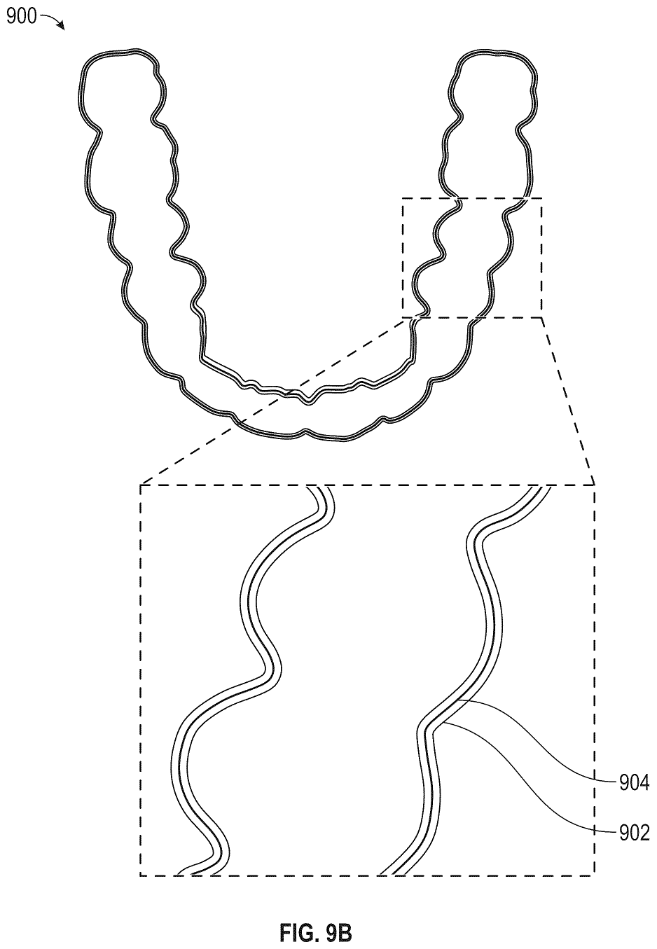

FIG. 1 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described with respect to FIGS. 9A-26 and in Section III below.

In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

For example, in the embodiment of FIG. 1, an object 102 is fabricated on a build platform 104 from a series of cured material layers, with each layer having a geometry corresponding to a respective cross-section of the object 102. To fabricate an individual object layer, a layer of curable material 106 (e.g., polymerizable resin) is brought into contact with the build platform 104 (when fabricating the first layer of the object 102) or with the previously formed portion of the object 102 on the build platform 104 (when fabricating subsequent layers of the object 102). In some embodiments, the curable material 106 is formed on and supported by a substrate (not shown), such as a film. Energy 108 (e.g., light) from an energy source 110 (e.g., a laser, projector, or light engine) is then applied to the curable material 106 to form a cured material layer 112 on the build platform 104 or on the object 102. The remaining curable material 106 can then be moved away from the build platform 104 (e.g., by lowering the build platform 104, by moving the build platform 104 laterally, by raising the curable material 106, and/or by moving the curable material 106 laterally), thus leaving the cured material layer 112 in place on the build platform 104 and/or object 102. The fabrication process can then be repeated with a fresh layer of curable material 106 to build up the next layer of the object 102.

The illustrated embodiment shows a “top down” configuration in which the energy source 110 is positioned above and directs the energy 108 down toward the build platform 104, such that the object 102 is formed on the upper surface of the build platform 104. Accordingly, the build platform 104 can be incrementally lowered relative to the energy source 110 as successive layers of the object 102 are formed. In other embodiments, however, the additive manufacturing process of FIG. 1 can be performed using a “bottom up” configuration in which the energy source 110 is positioned below and directs the energy 108 up toward the build platform 104, such that the object 102 is formed on the lower surface of the build platform 104. Accordingly, the build platform 104 can be incrementally raised relative to the energy source 110 as successive layers of the object 102 are formed.

Although FIG. 1 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

Examples of additive manufacturing techniques that are applicable to the present technology include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Additionally or alternatively, materials suitable for use with the systems and methods described herein can have a viscosity in the range of 0.05 Pa-s to 100 Pa-s at a temperature within a range from 20° C. to 160° C., 40° C. to 140° C., or from 50° C. to 120° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,224 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. In some embodiments of a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

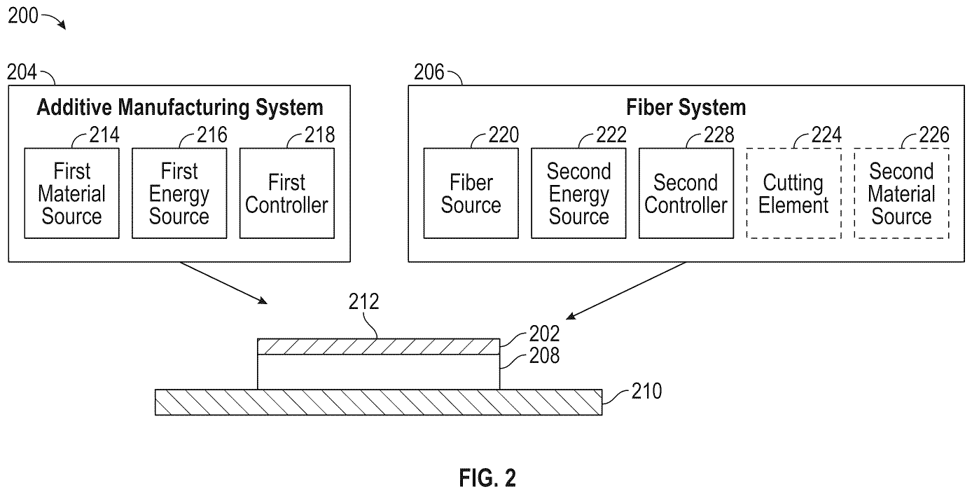

FIG. 2 is a partially schematic diagram providing a general overview of a system 200 for fabricating fiber-reinforced objects, in accordance with embodiments of the present technology. The system 200 is configured to fabricate one or more fiber-reinforced objects 202, such as one or more fiber-reinforced dental appliances, using an additive manufacturing process. In some embodiments, the system 200 includes an additive manufacturing system 204 and a fiber system 206. The additive manufacturing system 204 can be configured to perform an additive manufacturing process, such as the process described in connection with FIG. 1. For instance, the additive manufacturing system 204 can be configured to fabricate an object portion 208 (e.g., an object layer) on a build platform 210. The fiber system 206 can be configured to deposit and position a fiber 212 onto and/or into the object portion 208 and/or the build platform 210. In some embodiments, the additive manufacturing system 204 and the fiber system 206 operate sequentially, e.g., the additive manufacturing system 204 fabricates a first object portion, then the fiber system 206 deposits fiber onto and/or into the first object portion, then the additive manufacturing system 204 fabricates a second object portion proximate to the deposited fiber and the first object portion, and so on. However, the sequence of operations need not be alternating—for example, multiple object portions can be fabricated without fiber. Further, while only one fiber-reinforced object 202 and one build platform 210 are shown, the additive manufacturing system 204 and the fiber system 206 can be configured to fabricate a plurality of fiber-reinforced objects 202 on one or more build platforms 210, as desired.

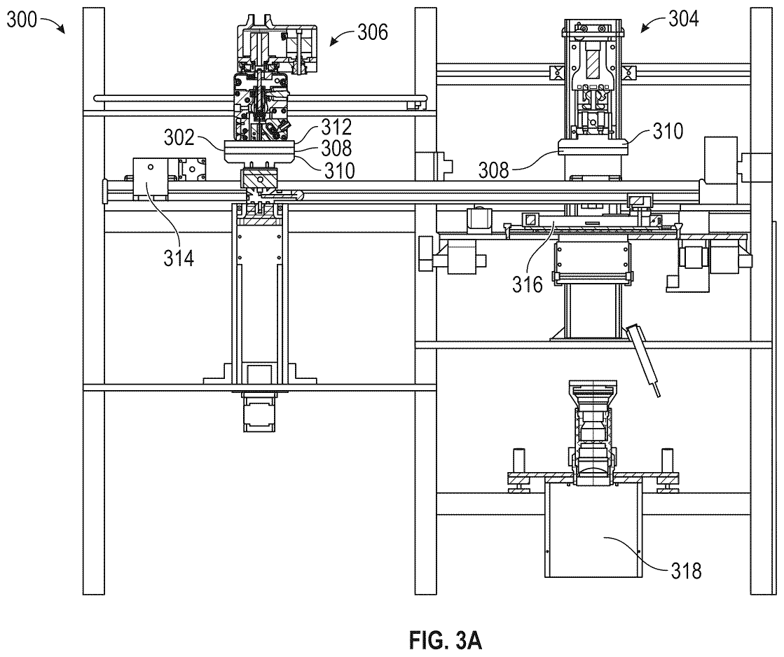

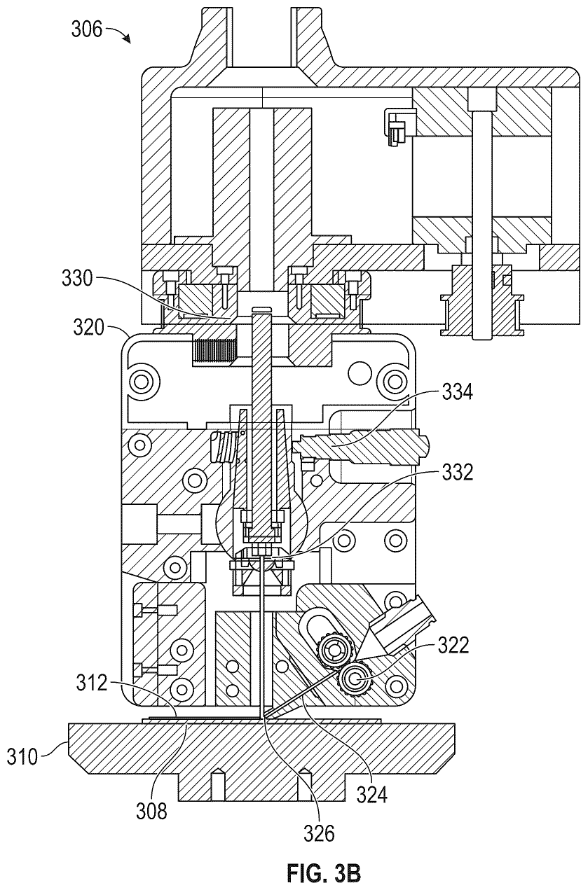

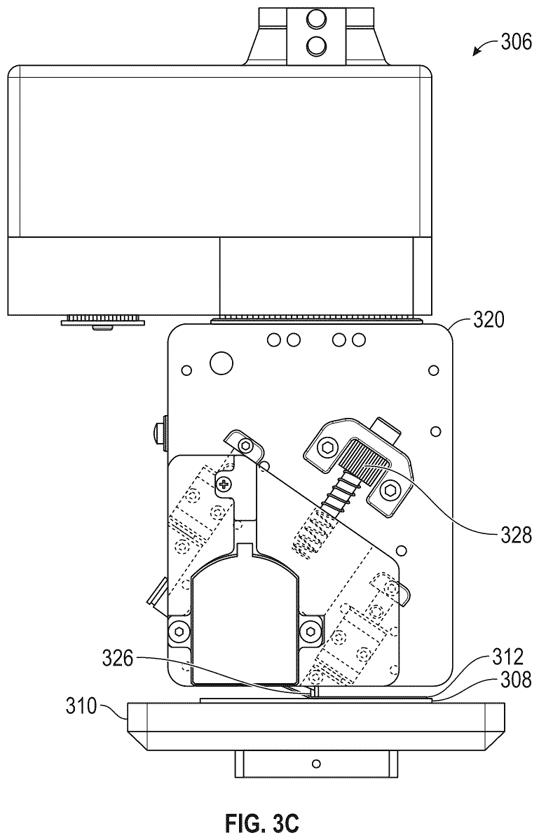

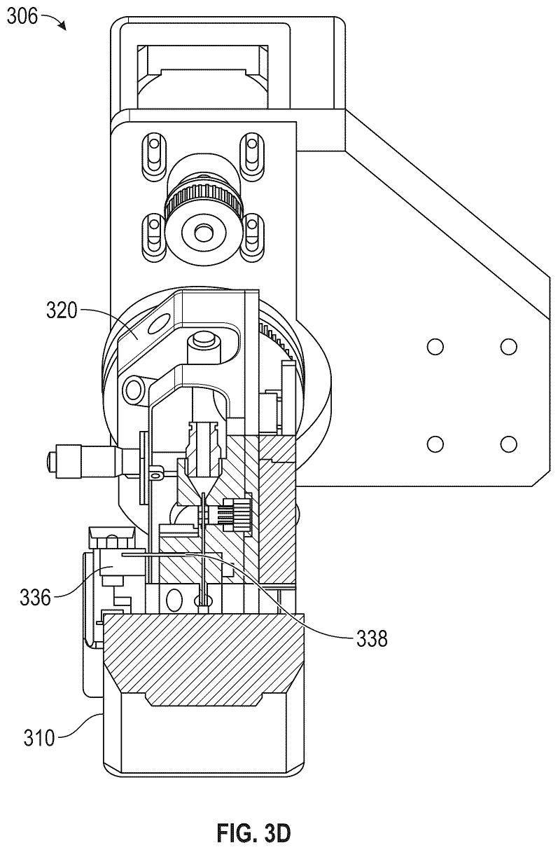

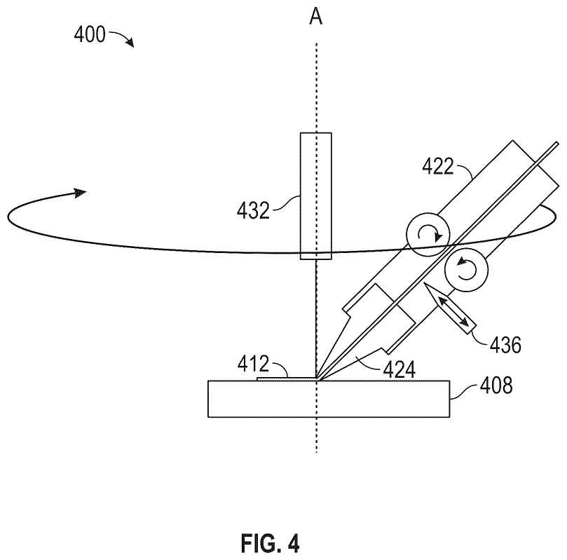

The additive manufacturing system 204 can include a first material source 214 configured to deposit a curable material. As previously noted, the curable material can include any suitable material or combination of materials. For instance, the curable material can include a curable polymeric resin. In some embodiments, the first material source 214 is configured to deposit the curable material onto a substrate. The substrate can be any structure suitable for supporting the deposited curable material, such as a tray, plate, film, sheet, printer bed, or other planar or non-planar substrate. The substrate may be the build platform 210 or may be a different component that is separate from the build platform 210, depending on the configuration of the additive manufacturing system 204. In some embodiments, the first material source 214 can be configured to deposit the curable material directly onto the build platform 210 or onto an object portion 208 on the build platform 210, e.g., as described in connection with FIGS. 3A-3D below. Alternatively, the substrate is a movable carrier film configured to deliver the curable material to the build platform 210 along a continuous loop trajectory, e.g., as described in connection with FIG. 4 below. The first material source 214 can include nozzles, ports, reservoirs, etc., that deposit the curable material. In some embodiments, for instance, the first material source 214 includes a nozzle coupled to a reservoir configured to supply the curable material.

The additive manufacturing system 204 can further include a first energy source 216 configured to apply first energy to the curable material to form an object portion 208 on the build platform 210. The first energy and the first energy source 216 can be generally similar to the energy 108 and the energy source 110 of FIG. 1, respectively. For instance, the first energy can include light energy, such as UV light, and the first energy source 216 can be a laser, light engine, projector, etc., that is configured to output the light energy toward the curable material to form the object portion 208. In some embodiments, the first energy has a wavelength configured to partially or fully cure the curable material. The first energy can be patterned or scanned in a suitable pattern onto the curable material, thus forming the object portion 208 on the build platform 210 or on a previously formed object portion 208. In some embodiments, the object portion 208 is or includes a layer of cured material on the build platform 210 and/or on a previously formed object portion 208.

The additive manufacturing system 204 can also include a first controller 218. The first controller 218 can be or include a computing device including one or more processors and memory storing instructions for performing the additive manufacturing operations described herein. For instance, the first controller 218 can receive a digital representation of the fiber-reinforced object 202 to be fabricated (e.g., a 3D digital model, a series of 2D image slices) and can transmit instructions to the first energy source 216 to apply the first energy to the curable material to form the object portions 208. In some embodiments, the first controller 218 can control various operational parameters of the first energy source 216, such as the exposure time, exposure pattern, exposure wavelength, energy density, power density, and/or other parameters affecting the printing process. Optionally, the first controller 218 can also determine and control other operational parameters, such as the positioning of a substrate and/or the build platform 210 (e.g., vertical and/or horizontal position) relative to other components of the system 200, the amount of curable material deposited by the first material source 214, the thickness of the curable material deposited, etc.

Optionally, the additive manufacturing system 204 can include one or more additional elements. For instance, the additive manufacturing system 204 can further include one or more heat sources (e.g., heating plates, infrared lamps, etc.) for heating the curable material to lower the viscosity to a range suitable for additive manufacturing. Additionally or alternatively, the additive manufacturing system 204 can include one or more cooling elements (e.g., a cool air gun, cold plate, thermoelectric cooler, cooling fin, ventilation unit, fan, etc.) for cooling the curable material.

As previously noted, the fiber system 206 can be configured to deposit one or more fibers 212 onto and/or into the object portion 208 fabricated by the additive manufacturing system 204. In some embodiments, the fiber system 206 includes a fiber source 220 configured to deposit the fiber 212 onto and/or into the object portion 208. The fiber 212 can include a material or a combination of materials that are configured to confer desired properties to the object 202 (e.g., strength, stiffness, durability, resistance to stress relaxation). In some embodiments, the fiber 212 is or includes one or more of a glass fiber, a carbon fiber, a metallic fiber, a natural fiber (e.g., wood, flax, silk, cotton, and/or hemp), or a synthetic and/or polymeric fiber (e.g., polyester, polyvinyl acrylic, polyolefin, etc.). Further, the fiber 212 can be a biocompatible fiber, such as a biocompatible glass fiber. Further details of biocompatible glass fibers (“bioglass fibers”) can be found in U.S. application Ser. No. 18/348,111, filed Jul. 6, 2023, the disclosure of which is incorporated by reference herein in its entirety. Optionally, the fiber 212 may be biodegradable. The fiber 212 may be configured to be positioned within a humid environment (e.g., an oral cavity) without losing desired properties.

In embodiments where the object 202 is transparent or translucent, the fiber 212 can also be transparent or translucent, and may be composed of a material having a refractive index that is identical or similar to the object 202 to maintain the transparency or translucency of the object 202. Alternatively, the fiber 212 may be opaque and/or colored, e.g., to provide a desired aesthetic effect. In some embodiments, the fiber 212 is a continuous fiber. The fiber 212 can have any suitable cross-sectional shape, such as circular, oval, square, triangular, etc. Optionally, the fiber 212 can take the form of a roving or a yarn.

In some embodiments, the fiber 212 includes a single fiber filament. However, in other embodiments, the fiber 212 includes a plurality of fiber filaments, such as at least 2 fiber filaments, 10 fiber filaments, 20 fiber filaments, 50 fiber filaments, 100 fiber filaments, 150 fiber filaments, 200 fiber filaments, 500 fiber filaments, etc. The diameter of each fiber filament can be within a range from 0.5 microns to 5 microns, 1 micron to 5 microns, 1 micron to 10 microns, 5 microns to 10 microns, 5 microns to 25 microns, 10 microns to 20 microns, etc. In some embodiments, the total diameter of the fiber 212 is less than or equal to 1000 microns, 500 microns, 400 microns, 300 microns, 200 microns, or 100 microns.

In embodiments where the fiber 212 is intended to be enclosed within the internal volume of the object 202, the total diameter of the fiber 212 can be selected to be smaller than the minimum thickness of the object 202 to prevent the fiber 212 from protruding out of the surfaces of the object 202. For instance, in embodiments where the object 202 is a dental appliance having a wall thickness within a range from 400 microns to 600 microns, the fiber 212 can have a total diameter less than or equal to 400 microns, 300 microns, 200 microns, or 100 microns; and/or within a range from 100 microns to 200 microns. However, if the fiber 212 is not intended to be enclosed within the internal volume of the object 202 (e.g., the fiber 212 is placed on an external surface of the object 202), the total diameter of the fiber 212 may be larger than the minimum thickness of the object 202. Alternatively, the fiber 212 may have a larger diameter in larger dental appliances. For instance, the fiber 212 may have a diameter of less than or equal to 1000 microns.

The fiber source 220 can be any device that deposits the fiber 212 at a desired location onto and/or into the object portion 208. The fiber source 220 can be configured to deposit the fiber 212 as a continuous segment (e.g., a segment having a length of at least 1 mm, 5 mm, 10 mm, 20 mm, 30 mm, 40 mm, 50 mm, or more). In some embodiments, the fiber source 220 includes a nozzle including an internal channel that receives the fiber 212 (e.g., from a spool, reservoir, or other supply of the fiber 212) and an outlet through which the fiber 212 exits the nozzle. The channel can be angled relative to a surface (e.g., the upper surface) of the build platform 210, e.g., at an angle within a range from 0 degrees to 30 degrees, 30 degrees to 60 degrees, 60 degrees to 90 degrees, etc. In some embodiments, the angle is less than 90 degrees, which may be advantageous to avoid kinking, bending, and/or breaking of the fiber 212 during deposition. In some embodiments, the fiber source 220 includes an actuation mechanism (e.g., via one or more rollers) to drive the fiber 212 out of the nozzle, as will be described further herein.

In some embodiments, the fiber source 220 is moveable relative to the build platform 210. For instance, the fiber source 220 can be translatable in one or more directions (e.g., in the X, Y, and/or Z directions), and/or may be rotatable in one or more directions (e.g., around the X-, Y-, and/or Z-axes). In some embodiments, the fiber source 220 is coupled to a pivot joint, translating stage, robotic arm, or other actuator for translating and/or rotating the fiber source 220. In other embodiments, however, the fiber source 220 may be stationary, and the build platform 210 may be movable relative to the fiber source 220.

In some embodiments, the fiber system 206 further includes a second energy source 222 configured to apply second energy to affix the fiber 212 to the object portion 208 and/or the build platform 210. The second energy source 222 can be or include a light source, such as a laser, LED, projector, light engine, etc. For instance, the second energy source 222 can be a diode laser. In some embodiments, the second energy source 222 is configured to output the second energy at or proximate to the location at which the fiber 212 exits the fiber source 220, which may be beneficial for improving control and accuracy of fiber placement on the object portion 208. For instance, the second energy can be directed at or proximate to the outlet of the nozzle of the fiber source 220. Optionally, the second energy source 222 is omitted, and the second energy may be applied by the first energy source 216 of the additive manufacturing system 204. Alternatively, the first energy source 216 of the additive manufacturing system 204 may be omitted, and the first energy may be applied by the second energy source 222.

The second energy can be directed at second curable material surrounding the fiber 212 and/or second curable material disposed on or within the fiber 212, and the curing of the second curable material by the second energy can adhere the fiber 212 to the object portion 208, thereby fixing the position of the fiber 212 with respect to the object portion 208. In some embodiments, the second energy can be similar to the first energy. For instance, the second energy may have the same wavelength, directionality, intensity, spot size, etc. as the first energy. The second curable material may or may not be the same as the curable material deposited by the first material source 214. In some embodiments, the second curable material is present on the object portion 208 prior to deposition of the fiber 212 (e.g., residual curable material may be present on the surface of the object portion 208 or may be applied to the surface of the object portion 208), such that the fiber 212 can be deposited onto and/or into the second curable material. Alternatively or in combination, as will be described further herein, the second curable material can be directly applied to the fiber 212 prior to and/or during deposition of the fiber 212, e.g., the fiber 212 may be coated, co-extruded, or impregnated with the second curable material.

The fiber 212 can be deposited and affixed in a plurality of locations onto and/or into the object portion 208. For instance, the fiber 212 can be deposited onto and/or into an upper surface of the object portion 208 (e.g., the surface facing away from the build platform 210). Alternatively or in combination, the fiber 212 can be deposited onto and/or into a lateral surface of the object portion 208. The fiber 212 can be deposited along any suitable path (e.g., straight, curved, curvilinear, zig-zag), and can form any suitable shape (e.g., lines, squares, rectangles, U-shaped, grid), depending on the desired geometry of the object 202 and/or function of the fiber 212 in the object 202. For instance, to reinforce edges of an object, the fiber 212 can follow the shape of the edges of the object. Further still, the fiber 212 can be deposited and/or affixed onto a separate material layer, and the separate material layer can be attached to the object portion 208. For instance, the fiber 212 may be deposited onto or into a separate material layer, and the separate material layer can be positioned on a surface of the object portion 208.

Optionally, the fiber system 206 can include a cutting element 224. The cutting element 224 can be configured to cut the fiber 212 to a desired length. The cutting element 224 can be or include one or more blades, lasers, wires, and/or any other suitable element for cutting, breaking, ablating, or otherwise separating the deposited fiber 212 from remaining fiber 212 within the fiber source 220 that is not intended to be deposited onto the object portion 208. Optionally, the cutting element may include a heated element, such as a heated blade and/or a heated wire configured to thermally cut the fiber 212. In some embodiments, the cutting element 224 is actuatable by a motor. For instance, the motor can actuate the cutting element 224 between a retracted configuration in which the cutting element 224 is positioned away from the fiber 212 to an extended configuration in which the cutting element 224 extends into contact with and/or past the fiber 212. Further, the cutting element 224 can have a fiber retraction function for improved threading of the fiber. After the fiber 212 is cut, (e.g. with the cutting element 224) the remaining fiber 212 can be kinked or bent away from the fiber guiding channel of the deposition nozzle. By retracting the fiber 212 for a short distance (e.g., around 0.2 mm to 3 mm) via a fiber actuation mechanism (e.g., one or more rollers additionally or alternatively to the motor), the fiber 212 can be straightened and centered inside the feeding channel. After the retraction movement, the fiber 212 can be moved forward again, where it is threaded into the guiding channel.

In some embodiments, the cutting element 224 cuts the fiber 212 at an outlet of the nozzle, thereby separating the deposited fiber 212 from remaining fiber within the nozzle. In such examples, the remaining fiber within the nozzle may not be deposited. However, in other embodiments, the cutting element 224 cuts the fiber 212 within the nozzle (e.g., proximal to from the outlet), in which case fiber remaining in the nozzle may be deposited along with already deposited fiber 212, e.g., by moving the fiber source 220 such that the remaining fiber is pulled out of the nozzle.

Optionally, the fiber system 206 can include a second material source 226. The second material source 226 can be configured to deposit the second curable material onto and/or into the fiber 212, if applicable. As noted previously, the second curable material may or may not be the same as the curable material deposited by the first material source 214. The second curable material may be deposited as an uncured material and can be at least partially cured by the second energy source 222 to affix the fiber 212 to the object portion 208 and/or the build platform 210. The second material source 226 can be generally similar to the first material source 214. For instance, the second material source 226 can include a nozzle coupled to a reservoir configured to supply the second curable material. The nozzle may be a concentric nozzle surrounding the nozzle of the fiber source 220, or a nozzle placed proximate to the nozzle of the fiber source 220, thereby coating and/or coextruding the fiber 212 with the second curable material. Alternatively or in combination, the fiber 212 may pass through the reservoir of the second material source 226 during deposition, thereby impregnating the fiber 212 with the second curable material. Alternatively, the fiber 212 may already include the second curable material (e.g., a pre-preg fiber) such that the second curable material need not be deposited onto and/or into the fiber 212 in situ, and the second material source 226 may be omitted.

The fiber system 206 can also include a second controller 228. The second controller 228 can be generally similar to the first controller 218. For instance, the second controller 228 can be or include a computing device including one or more processors and memory storing instructions for performing the fiber deposition operations described herein. For instance, the second controller 228 can receive a digital representation of the fiber-reinforced object 202 to be fabricated (e.g., a 3D digital model, a series of 2D image slices), including the locations of the fiber 212 within the object 202, and can transmit instructions to the fiber source 220 and the second energy source 222 to affix the fiber 212 to the object portion 208 according to the specified locations. In some embodiments, the second controller 228 can control various operational parameters of the second energy source 222, such as the exposure time, exposure pattern, exposure wavelength, energy density, power density, and/or other parameters affecting the fiber fixation process. Optionally, the second controller 228 can also determine and control other operational parameters, such as the position and/or orientation of the fiber source 220 and/or the second energy source 222, the feed rate of the fiber 212, the length of the fiber 212 via actuation of the cutting element 224, application of the second curable material to the fiber 212 via the second material source 226, etc. Further, the second controller 228 can be operably coupled to the first controller 218 such that the first controller 218 and the second controller 228 can transmit data and instructions therebetween, or the first controller 218 and the second controller 228 may be combined into a single controller that controls the operations of all the components of the system 200.

FIGS. 3A-3D illustrate a representative example of a system 300 for fabricating fiber-reinforced objects 302, in accordance with embodiments of the present technology. Specifically, FIG. 3A is a front cross-sectional view of the system 300 and FIGS. 3B-3D are cross-sectional views of a portion of the system 300. The system 300 is an example implementation of the system 200 of FIG. 2, such that any of the features described with respect to the embodiment of FIG. 2 may be included in the embodiment of FIGS. 3A-3D.

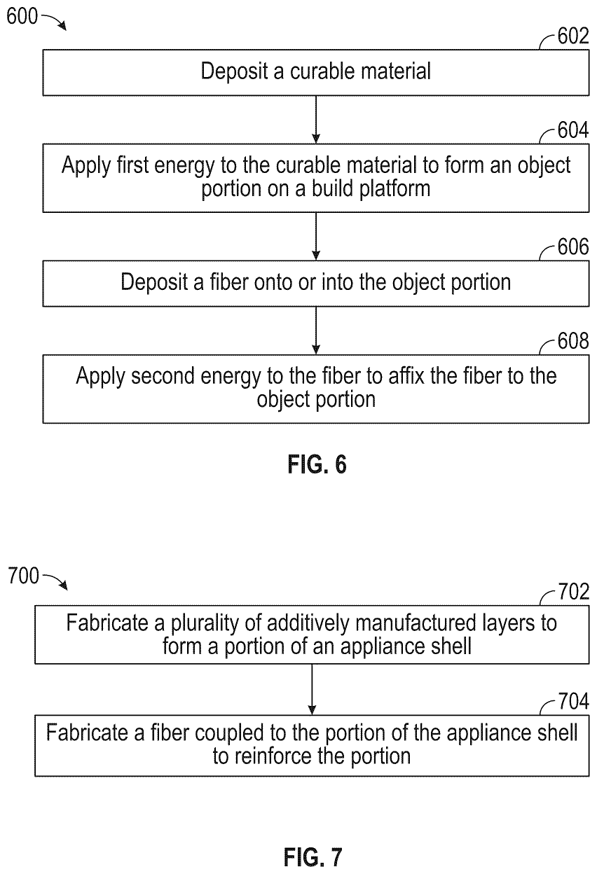

For instance, referring to FIG. 3A, the system 300 includes an additive manufacturing system 304 and a fiber system 306. The additive manufacturing system 304 is configured to fabricate an object portion 308 (e.g., an object layer) on a build platform 310 (the build platform 310 and object 308 are illustrated in two different positions—proximate to the additive manufacturing system 304 (right) and proximate to the fiber system 306—to show the separate stages of the fabrication process). The fiber system 306 is configured to deposit and position a fiber 312 onto and/or into the object portion 308 and/or the build platform 310 (the fiber 312 is enlarged in FIG. 3A merely for purposes of clarity). In some embodiments, the fiber-reinforced object 302 is a dental appliance, such as any of the embodiments described with respect to FIGS. 6A-7 and in Section II below. The mechanical properties of the dental appliance may be improved via the fiber 312.

The additive manufacturing system 304 and the fiber system 306 can operate sequentially. For instance, the additive manufacturing system 304 can fabricate a first object portion 308 (e.g., a first object layer) on the build platform 310, then the fiber system 306 can deposit the fiber 312 onto and/or into the first object portion 308, then the additive manufacturing system 304 can fabricate a second object portion 308 (e.g., a second object layer) on the first object portion 308 and/or the fiber 312, and so on. Further, the object portions 308 and the fiber 312 can be fabricated in accordance with different sequences. For instance, the fiber 312 can be deposited on the build platform 310 prior to fabrication of the first object portion 308. Additionally or alternatively, a plurality of object portions 308 may be fabricated prior to and/or between deposition of the fiber 312. Moreover, a plurality of fibers 312 may be deposited into a single object portion 308, as will be described further herein. In some embodiments, the build platform 310 is transported between the additive manufacturing system 304 and the fiber system 306 using a transport mechanism 314, as will be described further below.

In the illustrated embodiment, the additive manufacturing system 304 uses a “bottom-up” vat photopolymerization process to fabricate the object portion 308. The additive manufacturing system 304 includes a vat 316 of a curable material (e.g., a liquid resin). The bottom surface of the vat 316 includes a transparent material (e.g., glass, silicone, film) that permits energy (e.g., light) from a first energy source 318 to enter into the vat from below. The first energy source 318 can be a DLP light engine, laser, masked stereolithography (MSLA) source, or other suitable energy source. In operation, the bottom surface of the vat 316 can be coated with a layer of curable material using one or more coating tools, such as a coating blade. After coating, the build platform 310 is lowered proximate to and/or into the layer of curable material, and the layer of curable material is exposed to energy via the first energy source 318 to at least partially cure the layer of curable material, thereby forming the object portion 308 on the build platform 310. After curing, the build platform 310 can be raised and the bottom surface of the vat 316 can be recoated with additional curable material, and the above process can be repeated to produce additional object portions 308.

When fiber reinforcement is desired, the build platform 310 can be transported from the additive manufacturing system 304 to the fiber system 306 using the transport mechanism 314. In the illustrated embodiment, the transport mechanism 314 includes a motorized track configured to slide the build platform 310 from a first position proximate to the additive manufacturing system 304 to a second position proximate to the fiber system 306, and vice versa. Further, the transport mechanism 314 may be configured to rotate the build platform 310 between a first orientation in which the build platform 310 is facing the vat 316 (e.g., downwards) to a second orientation in which the build platform 310 is facing the fiber system 306 (e.g., upwards). This may involve a rotation of 180 degrees or similar.

At the fiber system 306, fiber 312 is deposited onto and/or into the object portion 308. Referring now to FIG. 3B, which illustrates a front cross-sectional view of the fiber system 306, the fiber system 306 includes a fiber source 320 configured to supply and deposit the fiber 312. The fiber source 320 can include a fiber feeding unit 322 coupled to a nozzle 324 configured to deposit the fiber 312. The nozzle 324 may include an internal channel for receiving the fiber 312 and an outlet 326 through which the fiber 312 exits the nozzle 324. The fiber feeding unit 322 can include a drive mechanism, such as two driven rollers with a silicone cover. The two driven rollers are compressed by a pre-tensioning unit 328 (shown in FIG. 3C, which illustrates a back view of the fiber system 306) having an adjustable spring force to advance the fiber 312 through the internal channel and out of the outlet 326 of the nozzle 324.

In the illustrated embodiment, the nozzle 324 is angled relative to the upper surface of the build platform 310. For example, the angle between the nozzle and the upper surface of the platform can be within a range from 0 degrees to 30 degrees, 30 degrees to 60 degrees, or 60 degrees to 90 degrees, such as 10 degrees, 45 degrees, 60 degrees, etc. This angled configuration can be advantageous, for example, to reduce the degree of fiber bending as the fiber 312 is deposited onto and/or into the object portion 308, which might otherwise lead to kinking and/or fracture of the fiber 312. Further, the fiber system 306 includes a pivot joint 330 that can allow for the adjustment of the angle and/or position in which fiber 312 is deposited, as desired. For instance, the pivot joint 330 may be designed in such a way that the direction of fiber placement is adapted to the direction of movement of the fiber source 320. While depositing the fiber 312, the nozzle 324 may always point toward the movement direction of the fiber source 320 (e.g., for correct fiber deposition with low bending). To ensure the orientation of the nozzle 324 matches the movement, the pivot joint 330 can be integrated such that the fiber source 320 rotates in an orthogonal axis from the deposition plane. For example, the pivot joint 330 can include a driven ball bearing (although other types of bearing are also possible) in combination with a through bore slip ring, where the fiber 312 is guided through the center and the fiber source 320 is supplied with power via the sliding contacts.

The fiber system 306 further includes a second energy source 332 configured to apply second energy to affix the fiber 312 to the object portion 308. In illustrated embodiment, the second energy source 332 is a light source configured to output light energy toward the fiber 312 as the fiber 312 exits the outlet 326 of the nozzle 324. The second energy source 332 can be an LED or a laser, such as a diode laser. Further, the position of the laser spot (e.g., where the light energy contacts the fiber 312) can be precisely adjusted using a fine adjustment mechanism 334. The fine adjustment mechanism 334 can be configured to modify the attenuation, shape, direction, wavelength, polarization, etc., of the light energy.

The second energy source 332 can be directed at second curable material surrounding the fiber 312 and/or second curable material disposed on or within the fiber 312, and the curing of the second curable material by the light energy can adhere the fiber 312 to the object portion 308, thereby fixing the position of the fiber 312 with respect to the object portion 308. The second curable material may or may not be the same as the curable material disposed within the vat 316. In some embodiments, the second curable material is present on the object portion 308 prior to deposition of the fiber 312 (e.g., residual curable material may be present on the surface of the object portion 308 or may be applied to the surface of the object portion 308), such that the fiber 312 can be deposited onto and/or into the second curable material. Alternatively or in combination, the second curable material can be directly applied to the fiber 312 prior to and/or during deposition of the fiber 312, e.g., the fiber 312 may be coated, co-extruded, or impregnated with the second curable material. Optionally, the fiber 312 may be a pre-preg fiber that is already provided with the second curable material.

While not depicted, the fiber system 306 can include a second material source to deposit the second curable material onto and/or into the fiber 312. For instance, the second material source can coat and/or coextrude the fiber 312 with the second curable material. Alternatively or in combination, the second material source can impregnate the fiber 312 with the second curable material. The second material source can be a vat, nozzle, or other any other mechanism suitable for depositing the second curable material onto and/or into the fiber 312, as discussed elsewhere herein.

The fiber 312 can be deposited and affixed in a plurality of locations onto and/or into the object portion 308. For instance, the fiber 312 can be deposited onto and/or into an upper surface, lower surface, lateral surface, etc. of the object portion 308. The fiber 312 can be deposited along a variety of suitable paths and/or in a plurality of object portions 308, as described elsewhere herein.

Referring now to FIG. 3D, which illustrates a side cross-sectional view of the fiber system 306, the fiber system 306 also includes a cutting element 336 configured to cut the fiber 312 to a desired length. The cutting element 336 includes a blade 338 that can be actuated via a motor. For instance, the motor can actuate the blade 338 between a retracted configuration in which the blade 338 is positioned away from the fiber 312 to an extended configuration in which the blade 338 extends into contact with and/or past the fiber 312. While the blade 338 is depicted in a substantially parallel orientation with respect to the build platform 310, the blade 338 may alternatively be positioned in a variety of angles with respect to the build platform 310.

Further, the system 300 can include one or more controllers configured to perform the additive manufacturing and fiber deposition operations described herein. For instance, a first controller may be or include a first computing device including one or more processors and memory storing instructions for performing the fabrication operations of the additive manufacturing system 304, and a second controller may be or include a second computing device including one or more processors and memory storing instructions for performing the fiber deposition operations of the fiber system 306. Alternatively, a single controller may control both the additive manufacturing system 304 and the fiber system 306. In some embodiments, the controllers are configured to control various operational parameters of the system 300 including, for example, actuation of coating tools for coating the bottom surface of the vat 316, actuation of the blade 338 of the cutting element 336, actuation of the transport mechanism 314, position and/or orientation of the fiber source 320, feed rate of the fiber feeding unit 322, etc.

FIG. 4 illustrates a representative example of a fiber system 400 for fabricating fiber-reinforced objects, in accordance with embodiments of the present technology. The fiber system 400 can be used with any of the systems and devices described herein, such as the system 300 of FIGS. 3A-3D. The fiber system 400 can be generally similar to the fiber system 306 of FIGS. 3A-3D. For example, the fiber system 400 can include a fiber feeding unit 422 coupled to a nozzle 424 configured to deposit a fiber 412 onto an object portion 408, an energy source 432 configured to apply energy to affix the fiber 412 to the object portion 408, and a cutting element 436 configured to cut the fiber 412 to a desired length; these components may be identical or generally similar to the corresponding components described with respect to FIGS. 3A-3D, except as discussed below.

In some embodiments, the fiber system 400 is configured to provide additional degrees of freedom for fiber deposition compared to systems that deposit fiber in only two directions, e.g., along an X-Y plane. For example, the fiber system 400 of FIG. 4 can be configured to rotate around a rotation axis A, such that the fiber 412 can be deposited and positioned onto and/or into the object portion 406 from a plurality of different directions relative to the X-Y plane (e.g., the plane orthogonal to the rotation axis A). For instance, the fiber system 400 may be configured to rotate around the rotation axis A relative to the object portion 408 over a desired range, such as within a range from 0 degrees to 30 degrees, 0 degrees to 60 degrees, 0 degrees to 90 degrees, 0 degrees to 120 degrees, 0 degrees to 150 degrees, 0 degrees to 180 degrees, 0 degrees to 210 degrees, 0 degrees to 240 degrees, 0 degrees to 270 degrees, 0 degrees to 300 degrees, 0 degrees to 330 degrees, or 0 degrees to 360 degrees. Further, while not depicted, the nozzle 424 may be configured to tilt toward and away from the rotation axis A to allow for different deposition angles for the fiber 412. Depositing the fiber 412 from one or more different directions and/or angles relative to the object portion 408 may allow for the fabrication of objects with more complex fiber pattens and/or reinforcement designs.

Alternatively or in addition to rotation about the rotation axis A, the fiber system 400 can be configured to move in a Z-direction to allow for control over the fiber 412 with three degrees of freedom (e.g., in the X-Y plane and along the Z-direction). For instance, the fiber system 400 may be configured to translate along a direction parallel to the rotation axis A to provide achieve fiber deposition across a plurality of object layers.

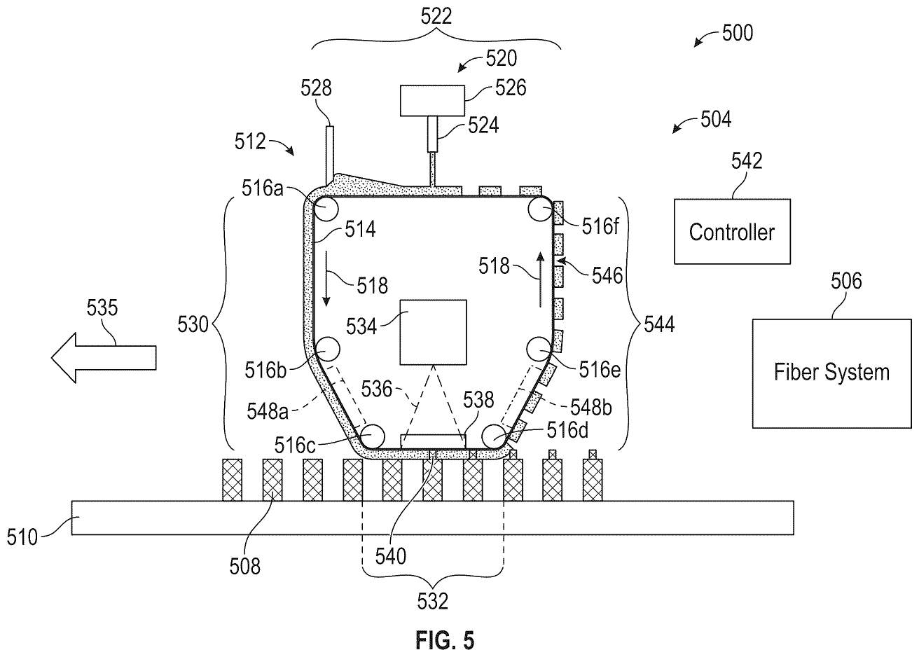

FIG. 5 illustrates a representative example of a system 500 for fabricating fiber-reinforced objects, in accordance with embodiments of the present technology. The system 500 is an example implementation of the system 200 of FIG. 2, such that any of the features described with respect to the embodiment of FIG. 2 may be included in the embodiment of FIG. 5.

For instance, the system 500 includes an additive manufacturing system 504 and a fiber system 506. The additive manufacturing system 504 is configured to fabricate a plurality of object portions 508 on a build platform 510. The fiber system 506 (shown schematically) is configured to deposit and position fiber onto and/or into the object portions 508 and/or the build platform 510. In some embodiments, the fiber-reinforced objects are dental appliances, such as any of the embodiments described with respect to FIGS. 9A-26 and in Section III below. The mechanical properties of the dental appliances may be improved via the fiber.

The additive manufacturing system 504 includes a printer assembly 512 that forms the object portions 508 on the build platform 510. The build platform 510 can be a tray, plate, film, sheet, printer bed, or other planar or non-planar substrate. The object portions 508 may be formed by applying energy to a curable material (e.g., a photopolymerizable resin). In the illustrated embodiment, the printer assembly 512 includes a carrier film 514 configured to deliver the curable material to the build platform 510. The carrier film 514 can be a flexible loop of material having an outer surface and an inner surface. The outer surface of the carrier film 514 can adhere to and carry a thin layer of the curable material. The inner surface of the carrier film 514 can contact a drive mechanism for moving the carrier film 514, such as one or more rollers 516a-516f that rotate to move the carrier film 514 in a continuous loop trajectory, e.g., along the directions indicated by arrows 518. The rollers 516a-516f can include any suitable geometry for facilitating the movement of the carrier film 514. For instance, the rollers 516a-516f can include cylinders, spools, blades, etc.

The printer assembly 512 can also include a material source 520 configured to apply the curable material to the carrier film 514 at a deposition zone 522 (also known as a “coating zone” or “recoating zone”). In the illustrated embodiment, the material source 520 is located at the upper portion of the printer assembly 512, and the deposition zone 522 is an upper horizontal segment of the carrier film 514 between rollers 516a and 516f. In other embodiments, however, the material source 520 and/or deposition zone 522 can be at different locations in the printer assembly 512. The material source 520 can include nozzles, ports, reservoirs, etc., that deposit the curable material onto the outer surface of the carrier film 514. In some embodiments, for instance, the material source 520 includes a nozzle 524 coupled to a reservoir 526. The system 500 can also include one or more blades 528 (e.g., doctor blades, recoater blades) that smooth the deposited curable material into a relatively thin, uniform layer. For example, the curable material can be formed into a layer having a thickness within a range from 100 microns to 500 microns, 200 microns to 300 microns, or any other desired thickness.

The curable material can be conveyed by the carrier film 514 toward the build platform 510. In some embodiments, the curable material is transported through a pre-print zone 530 downstream of the deposition zone 522. The pre-print zone 530 can include a vertical segment, an angled segment, or a combination thereof of the carrier film 514. For instance, although the pre-print zone 530 is illustrated as including a vertical segment of the carrier film 514 between the rollers 516a and 516b and an angled segment of the carrier film 514 between the rollers 516b and 516c, in other embodiments, the pre-print zone 530 can include only a vertical segment or only an angled segment.

The build platform 510 can be located proximate to a print zone 532 of the carrier film 514 (also known as an “exposure zone”). In the illustrated embodiment, the build platform 510 is located below the printer assembly 512, and the print zone 532 is a lower horizontal segment of the carrier film 514 between rollers 516c and 516d. In other embodiments, however, the build platform 510 and/or print zone 532 can be positioned at different locations in the printer assembly 512. The distance between the carrier film 514 and build platform 510 can be adjustable so that the curable material at the print zone 532 can be brought into direct contact with the surface of the build platform 510 or with the surface of a previous object portion 508. For example, the build platform 510 can include or be coupled to an actuator (e.g., a motor—not shown) that raises and/or lowers the build platform 510 to the desired height during the manufacturing process. Alternatively or in combination, the printer assembly 512 can include or be coupled to a motor (not shown) that raises and/or lowers the printer assembly 512 relative to the build platform 510.

The printer assembly 512 can include an energy source 534 (e.g., a projector, light engine, laser scanner) that outputs energy 536 (e.g., light, such as UV light) having a wavelength configured to partially or fully cure the curable material. The carrier film 514 can be partially or completely transparent to the wavelength of the energy 536 to allow the energy 536 to pass through the carrier film 514 and onto the portion of the curable material above the build platform 510. Optionally, a transparent plate 538 can be disposed between the energy source 534 and the carrier film 514 to guide the carrier film 514 into a specific position (e.g., height) relative to the build platform 510.

During operation, the energy 536 can be patterned or scanned in a suitable pattern onto the curable material, thus forming a layer of cured material 540 onto the build platform 510 and/or on a previously formed object portion 508. The geometry of the cured material 540 can correspond to the desired cross-sectional geometry for the object portion 508. The parameters for operating the energy source 534 (e.g., exposure time, exposure pattern, exposure wavelength, energy density, power density) can be set based on instructions from a controller 542, as described in further detail below.

In some embodiments, the energy 536 is applied to the curable material while the carrier film 514 moves to circulate the curable material through the print zone 532. To maintain zero or substantially zero relative velocity between the curable material and the build platform 510, the printer assembly 512 can concurrently move horizontally relative to the build platform 510 opposite the direction of the motion of the carrier film 514 at the print zone 532, e.g., as indicated by arrow 535. The motion of the printer assembly 512 can also increase the printable surface area of the build platform 510. The energy 536 output by the energy source 534 can be coordinated with the movement of the carrier film 514 and build platform 510 so that the layer of cured material 540 is formed with the correct geometry. For example, the energy source 534 can be a scrolling light engine (e.g., a scrolling DLP) or laser scanner that outputs the energy 536 in a pattern that varies over time to match the motion of the printer assembly 512 and carrier film 514. In other embodiments, however, the printer assembly 512 can be a stationary device that does not move relative to the build platform 510 while the energy 536 is being applied to the curable material.

After curing, the newly formed layer of cured material 540 can be separated from the carrier film 514 and the remaining curable material at the print zone 532 (also referred to herein as “peel-off”). In some embodiments, the separation occurs at least in part due to peel forces produced by the carrier film 514 wrapping around the roller 516d immediately downstream of the print zone 532. The remaining curable material can be conveyed by the carrier film 514 away from the build platform 510, and into a post-print zone 544 downstream of the print zone 532 (also known as a “peel-off zone”). Separation of the cured material 540 from the carrier film 514 can leave recesses 546 (also known as “imprints”) in the remaining curable material. For instance, the recesses 546 can have a geometry corresponding to the geometry of the separated cured material 540. The post-print zone 544 can include a vertical segment, an angled segment, or a combination thereof of the carrier film 514. For instance, although the post-print zone 544 is illustrated as having an angled segment of the carrier film 514 between the rollers 516d and 516e and a vertical segment of the carrier film 514 between the rollers 516e and 516f, in other embodiments, the system 500 can include only a vertical segment or only an angled segment. The presence of an angled segment of carrier film 514 immediately downstream of the print zone 532 can adjust the peel angle produced by the roller 516d, and thus, the peel force applied to the cured material 540, to enhance separation from the surrounding curable material.

The remaining curable material conveyed away from the build platform 510 can be circulated by the carrier film 514 back toward the deposition zone 522. At the deposition zone 522, the material source 520 can apply additional curable material onto the carrier film 514 and/or smooth the curable material to fill in the recesses 546 and re-form a uniform layer of curable material on the carrier film 514. The curable material can then be recirculated back through the pre-print zone 530, and then to the print zone 532 and build platform 510 to fabricate subsequent object portions 508. This process can be repeated to iteratively build up individual object portions 508 on the build platform 510, until the entire object geometry is fabricated. The objects can then be removed from the system 500 for post-processing.

Optionally, the printer assembly 512 can be configured to produce the object portions 508 via a high temperature lithography process utilizing a highly viscous resin. In such embodiments, the printer assembly 512 can include one or more heat sources (e.g., heating plates, infrared lamps) for heating the curable material to lower the viscosity to a range suitable for additive manufacturing. The heat sources can be positioned near or in direct contact with the carrier film 514 to heat the curable material supported by the carrier film 514. For example, the printer assembly 512 can include a first heat source 548a positioned against the segment of the carrier film 514 before the build platform 510, and a second heat source 548b positioned against the segment of the carrier film 514 after the build platform 510. In some embodiments, the heat sources can additionally or alternatively be located at any suitable portion of the printer assembly 512, such as on or within the build platform 510, on or within the material source 520, at the deposition zone 522, on or within the coating blades 528, at the pre-print zone 530, at the print zone 532, at the post-print zone 544, or combinations thereof.

The object portions 508 may benefit from fiber reinforcement, as described elsewhere herein, and the fiber system 506 can be configured to reinforce the object portions 508 with fiber and/or position fiber between and/or across object portions 508. The fiber system 506 can be generally similar or the same as the fiber system 206 of the system 200 of FIG. 2, the fiber system 306 of FIGS. 3A-3D, and/or the fiber system 400 of FIG. 4, and may include any of the features previously described with respect to FIGS. 2-4. For instance, the fiber system 506 can include a fiber source configured to deposit one or more fibers onto and/or into the object portions 508. In some embodiments, the fiber is a material or a combination of materials that are configured to confer desired properties to the fiber-reinforced object (e.g., strength, stiffness, durability, resistance to stress relaxation). The fiber source may include a nozzle for depositing the fiber, and the fiber source may be pivotable and/or translatable with respect to the build platform 510. The fiber source may also include a cutting element configured to cut the deposited fiber to a desired length. Further, the fiber source may include additional material sources for depositing second curable material onto and/or into the fiber, and/or additional energy sources for affixing the fiber to the object portions 508. In some embodiments, various operational parameters of the fiber system 506 are controlled via the controller 542 of the additive manufacturing system 504. However, in other embodiments, the fiber system 506 is controlled via a separate controller or a controller operably coupled to both the additive manufacturing system 504 and the fiber system 506.

In some embodiments, the fiber system 506 is mechanically coupled to the printer assembly 512, such that the fiber system 506 is carried by and moves together with the printer assembly 512. In such embodiments, at least a portion of the fiber system 506 (e.g., at least the fiber source and/or an energy source of the fiber system 506) may be positioned laterally to the printer assembly 512, such that as the printer assembly 512 moves relative to the build platform 510 (e.g., along the direction of arrow 535), the fiber system 506 also moves relative to the build platform 510 and passes over the newly formed object portions 508. Accordingly, the fiber system 506 may be configured to deposit and affix the fiber onto and/or into the object portions 508 immediately and/or soon after the object portions 508 are formed by the printer assembly 512. In such embodiments, the fiber system 506 may be selectively activated to deposit the fiber as desired.

Alternatively, the fiber system 506 may be separate from the printer assembly 512, such that the fiber system 506 is movable independently of the printer assembly 512 or is stationary. For instance, the object portions 508 may be formed via the printer assembly 512 and then transported from the printer assembly 512 to the fiber system 506. In such examples, the object portions 508 and/or the build platform 510 may be transported using a transport mechanism, e.g., the transport mechanism 314 of the system 300 of FIG. 3. The object portions 508 and/or the build platform 510 may be transported back from the fiber system 506 to the printer assembly 512 as desired. Alternatively or in combination, the fiber system 506 may be movable relative to the build platform 510, e.g., via a motorized track, robotic arm, or other actuation mechanism. In such embodiments, the fiber system 506 may be transported to the location of the object portions 508 where fiber is to be deposited and affixed.

Although FIG. 5 illustrates a system with a single additive manufacturing system 504 and a single fiber system 506, this is not intended to be limiting. In some embodiments, one or more fiber systems 506 can be configured to operate in conjunction with one or more additive manufacturing systems 504. For instance, a single fiber system 506 may be configured to receive and deposit fiber onto and/or into object portions 508 from a plurality of additive manufacturing systems 504. Alternatively or in combination, a plurality of fiber systems 506 may be configured to receive and deposit fibers onto and/or into object portions 508 from a single additive manufacturing system 504. In such situations, each fiber system 506 may deposit different types of fibers (e.g., different fiber sizes, geometries, materials, etc.).

FIG. 6 is a flow diagram illustrating a method 600 for fabricating a fiber-reinforced object, in accordance with embodiments of the present technology. The method 600 can be performed using any of the systems and devices described herein, such as any of the embodiments of FIGS. 1-5. In some embodiments, some or all of the processes of the method 600 are implemented as computer-readable instructions (e.g., program code) that are configured to be executed by one or more processors of a computing device, such as a controller of a fabrication system (e.g., the first controller 218 and/or the second controller 228 of the system 200).

The method 600 can begin at block 602 with depositing a curable material on a substrate. In some embodiments, the curable material is or includes a photopolymerizable resin. The curable material can be deposited on the substrate from a material source, e.g., such as a nozzle coupled to a reservoir of the curable material. Optionally, the deposited curable material can be smoothed into a thin, uniform material layer on the substrate using one or more blades, with the thickness of the material layer being larger or substantially equivalent to the thickness of an object portion to be formed. The substrate can be any structure suitable for supporting the deposited curable material, such as a film, plate, etc. In some embodiments, the substrate is a movable substrate that circulates the curable material toward an energy source for curing, such as a carrier film, movable plate, etc. (e.g., the carrier film 514 of FIG. 5). Alternatively, the substrate can be a stationary substrate having a fixed position and orientation (e.g., the bottom surface of the vat 316 of FIGS. 3A-3D).

The method 600 can continue at block 604 with applying first energy to the curable material to form an object portion on a build platform. For example, a first energy source (e.g., a laser, projector, light engine) can output the first energy (e.g., light energy) to at least partially cure the curable material to form the object portion. The energy can be patterned or scanned onto the curable material in a geometry corresponding to the desired geometry for the object portion. In some embodiments, the energy source directs energy through the substrate to reach the curable material, and the substrate is partially or fully transparent to the wavelength of energy produced by the energy source.

The method 600 can continue at block 606 with depositing a fiber onto and/or into the object portion. In some embodiments, the fiber includes a material or a combination of materials that are configured to confer desired properties to the object (e.g., a strength, stiffness, durability, resistance to stress relaxation). The fiber may include one or more of a glass fiber, a carbon fiber, a metallic fiber, a natural fiber (e.g., wood, flax, silk, cotton, and/or hemp), or a synthetic and/or polymeric fiber (e.g., polyester, polyvinyl acrylic, polyolefin, etc.). For instance, the fiber can be a biocompatible fiber, such as a biocompatible glass fiber. The fiber may optionally be optically transparent or translucent, e.g., if the curable material used to fabricate the object portion is also transparent or translucent. The fiber may be deposited as a continuous fiber, e.g., having a desired length of at least 1 mm, 5 mm, 10 mm, 20 mm, 30 mm, 40 mm, 50 mm, or more.

In some embodiments, the desired length of the fiber exceeds a predetermined length. The predetermined length can be a minimum length to effectively strengthen and/or stiffen the cured material around the fiber (“material matrix”). In some embodiments, the predetermined length is a critical fiber length; the term “critical fiber length” can refer to a minimum length of the fiber to ensure that stresses applied to the material matrix are effectively transferred to the fiber (e.g., at least 50%, 60%, 70%, 75%, 80%, 85%, 90%, 95%, or 99% of the stress applied to the material matrix is transferred to the fiber).

The predetermined length may be based on a tensile strength of the fiber, a diameter of the fiber, a shear strength between the fiber and the material matrix, or a combination thereof. For example, the predetermined length may be based on a product of the tensile strength of the fiber and the diameter of the fiber. In some embodiments, the predetermined length is based on a ratio of the tensile strength of the fiber and the shear strength between the fiber and the material matrix, the diameter of the fiber and the shear strength between the fiber and the material matrix, or a combination thereof.

In some embodiments, the predetermined length is determined according to the following equation:

$${L}_{c} = \frac{{σ}_{f} \cdot d}{2 τ}$$

where L_{c} is the predetermined length (e.g., critical fiber length), σ_{f} is the tensile strength of the fiber, d is the diameter of the fiber, and τ is the shear strength between the fiber and the material matrix. If the fiber is shorter than the predetermined length L_{c}, stresses with the material matrix may not be sufficiently transferred into the fiber, thus resulting in suboptimal reinforcement of the material matrix. As an example, for a glass fiber having a tensile strength of 2000 MPa, a fiber diameter of 15 μm, and a shear strength in a photopolymer matrix within a range from 1 MPa to 20 MPa, the predetermined length L_{c} can be within a range from 0.75 mm to 15 mm. Thus, the desired length of the fiber in the object portion may be greater than or equal to 1 mm, 5 mm, 10 mm, 15 mm, 20 mm, 30 mm, 40 mm, 50 mm, or more.

The fiber may be supplied from a fiber source (e.g., the fiber source 320 of FIGS. 3A-3D) and may be deposited onto and/or into the object portion via a nozzle. For instance, the nozzle may include a channel for depositing the fiber. The channel may be angled relative to a surface of the build platform (e.g., at an angle of 15 degrees, 30 degrees, 45 degrees, 60 degrees, 75 degrees, etc.). This may reduce bending, kinking, and/or fracturing of the fiber as the fiber is deposited onto and/or into the object portion. The fiber may be deposited in a plurality of locations onto and/or into the object portion. For instance, the fiber may be deposited onto and/or into one or more of an upper surface of the object portion, a lower surface of the object portion, a channel defined within the object portion, a lateral surface of the object portion, an external surface of the object portion, etc. In some embodiments, the fiber is deposited onto and/or into a plurality of object portions, e.g., the fiber may be inserted into the plurality of object portions.

At block 608, the method 600 can continue with applying second energy to the fiber to affix the fiber to the object portion. For instance, a second energy source (e.g., a laser, projector, light engine) may direct the second energy (e.g., light energy) at second curable material surrounding the fiber and/or second curable material disposed on or within the fiber, where the curing of the second curable material by the second energy can adhere the fiber to the object portion. Alternatively, the second energy can be applied by the first energy source. Optionally, the second energy may be similar to the first energy. For instance, the second energy may have the same wavelength, directionality, intensity, spot size, etc. as the first energy. The second curable material may or may not be the same as the curable material used to form the object portion. The second curable material may be present on the object portion prior to deposition of the fiber, or the second curable material may be deposited with the fiber. For instance, the fiber can be coated, co-extruded, or impregnated with the second curable material. In such embodiments, the method 600 may optionally include depositing the second curable material on the fiber, such as before, concurrently with, or after the deposition of the fiber in block 606. In other embodiments, the fiber may already include the second curable material (e.g., a pre-preg fiber), such that the second curable material need not be deposited onto and/or into the fiber 212 in situ.

Optionally, the method 600 may also include cutting the fiber, such as before, concurrently with, or after the deposition of the fiber in block 606. For instance, the fiber may be cut to a desired length as the fiber exits the nozzle. In some embodiments, the fiber is cut via a blade, laser, and/or any other suitable element for cutting, breaking, ablating, or otherwise separating the fiber. In some embodiments, cutting the fiber includes actuating a cutting element (e.g., a blade) between a retracted configuration in which the cutting element is positioned away from the fiber to an extended configuration in which the cutting element extends into contact with and/or past the fiber. The cutting may occur at an outlet of the nozzle, or may occur within the nozzle, as described elsewhere herein.

The processes of blocks 602-606 can be repeated multiple times to build up the object geometry in a layer-by-layer manner. In some embodiments, after the fiber is affixed to the object portion according to the process of block 608, the method 600 may return to the process of block 602 with depositing additional curable material onto the object portion and/or the fiber. The method 600 may proceed with forming an additional object portion, depositing additional fiber onto and/or into the additional object portion, and applying second energy to the additional fiber to affix the additional fiber to the additional object portion. This process can be repeated until the entire geometry of the object has been produced, and the sequence of forming object portions and depositing fiber may vary, e.g., as described elsewhere herein.

The method 600 illustrated in FIG. 6 can be modified in many different ways. For example, although the above processes of the method 600 are described with respect to a single object, the method 600 can be used to sequentially or concurrently fabricate any suitable number of objects, such as tens, hundreds, or thousands of additively manufactured objects. As another example, the ordering of the processes shown in FIG. 6 can be varied, and/or some of the processes of the method 600 can be omitted. For instance, the processes of blocks 602 and 604 may be repeated multiple times before proceeding to the processes of blocks 606 and 608, and/or the processes of blocks 606 and 608 may be repeated multiple times before returning to the processes of blocks 602 and 604.

FIG. 7 is a flow diagram illustrating a method 700 for fabricating a fiber-reinforced dental appliance, in accordance with embodiments of the present technology. The method 700 can be performed using any of the systems and devices described herein, such as any of the embodiments of FIGS. 1-5. However, the method 700 may additionally or alternatively be performed using any suitable additive manufacturing system. For instance, the method 700 may be performed using an additive manufacturing system having different fiber sources, material sources, and/or energy sources than the representative components of FIGS. 1-5, and/or may be performed using an additive manufacturing system in which some of the component of FIGS. 1-5 are omitted. In some embodiments, some or all of the processes of the method 700 are implemented as computer-readable instructions (e.g., program code) that are configured to be executed by one or more processors of a computing device, such as a controller of a fabrication system. The method 700 may be combined with any of the other methods described herein, such as the method 600 of FIG. 6

The method 700 can begin at block 702 with fabricating a plurality of additively manufactured layers to form a portion of an appliance shell. The additively manufactured layers can be fabricated using any of the additive manufacturing processes described herein, such as any of the additive manufacturing processes described above. In some embodiments, the additively manufactured layers are formed from a polymeric material (e.g., a curable resin), where first energy (e.g., light energy) is applied to cure or otherwise solidify the polymeric material into a material matrix, e.g., as discussed with respect to blocks 602 and 604 of the method 600 of FIG. 6. The additively manufactured layers can be built up layer-by-layer in a successive fashion.

In some embodiments, the appliance shell is part of a dental appliance. For instance, the appliance shell may be part of an aligner, palatal expander, retainer, attachment placement device, etc. In some embodiments, the appliance shell includes a plurality of tooth-receiving cavities shaped to receive a patient's dentition. The appliance shell may be configured to be worn on a patient's teeth during or after a dental treatment.

The method 700 can continue at block 704 with fabricating a fiber coupled to the portion of the appliance shell to reinforce the portion. For example, the fiber can be deposited from a fiber source of a fiber system (e.g., the fiber system of any one of FIGS. 2-5) onto and/or into the portion of the appliance shell. The fiber may be coupled to the portion of the appliance shell during and/or after deposition, such as by applying second energy to the fiber to cure or otherwise solidify a curable material on or around the fiber, thereby affixing the fiber to the material matrix of the appliance portion, e.g., as discussed with respect to blocks 604 and 608 of the method 600 of FIG. 6. The fiber can be coupled to the appliance shell at a variety of locations. In some embodiments, the fiber is coupled to an occlusal surface of the appliance shell, a buccal surface of the appliance shell, and/or a lingual surface of the appliance shell. The fiber can be positioned entirely within an interior volume of the appliance shell, or the fiber can be positioned entirely on an external surface of the appliance shell. In some embodiments, the fiber is coupled to a plurality of portions of the appliance shell.

The fiber can be the same as or generally similar to any of the fibers described herein, such as the fiber 212 of the fiber system 206 of FIG. 2. For instance, the fiber may include a material or a combination of materials that are configured to confer desired properties to the fiber-reinforced dental appliance (e.g., a strength, stiffness, durability, resistance to stress relaxation). The fiber may include one or more of a glass fiber, a carbon fiber, a metallic fiber, a natural fiber (e.g., wood, flax, silk, cotton, and/or hemp), or a synthetic and/or polymeric fiber (e.g., polyester, polyvinyl acrylic, polyolefin, etc.). The fiber may be a biocompatible fiber, such as a biocompatible glass fiber. Further, the fiber may be optically transparent or translucent, e.g., if the curable material used to fabricate the object portion is also transparent or translucent. The fiber may be deposited as a continuous fiber, e.g., having a desired length of at least 1 mm, 5 mm, 10 mm, 20 mm, 30 mm, 40 mm, 50 mm, or more. The desired length may exceed a predetermined length (e.g., a critical fiber length), as previously discussed with respect to block 606 of the method 600 of FIG. 6. For instance, the method 700 may optionally include identifying a predetermined length for the fiber, where the predetermined length is based on: a ratio of a tensile strength of the fiber and a shear strength between the fiber and a material matrix of a polymer, a diameter of the fiber and the shear strength between the fiber and the material matrix of the polymer, or a combination thereof. The predetermined length can be used to identify a desired length for the fiber within the dental appliance.

In some embodiments, fabricating the fiber includes fabricating the fiber from a plurality of transparent fibers in a conformal fiber pattern that follows one or more geometrical contours of the portion of the dental appliance. The plurality of transparent fibers may include a conformal fiber pattern following one or more geometrical contours of the portion of the dental appliance. Alternatively or in combination, other fiber configurations may be used, such as any of the embodiments described in Section II below.

In some embodiments, after the fiber is fabricated and coupled to the portion of the appliance shell according to the processes of block 704, the method 700 may return to the processes of block 702 with fabricating an additional plurality of additively manufactured layers to form an additional portion of the appliance shell. The method 700 may proceed with fabricating additional fibers coupled to the additional portion of the appliance shell. These processes can be repeated until the entire geometry of the dental appliance has been produced, and the sequence of fabricating the appliance shell portions and the fiber may vary. For instance, the processes of block 702 may be repeated before advancing to the processes of block 704, and/or the processes of block 704 may be repeated before returning to the processes of block 702.

The method 700 illustrated in FIG. 7 can be modified in many different ways. For example, although the above processes of the method 700 are described with respect to a single appliance, the method 700 can be used to sequentially or concurrently fabricate any suitable number of appliances, such as tens, hundreds, or thousands of appliances. As another example, the ordering of the processes shown in FIG. 7 can be varied, as described above. As a further example, the method 700 can additionally include curing or post-processing steps, e.g., during fabrication of the shell and/or the fiber, and/or during coupling of the fiber to the appliance shell.

### II. Fiber-Reinforced Additively Manufactured Objects

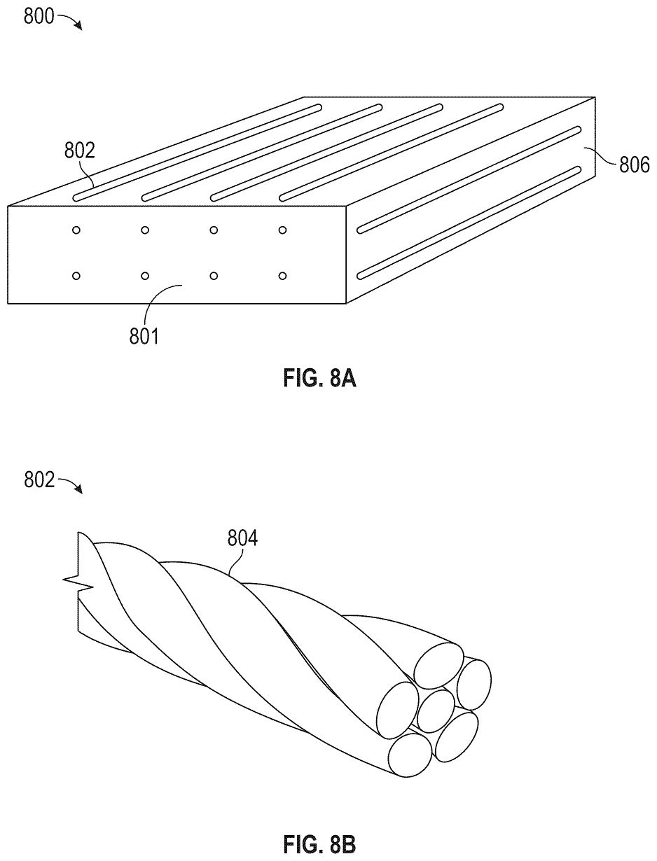

FIG. 8A is a representative example of an object portion 800 including a material matrix 801 reinforced by a plurality of fibers 802, in accordance with embodiments of the present technology. For example, the object portion 800 can be a portion of an additively manufactured dental appliance, such as any of the embodiments described with respect to FIGS. 9A-26 and in Section III below. The object portion 800 may be fabricated using any suitable system and method, including but not limited to the systems and methods described in Section I above.

The material matrix 801 can be an additively manufactured material, such as a material composed of plurality of polymer layers (e.g., a photopolymerized resin) as discussed in Section I above. In some embodiments, the fibers 802 each include a material or a combination of materials that are configured to confer desired properties to the object portion 800 (e.g., strength, stiffness, durability, resistance to stress relaxation) by reinforcing the material matrix 801. In some embodiments, the fibers 802 include one or more of a glass fiber (e.g., a biocompatible glass fiber (also known as “bioglass fiber”), a carbon fiber, a metallic fiber, a ceramic fiber, a natural fiber (e.g., wood, flax, silk, cotton, and/or hemp), or a synthetic and/or polymeric fiber (e.g., polyester, polyvinyl acrylic, polyolefin). In some embodiments, the fibers 802 are biocompatible fibers, such as biocompatible glass fibers. In some embodiments, each of the fibers 802 is configured to maintain its material properties in humid environments, such as an oral cavity. In some embodiments, the fiber 802 is optically transparent. The fiber 802 may be composed of a material having a refractive index that is identical or similar to the rest of the object portion 800 to maintain the transparency or translucency of the object portion 800. Alternatively, the fiber 802 may be opaque and/or colored, e.g., to provide a desired aesthetic effect.

In some embodiments, the fibers 802 are continuous fibers. The fibers 802 can have a desired length. In some embodiments, the desired length exceeds a predetermined length, which may be a critical length as described above with respect to block 606 of the method 600 of FIG. 6. For example, the desired length can exceed a predetermined length. The predetermined length can be a minimum length to effectively strengthen and/or stiffen the material matrix 801 (e.g., cured material) of the object portion 800. In some embodiments, the predetermined length is a critical fiber length. The predetermined length may be based on a tensile strength of the fiber 802, a diameter of the fiber 802, a shear strength between the fiber 802 and the material matrix 801, or a combination thereof. For example, the predetermined length may be based on a product of the tensile strength of the fiber 802 and a diameter of the fiber 802. In some embodiments, the predetermined length is based on a ratio of the tensile strength of the fiber 802 and a shear strength between the fiber 802 and the material matrix 801, the diameter of the fiber 802 and the shear strength between the fiber 802 and the material matrix 801, or a combination thereof.

The desired length of the fiber 802 may be greater than or equal to 1 mm, 5 mm, 10 mm, 15 mm, 20 mm, 30 mm, 40 mm, 50 mm, or more. In some embodiments, the desired length is greater than 10 mm. Further, in some embodiments, the object portion 800 may not include any fibers having a length less than or equal to 1 mm.

The fibers 802 can each include a single fiber filament, or a plurality of fiber filaments. For example, FIG. 8B is a closeup view of an individual fiber 802 of FIG. 8A, in accordance with embodiments of the present technology. As illustrated, the fiber 802 can include a plurality of interwoven fiber filaments 804. While the illustrated fiber 802 includes 6 fiber filaments, any number of fiber filaments are possible. For instance, the fiber 802 can include at least 2 fiber filaments, 10 fiber filaments, 20 fiber filaments, 50 fiber filaments, 100 fiber filaments, 150 fiber filaments, 200 fiber filaments, 500 fiber filaments, etc. The diameter of each fiber filament 804 can be within a range from 0.5 microns to 5 microns, 1 micron to 5 microns, 1 micron to 10 microns, 5 microns to 10 microns, 10 microns to 20 microns, etc. In some embodiments, the total diameter of the fiber 802 is less than 1000 microns, 500 microns, 400 microns, 300 microns, 200 microns, or 100 microns. Moreover, many other patterns for the fiber 802 may be used such as a central core with one or more filaments wrapped around it substantially perpendicular to its axis (also known as a wrap-around pattern).

Returning again to FIG. 8A, at least some or all of the fibers 802 can be positioned within an internal volume of the object portion 800. In some embodiments, some or all of the fibers 802 are additionally or alternatively positioned on an external surface 806 of the object portion 800. Some or all of the fibers 802 can be oriented along a longitudinal axis of the object portion 800, e.g., as illustrated. Alternatively or in combination, some or all of the fibers 802 can be oriented in any of a variety of directions relative to the object portion 800. While the fibers 802 are depicted as being parallel with each other, some or all of the fibers 802 may alternatively be angled relative to each other, interwoven with each other, etc.

In some embodiments, the fibers described herein are used to reinforce additively manufactured dental appliances. The fibers may be selectively positioned to reinforce the dental appliance, e.g., by reinforcing “weak” spots in the dental appliance without substantially influencing the mechanical properties in other regions of the dental appliance. In some embodiments, the degree of reinforcement is determined at least in part by the structure and arrangement of the fiber (e.g., orientation, density, fiber diameter, fiber length, fiber curvature, connectivity). The appropriate fiber structure and configuration can be determined for various dental applications.

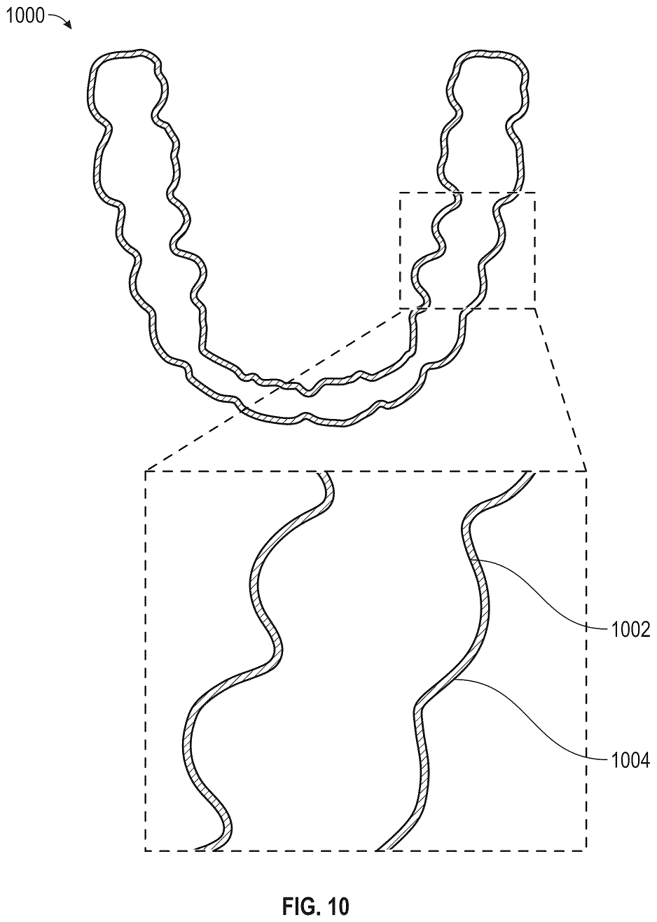

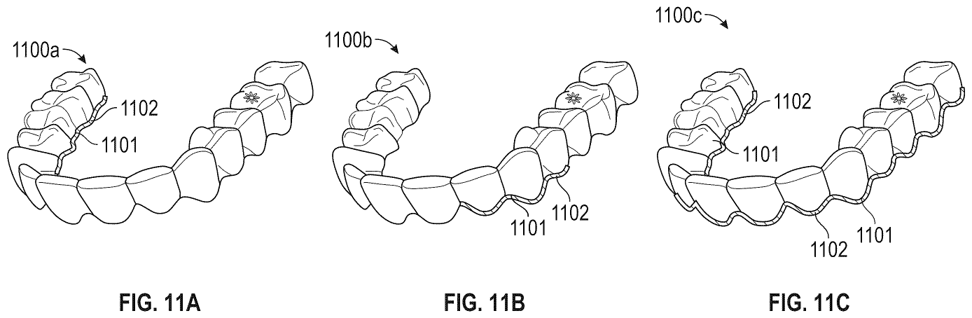

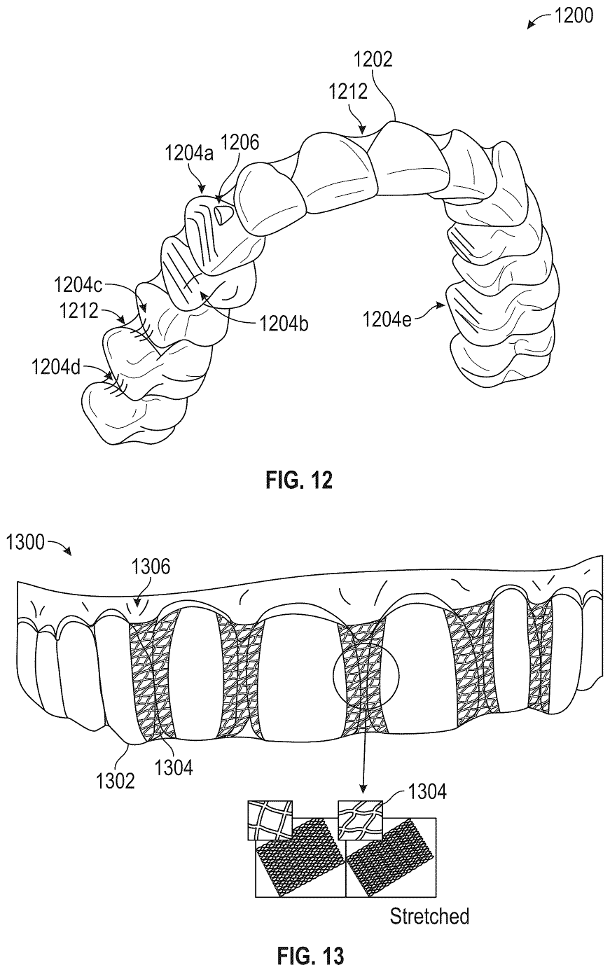

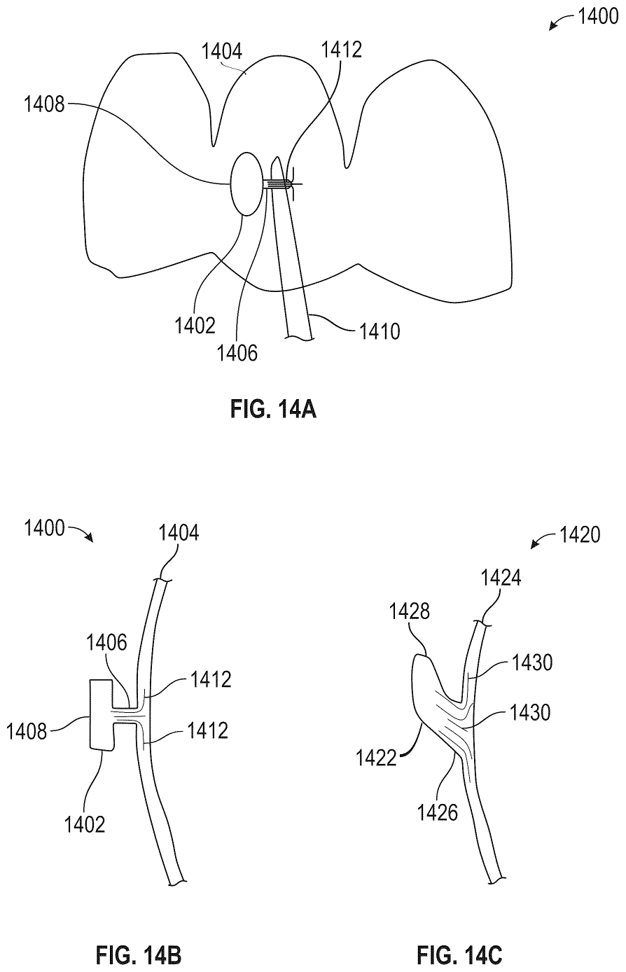

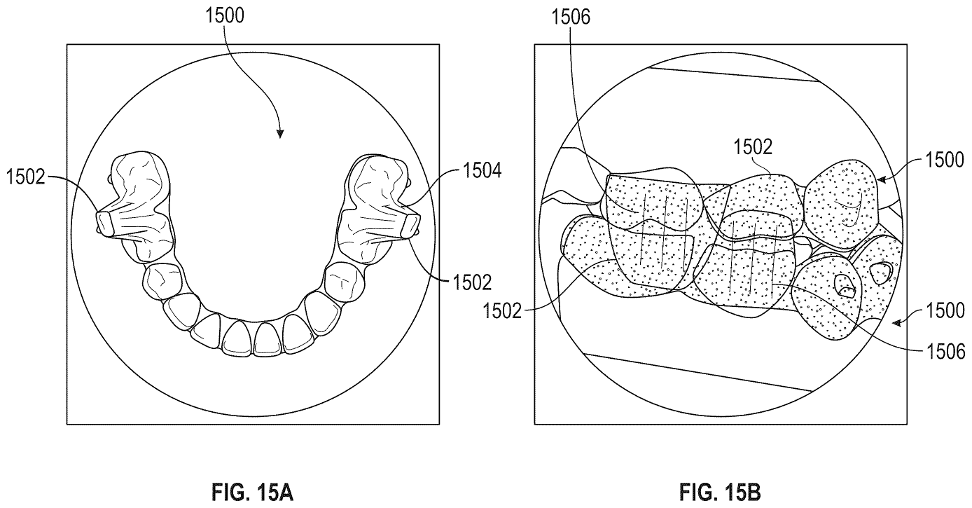

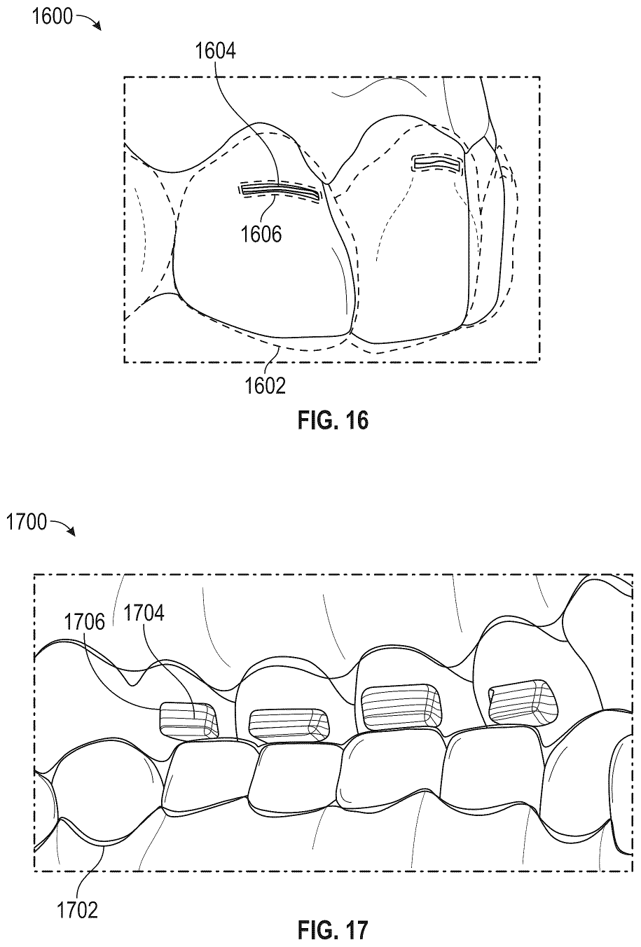

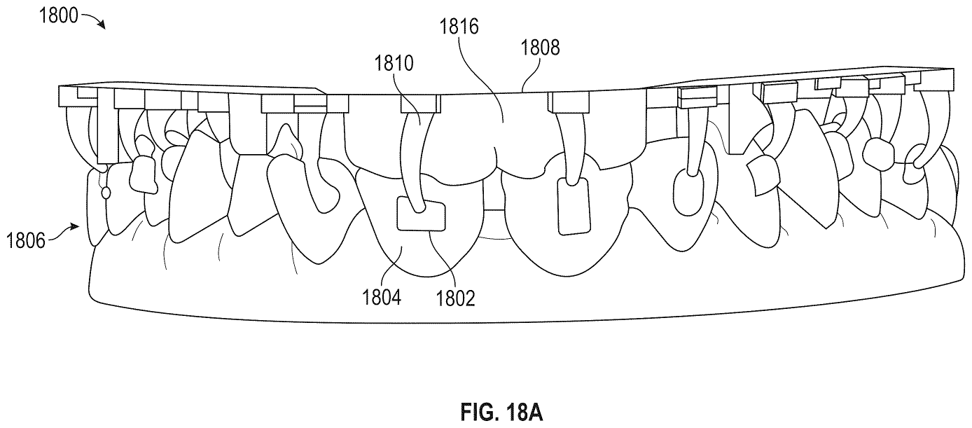

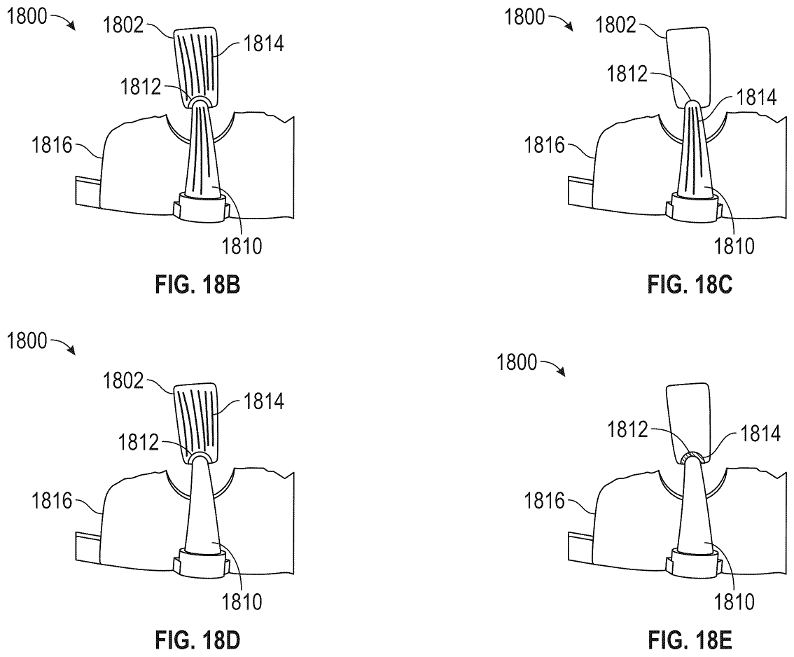

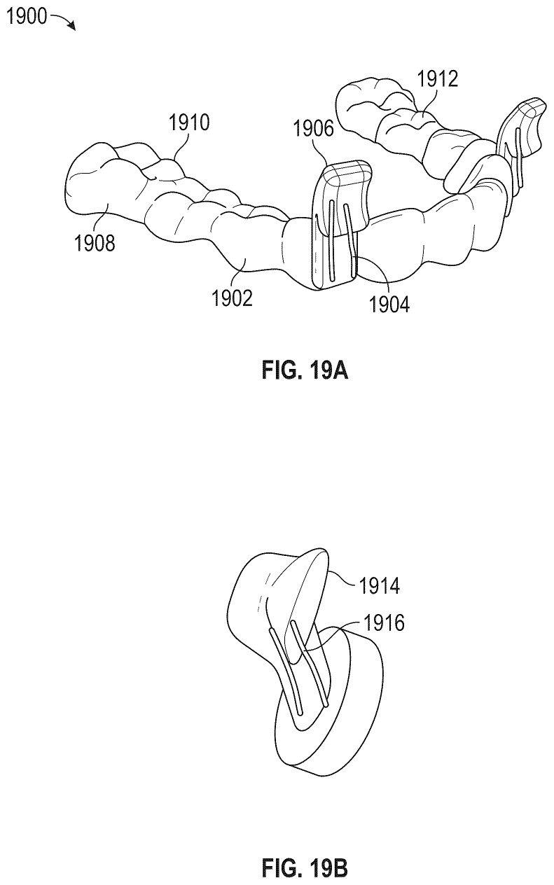

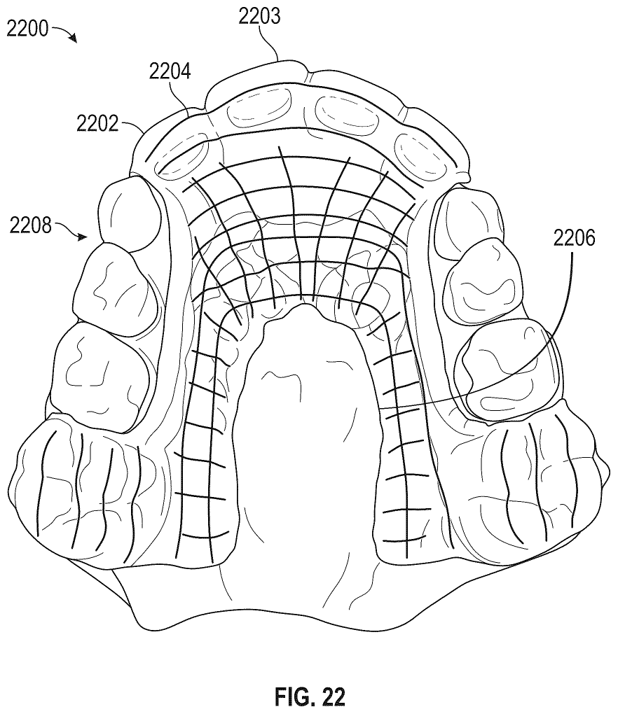

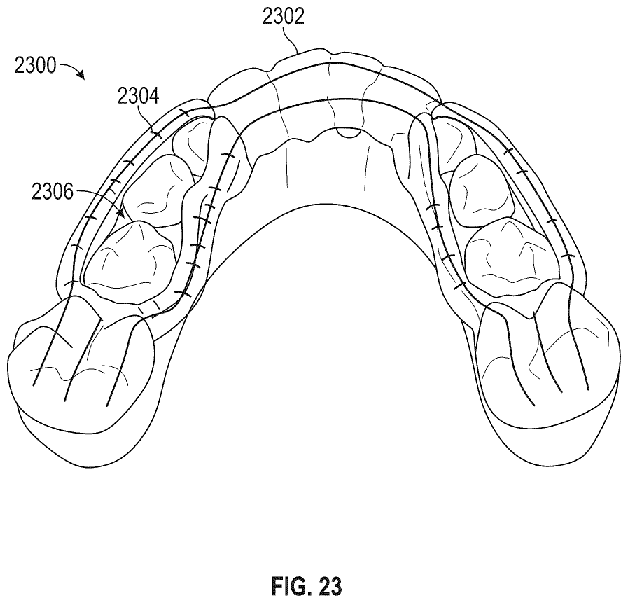

In some embodiments, fibers are positioned at stress concentration points near trimlines (e.g., as described in connection with FIGS. 11A-11C), attachments (e.g., as described in connection with FIGS. 18A-18E), precision cuts, buttons (e.g., as described in connection with FIGS. 14A and 14B), hooks (e.g., as described in connection with FIG. 14C, FIGS. 19A and 19B), attachment receiving cavities (e.g., as described in connection with FIG. 12), precision wings and/or occlusal blocks (e.g., as described in connection with FIGS. 15A and 15B), interproximal regions (e.g., as described in connection with FIG. 13), space closures, power ridges (e.g., as described in connection with FIG. 16), bite ramps (e.g., as described in connection with FIG. 17), and/or cutouts (e.g., as described in connection with FIGS. 22 and 23).

One aspect of dental appliance design for treatment is to control the movement of groups of teeth with respect to each other. Fibers may be used to control localized stiffness and/or other material properties in various parts of the dental appliance to allow for control over one or more teeth that are anchored and not intended to move, as well as control over one or more teeth in the dental arch that are intended to move. For example, the teeth received by a dental appliance may be divided into two groups (teeth that are anchored versus teeth that are intended to move), with the teeth within each group held together with an appliance portion having a high stiffness fiber “weave,” and with the two groups being connected by an appliance portion having more flexible, less stiff fiber weave. This configuration may be used to achieve movement of the two groups of teeth with respect to one another in a controlled manner. A dental appliance designed and fabricated with this fiber structure may be applicable to many clinical applications, such as extraction space closure (e.g., closing the space where a tooth has been extracted). Other clinical applications include vertical movement of the upper and lower anterior dentition to open a deep bite, or closure of an open bite while the posterior dentition remains anchored together and little vertical movement occurs.

Dental appliances including smaller diameter fibers that are woven with specific patterns may allow the dental appliance to exhibit variable stiffness in different directions and/or at different portions of the arch. For example, weaves with low stiffness and larger ranges of movement may be appropriate for the anterior portions of the arch, whereas stiffer weaves with smaller ranges of movement may be appropriate for the posterior portions of the arch. The material connecting these two parts of the arch may have various stiffness characteristics as is appropriate for treatment, such as high or low torsional stiffness and/or rigidity, or high buccal-lingual stiffness and/or rigidity when bending. Various fiber patterns in different locations along the arch allow can for differential stiffness around the arch, directional control of the forces and moments applied to the dentition, and/or improved control of the amount of specific tooth movements during treatment.

Multiple different diameters or cross-sectional sizes of fibers are possible, as well as multiple fiber heads. By matching the refractive indices of the polymeric material and the fiber, the final dental appliance may be transparent. The identification of the dental appliance structure can be pre-calculated based on Finite Element Analysis (FEA), e.g., by identifying stress concentration points, experimentation (e.g., breakage test(s)), clinical data, clinician feedback, etc. The dental appliance structure may also be based on desired force systems, e.g., action and reaction forces produced by the dental appliance can be determined and adjusted to ensure they are beneficial to treatment and do not create issues. The selected structure can be pre-embedded in design software, or the design can be customized for each dental appliance for each patient.

FIGS. 9A-26 illustrate representative examples of fiber-reinforced dental appliances and associated structures, in accordance with embodiments of the present technology. The dental appliances and structures of FIGS. 9A-26 can be fabricated using any of the systems and methods described herein, e.g., in Sections I and III. Moreover, any of the features of the embodiments of FIGS. 9A-26 may be combined with each other and/or any of the other embodiments described herein. For example, any of the fibers of the embodiments of FIGS. 9A-26 can include any of the properties of the fibers 802 described in connection with FIGS. 8A and 8B and/or in Section I above.

FIGS. 9A and 9B illustrate an example dental appliance 900 configured in accordance with embodiments of the present technology. Specifically, FIG. 9A is a perspective view of the dental appliance 900, and FIG. 9B is a top cross-sectional view of the dental appliance 900. Referring first to FIG. 9A, the dental appliance 900 can be an aligner, palatal expander, retainer, attachment placement device, oral sleep apnea appliance, mouth guard, etc. The dental appliance 900 includes a shell 902 including a plurality of cavities for receiving a patient's teeth, and a fiber 904 coupled to the shell 902. The fiber 904 can be used to reinforce the shell 902, e.g., by increasing the stiffness, torsional rigidity, strength, tear resistance, creep resistance, and/or stability of the portions of the shell 902 to which the fiber 904 is coupled. This may be advantageous, for example, to enhance the forces applied to the patient's teeth by the shell 902, to reduce deformation and/or stress relaxation of the shell 902 during use, to ensure that the shell 902 is seated firmly on the teeth, etc.

In the illustrated embodiment, the fiber 904 is a single continuous fiber that is located at the gingival edges of the shell 902 and generally follows the contours of the gingival edges. Accordingly, the fiber 904 may reinforce the gingival edges of the shell 902, e.g., to increase the stiffness, torsional rigidity, strength, tear resistance, creep resistance, and/or stability of the gingival edges of the shell 902. In other embodiments, however, the fiber 904 may be alternatively or additionally be located at other portions of the dental appliance 900, such as on or within a buccal surface of the shell 902, on or within a lingual surface of the shell 902, on or within an occlusal surface of the shell 902, on or within another structure coupled to the shell 902 (e.g., a palatal expander portion, an occlusal block), on or within a posterior portion of the shell 902, on or within an anterior portion of the shell 902, etc. Moreover, although FIG. 9A illustrates a single fiber 904, the dental appliance 900 may include a plurality of fibers 904, each of which may be positioned at any suitable location. In some embodiments, the fiber 904 includes conformal fiber following one or more geometric contours of one or more portions of the dental appliance 900.

In embodiments where the shell 902 is fabricated from a plurality of layers (e.g., cured material layers), some or all of the layers may include one or more fibers, or some or all of the layers may not include any fiber. For instance, each of the plurality of layers may include fiber. Alternatively, increments of layers may include fiber. For instance, every 2 layers, every 5 layers, every 10 layers, every 20 layers, every 50 layers, etc., of the shell 902 may include fiber. Alternatively, only layers within 2 layers, 5 layers, 10 layers, 20 layers, etc., of the gingival edges of the shell 902 may include fiber. In some embodiments, a single layer includes a single continuous fiber. Alternatively, a single layer may include a plurality of discrete fibers. Further, a single fiber may extend through more than one layer, e.g., a single fiber may extend through 2 or more layers, 5 or more layers, 10 or more layers, etc.

In some embodiments, as best seen in FIG. 9B, the fiber 904 is embedded within the internal volume of the dental appliance 900. For instance, the fiber 904 may be contained entirely within the internal volume of the shell 902 (e.g., the fiber 904 is located between and offset from the lingual and buccal surfaces of the shell 902), thus reducing or preventing any interference with the surface quality and/or functionality of the dental appliance 900.

FIG. 10 illustrates an example dental appliance 1000 configured in accordance with embodiments of the present technology. The dental appliance 1000 can be generally similar to the dental appliance 900 of FIG. 9. For instance, the dental appliance 1000 can include a shell 1002 and a fiber 1004. In contrast with the fiber 904 of the dental appliance 900, the fiber 1004 is located along an external surface of the dental appliance 1000, rather than being embedded within the internal volume of the dental appliance 1000. In the illustrated embodiment, the fiber 1004 is positioned on the lingual surface of the shell 1002 and generally follows the contours of the lingual surface. This configuration may be advantageous, for example, to avoid interfering with the geometry of the cavities of the shell 1002 (which may affect the fit and/or functionality of the dental appliance 1000), particularly if deposition and fixation of the fiber 1004 causes some deformation of the shell 1002 and/or is limited in accuracy. In other embodiments, however, the fiber 1004 may alternatively or additionally be positioned on a buccal surface of the shell 1002, on an occlusal surface of the shell 1002, or any other suitable locations, as described elsewhere herein.

FIGS. 11A-11C illustrate example dental appliances configured in accordance with embodiments of the present technology. Specifically, FIG. 11A is a perspective view of a first dental appliance 1100a, FIG. 11B is a perspective view of a second dental appliance 1100b, and FIG. 11C is a perspective view of a third dental appliance 1100c. The dental appliances 1100a, 1100b, and 1100c (collectively, “dental appliances 1100”) can each include a fiber 1102 positioned along respective gingival edges (“trimlines” 1101) of the dental appliances 1100 to provide mechanical reinforcement to the portions of the dental appliances 1100 proximate to the trimlines 1101, e.g., by increasing the stiffness, torsional rigidity, strength, tear resistance, creep resistance, and/or stability of the dental appliances 1100 near respective trimlines 1101 of the dental appliances 1100. This may improve retention of the dental appliances 1100 on a patient's teeth, and/or may improve force application of the dental appliances 1100 to the patient's teeth. Moreover, reinforcement of the portions of the dental appliance 1100 proximate to the trimlines 1101 may be advantageous since these portions may be more prone to deformation during fabrication, post-processing (e.g., centrifugation), handling, and/or use (e.g., placement and/or removal of the dental appliances 1100 on the patient's teeth).

The fiber 1102 can be positioned at any suitable location along the trimline 1101 to provide a desired extent of reinforcement. For instance, the dental appliance 1100a of FIG. 11A includes a fiber 1102 positioned along a portion of or the entire trimline 1101 of a lingual side of the dental appliance 1100a. The dental appliance 1100b of FIG. 11B includes a fiber positioned along a portion of the trimline of a buccal side of the dental appliance 1100b, e.g., the portion proximate to the canines and/or lateral incisors, which may be subjected to greater forces during insertion and removal of the dental appliance 1100b on the teeth compared to other portions of the dental appliance 1100b. The dental appliance 1100c of FIG. 11C includes a fiber 1102 positioned along a portion of or the entire trimline 1101 on both the buccal and lingual sides of the dental appliance 1100c.

FIG. 12 illustrates another example dental appliance 1200 configured in accordance with embodiments of the present technology. The dental appliance 1200 can be an orthodontic aligner 1200 having a shell 1202 including a plurality of tooth-receiving cavities and one or more fibers 1204a-1204e (collectively, “fibers 1204”) coupled to the shell 1202. The fibers 1204 may be configured to reinforce the dental appliance 1200, e.g., by increasing the stiffness, torsional rigidity, strength, tear resistance, creep resistance, and/or stability of the dental appliance 1200 in a particular direction or area. The fibers 1204 may also cause anisotropy in the aligner structure and allow the dental appliance 1200 to have different stiffnesses in different directions. The direction of the stiffness may be determined based on a programmed tooth movement in an orthodontic treatment plan. For example, the stiffness may be increased in areas with increased force or anticipated force concentrations, and/or in areas where the dental appliance 1200 is likely to bend or deform in an undesirable manner.

The fibers 1204 can be continuous fibers having a length of at least 1 mm, such as at least 5 mm or 10 mm. The fibers 1204 may be optically transparent and/or biocompatible. Further, the fibers 1204 may span a single layer of the dental appliance 1200, or may span a plurality of layers of the dental appliance 1200. The fibers 1204 may be positioned within an interior volume of the dental appliance 1200, or the fibers 1204 may be positioned on an external surface of the dental appliance 1200.

In some embodiments, the fibers 1204 include first fibers 1204a configured to reinforce the aligner sidewall and/or distribute the forces imparted to an attachment receiving cavity 1206 by an attachment when the dental appliance 1200 is worn by a patient. The first fibers 1204a can extend from a gingival portion of a tooth-receiving cavity, such as near a gingival edge of the tooth-receiving cavity, towards an occlusal or incisal surface of a tooth-receiving cavity. The first fibers 1204a can be straight, curved, or curvilinear. The first fibers 1204a can be equidistant from each other or, in some embodiments, the distance between respective first fibers 1204a may vary. For example, the distance between the first fibers 1204 can increase as a function of the distance of the first fibers 1204a from the attachment receiving cavity 1206, such that a stress concentration that may otherwise be caused by the fibers may be reduced and/or resisted. In some embodiments, the length of the first fibers 1204a can increase or decrease as a function of distance from the attachment receiving cavity 1206.

The fibers 1204 can additionally or alternatively include second fibers 1204b. The second fibers 1204b may be used in the sidewalls of a tooth-receiving cavity shaped to extrude a tooth without use of attachments. During tooth extrusion, the tooth-receiving cavity can act on the undercut of the tooth in order to provide an extrusion force on the tooth. During extrusion, even a slight bow or deformation of the sidewalls of the tooth-receiving cavity can reduce the already limited amount of force available to extrude the teeth. Second fibers 1204b can be added to the sidewalls of the tooth-receiving cavity for extrusion in order to stiffen the sidewall and reduce or prevent undesirable deformation. The second fibers 1204b may extend from a gingival location of the tooth-receiving cavity towards an occlusal or incisal surface of the tooth-receiving cavity. In some embodiments, the second fibers 1204b can extend into the occlusal surface of the tooth-receiving cavity. In some embodiments, the sidewalls of the tooth-receiving cavity can include two or more second fibers 1204b. The second fibers 1204b can be arranged parallel to each other. In some embodiments, the tooth-receiving cavity can include second fibers 1204b in one or both of the lingual or buccal sidewalls.

The fibers 1204 can additionally or alternatively include third fibers 1204c. The third fibers 1204c can extend along an interproximal region 1212 of the dental appliance 1200, between adjacent tooth-receiving cavities. In the dental appliance 1200, stress concentrations may be formed in the interproximal region 1212 between tooth receiving cavities. For example, if a tooth is being distalized or moved in a distal direction, increased forces may be applied across an interproximal region between the distalized tooth and an adjacent tooth. The third fibers 1204c can be formed within the dental appliance 1200 and extend from a distal portion of a first tooth-receiving cavity, across an interproximal region 1212, and to a mesial portion of a second, adjacent tooth-receiving cavity. As shown in FIG. 12, the third fibers 1204c can include a plurality of fibers arranged parallel to each other and extending along a mesial-distal direction.

The fibers 1204 can additionally or alternatively include fourth fibers 1204d. The fourth fibers 1204d can extend along a plurality of tooth receiving cavities of the dental appliance 1200. For example, the fourth fibers 1204d may extend between two or more adjacent tooth-receiving cavities. In an orthodontic aligner or a retainer, the patient may have a missing tooth or have a large interproximal gap between adjacent teeth. Aligners typically rely on the patient's teeth in order to provide additional structural rigidity to the aligner and to prevent deformations into the teeth. However, if a tooth is missing or the patient has a large interproximal gap, an aligner may be unsupported across a large portion of its length. The unsupported portions of the aligner may deform under relatively low loads and therefore may not be able to transmit forces desired for tooth movement. One or more fourth fibers 1204d can be used to stiffen and add strength to the dental appliance 1200 across portions of the dental appliance 1200 where the patient is missing a tooth or an interproximal region. As shown in FIG. 12, the fourth fibers 1204d, which can be a bundle of fibers, can be formed within the aligner sidewall and extend from a distal portion of a first tooth-receiving cavity, across an interproximal location, and to a mesial portion of a second, adjacent tooth-receiving cavity.

Any of the fibers 1204 may be placed on a buccal side and/or a lingual side of the dental appliance 1200. For example, as shown in FIG. 12, lingual fibers 1204e are placed on or in lingual sidewalls of the dental appliance 1200. Although the lingual fibers 1204e are depicted as having similar shapes and relationships as those of the second fibers 1204b, the lingual fibers 1204e can have the shapes, locations, and properties of any of the fibers described herein. In some embodiments, similar fibers may be placed on both the lingual and buccal sidewalls of the dental appliance 1200.

The dental appliance 1200 can be fabricated in accordance with any of the embodiments provided herein. For instance, the shell 1202 can be fabricated from a plurality of polymer layers in an additive manufacturing process, and the fibers 1204 can be inserted into and/or deposited onto the polymer layers during additive manufacturing.

FIG. 13 illustrates a portion of another example dental appliance 1300 configured in accordance with embodiments of the present technology. The dental appliance 1300 can include a shell 1302 having a plurality of tooth-receiving cavities, and a fiber network 1304. The fiber network 1304 may include an arrangement of fibers that are positioned in interproximal regions 1306 of the dental appliance 1300. In some embodiments, the fiber network 1304 can be configured to decrease the width of one or more interproximal regions 1306 between the patient's teeth. For instance, when the dental appliance 1300 is worn on the patient's teeth, the fiber network 1304 may be stretched, e.g., as shown in the inset view in FIG. 13. The fiber network 1304 may be configured to resist the stretching to apply one or more repositioning forces on the patient's teeth, thereby decreasing the width of the one or more interproximal regions 1306. Alternatively, the fiber network 1304 may be configured to increase the width of one or more interproximal regions 1306 between the patient's teeth. For instance, the fiber network 1304 may be compressed when the dental appliance 1300 is worn on the patient's teeth, and the fiber network 1304 may be configured to resist the compression to apply one or more repositioning forces on the patient's teeth, thereby increasing the width of the one or more interproximal regions 1306.

FIGS. 14A and 14B illustrate another example dental appliance 1400 configured in accordance with embodiments of the present technology. Specifically, FIG. 14A is a side view of a dental appliance 1400, and FIG. 14B is a cross-sectional view of the dental appliance 1400 of FIG. 14A. The dental appliance 1400 can include a button 1402 extending from a sidewall 1404 of a tooth-receiving cavity, in accordance with embodiments of the present technology. The button 1402 can include a shaft 1406 extending from the sidewall 1404 of the dental appliance 1400 and terminating at a button head 1408. The shaft 1406 and button head 1408 are cantilevered out from the sidewall 1404 of the dental appliance and are shaped to receive an elastic 1410 that is used to exert tooth and/or jaw moving forces to the patient's arches. In some embodiments, the force imparted on the shaft 1406 by the elastic 1410 and the cantilevered structure of the shaft 1406 may cause increased loads at the base of the shaft 1406 and the sidewall 1404 of the dental appliance 1400. In addition, the shape of the post-dental appliance junction may also cause a stress concentration between the shaft 1406 and the sidewall 1404 of the tooth-receiving cavity of the dental appliance 1400.

In some embodiments, fibers 1412 are formed within the shaft 1406 and the sidewall 1404. The fibers 1412 may be configured to reinforce the dental appliance 1400, e.g., by increasing the stiffness, torsional rigidity, strength, tear resistance, creep resistance, and/or stability of the dental appliance 1400 in a particular direction or area. The fibers 1412 can have a first end within the shaft 1406 of the button 1402, extend through the junction between the shaft 1406 and the sidewall 1404, and terminate at a second end within the sidewall 1404 of the tooth-receiving cavity. First portions of the one or more fibers 1412 can extend parallel to each other along the length of the shaft 1406. Second portions of the one or more fibers 1412 may extend radially outward from the shaft 1406 within the sidewall 1404 of the tooth-receiving cavity.

In some embodiments, for example, as shown in FIG. 14B, the first end of a fiber 1412 may be located within the head 1408 of the button 1402. A first portion of the fiber 1412 can extend from the first end and radially inward towards the junction of the shaft 1406 with the head 1408. A second portion may extend parallel with the length of the shaft 1406 from the junction of the button 1402 to the junction with the sidewall 1404 of the tooth-receiving cavity. A third portion of the fiber 1412 can extend radially outward from the junction of the shaft 1406 within the sidewall 1404.

FIG. 14C illustrates a dental appliance 1420 having a hook 1422 extending from a sidewall 1424 of the tooth-receiving cavity, in accordance with embodiments of the present technology. The hook 1422 can include a shaft 1426 extending from the sidewall 1424 of the dental appliance 1420 and terminating at a tip 1428. The shaft 1426 and tip 1428 extend from the sidewall 1424 of the dental appliance 1420 and are shaped to receive an elastic that is used to exert tooth and/or jaw moving forces to the patient's arches. In some embodiments, the force imparted on the hook 1422 by the elastic may cause increased loads at the base of the shaft 1426 and the sidewall 1424 of the dental appliance 1420. In addition, the shape of the shaft-dental appliance junction may also cause a stress concentration between the shaft 1426 and the sidewall 1424 of the tooth-receiving cavity of the dental appliance 1420.

Fibers 1430 can be formed within the hook 1422 and the sidewall 1424 to reinforce the dental appliance 1420, e.g., by increasing the stiffness, torsional rigidity, strength, tear resistance, creep resistance, and/or stability of the dental appliance 1420 in a particular direction or area. The fibers 1430 can have a first end within the shaft 1426, extend through the junction between the shaft 1426 and the sidewall 1424, and can end at a second end within the sidewall 1424 of the tooth-receiving cavity. First portions of the one or more fibers 1430 can extend parallel to each other along the length of the shaft 1426. Second portions of the one or more fibers 1430 can extend radially outward from the shaft 1426 within the sidewall 1424 of the tooth-receiving cavity. In some embodiments, the fibers 1412 can extend from the tip 1428 of the hook 1422 through the shaft 1426, and into the sidewall 1424 of the tooth-receiving cavity. In some embodiments, the fibers 1430 follow the contour of the external surface of the hook 1422 and the sidewall 1424.

FIGS. 15A and 15B illustrate additional examples of dental appliances 1500 configured in accordance with embodiments of the present technology. Specifically, FIG. 15A is a top view of a dental appliance 1500 having mandibular advancement devices 1502, and FIG. 15B is a side view of two dental appliances 1500 with mandibular advancement devices 1502 worn on a patient's jaws with the jaws in occlusion with each other.

In some embodiments, the dental appliances 1500 are orthodontic aligners having mandibular advancement devices 1502 (also referred to herein as “mandibular advancement occlusal blocks” or “precision wings”). The mandibular advancement devices 1502 can function to advance the mandible of a patient over time, e.g., the upper mandibular advancement device 1502 pushes against the lower mandibular advancement device 1502 attached to the lower arch of the patient in order to reposition the patient's lower jaw or mandible to correct Class II malocclusions and/or treat sleep apnea. Large amounts of force may be applied to each of the mandibular advancement devices 1502. The forces may cause deformation and over time may potentially cause buckling and other undesirable deformations of the mandibular advancement devices 1502.

Fibers can be added to the mandibular advancement devices 1502 and/or the portions of the dental appliance 1500 adjacent to the mandibular advancement devices 1502 in order to provide added stiffness and durability. The fibers may also allow for increased forces to be transmitted between the upper and lower mandibular advancement devices 1502 as compared to such structures without fiber reinforcement. For example, FIG. 15A shows fibers 1504 in the lingual sidewalls of the mandibular advancement devices 1502. The fibers 1504 may be configured to reinforce the dental appliance 1500, e.g., by increasing the stiffness, torsional rigidity, strength, tear resistance, creep resistance, and/or stability of the dental appliance 1500 in a particular direction or area.

In some embodiments, the fibers 1504 extend along the mandibular advancement device 1502 and into the wall of the adjacent tooth receiving cavities. The fibers 1504 can have a greater stiffness and Young's modulus as compared to the polymer in the dental appliance 1500 and the mandibular advancement device 1502, which can result in reduced bending and deformation along the mandibular advancement device 1502. In some embodiments, the density of the fibers 1504 in the dental appliance 1500 can vary based on expected forces or other factors, such as to reduce and/or resist stress concentrations. For example, as shown in FIG. 15A, the fibers 1504 can be present in a greater volume fraction in the sidewalls of the mandibular advancement device 1502. In some embodiments, the volume fraction may be reduced as the fibers transition from the mandibular advancement device portion of the dental appliance 1500 into the tooth-receiving cavity walls of the dental appliance 1500. This arrangement may reduce and/or resist stress concentrations that may otherwise develop through the use of fibers 1504.

FIG. 15B shows fibers 1506 in the buccal sidewalls of the mandibular advancement devices 1502. For example, the fibers 1506 can include two or more fibers arranged parallel to each other. The fibers 1506, can extend from a gingival location of the mandibular advancement device 1502, across an occlusal plane of the patient's dentition, to a distal end of the mandibular advancement device 1502. Optionally, the fibers 1506 can extend beyond an occlusal surface of a patient's dentition or an occlusal surface of a tooth-receiving cavity proximate to the mandibular advancement device 1502. In some embodiments, a pair of dental appliances 1500 including an upper dental appliance for the patient's upper arch and a lower dental appliance for the patient's lower arch is provided. In such embodiments, each of the upper and lower dental appliances may include respective mandibular advancement devices 1502. Each of the mandibular advancement devices 1502 may include one or more fibers 1506.

FIG. 16 illustrates a portion of another example dental appliance 1600 configured in accordance with embodiments of the present technology. The dental appliance 1600 can include a shell 1602 having a plurality of tooth-receiving cavities shaped to receive a patient's teeth, and one or more fibers 1604 coupled to the shell 1602. The fibers 1604 may be configured to reinforce the dental appliance 1600, e.g., by increasing the stiffness, torsional rigidity, strength, tear resistance, creep resistance, and/or stability of the dental appliance 1600 in a particular direction or area.

In some embodiments, the shell 1602 includes a ridge 1606 (e.g., a power ridge) that is indented inward toward a tooth received by the shell 1602. The ridge 1606 can be configured to apply local forces to the tooth when the dental appliance 1600 is worn by the patient. For instance, the ridge 1606 may be configured to contact the tooth to cause the tooth to tilt and/or rotate in a desired direction when the dental appliance 1600 is worn by the patient. In some embodiments, the fibers 1604 are positioned in and/or near the ridge 1606 to reinforce the ridge 1606. This can have the effect of increased force localization at the ridge 1606, provide more resilient repositioning forces onto the patient's teeth, and/or improve the moment-to-force ratio.

FIG. 17 illustrates another example dental appliance 1700 configured in accordance with embodiments of the present technology. The dental appliance 1700 can include a shell 1702 having a plurality of tooth-receiving cavities shaped to receive a patient's teeth, and a fiber 1704 coupled to the shell 1702. The fibers 1704 may be configured to reinforce the dental appliance 1700, e.g., by increasing the stiffness, torsional rigidity, strength, tear resistance, creep resistance, and/or stability of the dental appliance 1700 in a particular direction or area.

In some embodiments, the dental appliance 1700 includes a bite adjustment structure 1706. The bite adjustment structure 1706 can be a projection such as a bite ramp and/or a bite plane coupled to the shell, and the bite adjustment structure 1706 can be configured to at least partially separate the patient's dental arches. In some embodiments, the fiber 1704 is positioned in and/or near the bite adjustment structure 1706 to reinforce the bite adjustment structure 1706. This can have the effect of increased strength, torsional rigidity, and/or stiffness at the bite adjustment structure 1706, and/or to provide more resilient separation forces on the patient's dental arches.

FIGS. 18A-18E illustrate an example attachment placement appliance 1800 configured in accordance with embodiments of the present technology. Referring first to FIG. 18A, the dental attachment placement appliance 1800 may be configured to position one or more attachments 1802 on one or more tooth surfaces 1804 of a patient's dentition 1806. The attachments 1802 can be configured to engage a dental appliance (e.g., an aligner, retainer, or palatal expander) to apply forces to the dentition 1806, as described elsewhere herein.

In some embodiments, the attachment placement appliance 1800 includes a frame 1808 configured to extend over at least a portion of patient's dentition 1806. The frame 1808 may be a solid structure that follows the shape of the patient's dentition 1806. The frame 1808 can be coupled to a plurality of supports 1810, and the attachments 1802 may be coupled to the plurality of supports 1810. In some embodiments, the attachments 1802 are frangibly coupled to the supports 1810, such that the attachments 1802 can be detached from the attachment placement appliance 1800, for example, after the attachments 1802 are affixed to the tooth surface. Removal of the attachments 1802 from the supports 1810 may be achieved by fracturing the attachments 1802 from the supports 1810.

Optionally, the frame 1808 may include one or more registration anchors 1816 that extend from the frame 1808 and that include contact surfaces that register with corresponding one or more teeth. At least some of the registration anchors 1816 can be coupled to the supports 1810 such that when the contact surfaces of the registration anchors 1816 register with corresponding teeth, the attachments 1802 can also register with the corresponding tooth surfaces. In some cases, the registration anchor contact surface is contoured to complement the undulations and/or grooves of a corresponding surface of one or more teeth. The contoured surface may be adapted to complement the surfaces of any type of one or more teeth, such as one or more incisors, canines, premolars, and molars. The contoured surface may be adapted to complement any side of a tooth, such as one or more lingual, occlusal, buccal, and distal tooth surfaces. In some embodiments, the registration anchor 1816 may at least partially encapsulate an incisal edge of a tooth. The registration anchor 1816 may extend over more than one side of a tooth, such as portions of the top (e.g., crown), buccal and/or lingual sides of the corresponding tooth.

Turning now to FIGS. 18B-18E, an attachment 1802 may be coupled to a support 1810 at an interface region 1812. The attachment 1802, support 1810, and interface region 1812 may be configured such that fracturing preferentially occurs at the interface region 1812, rather than at the attachment 1802 or at portions of the support 1810 further away from the attachment 1802. This may be advantageous to avoid damaging the attachment 1802 and/or to provide a clean break with little or no residue on the attachment 1802 that needs to be removed. For instance, as shown in FIG. 18B, in some embodiments, both the attachment 1802 and the support 1810 are reinforced with fibers 1814, whereas the interface region 1812 does not include any fibers. This may create a “weak zone” in the interface region 1812, and the interface region 1812 may be easily breakable in response to force applied to the attachment 1802 and/or the support 1810. Alternatively, as shown in FIG. 18C, in some embodiments, the support 1810 is reinforced with fibers 1814, whereas the interface region 1812 and the attachment 1802 do not include fibers. Alternatively, as shown in FIG. 18D, in some embodiments, the attachment 1802 is reinforced with fibers 1814, whereas the interface region 1812 and the support 1810 do not include fibers. Alternatively, as shown in FIG. 18E, in some embodiments, the interface region 1812 is reinforced with fibers 1814, whereas the support 1810 and the attachment 1802 do not include fibers. Due to the increase in strength in the interface region 1812 compared to the support 1810, the support 1810 can be fractured adjacent to the interface region 1812 when sufficiently large tensile stresses are applied. In any of these embodiments, the registration anchors 1816 connected to the supports 1810 may optionally be reinforced with fibers (not shown), e.g., to provide a stable base for separation of the attachments 1802 from the supports 1810.

FIG. 19A illustrates an example dental appliance 1900 configured in accordance with embodiments of the present technology. The dental appliance 1900 can include a shell 1902 having a plurality of tooth-receiving cavities shaped to receive a patient's teeth, and one or more fibers 1904. The fibers 1904 may be configured to reinforce the dental appliance 1900, e.g., by increasing the stiffness, torsional rigidity, strength, tear resistance, creep resistance, and/or stability of the dental appliance 1900 in a particular direction or area.

In some embodiments, the dental appliance 1900 includes a projection 1906. The projection 1906 can include a hook or similar structure that is configured to bear a load (e.g., from elastics, wires, etc.). In some embodiments, the projection 1906 extends from a buccal surface 1908 of the shell 1902, as shown. Alternatively or in combination, the projection 1906 can extend from a lingual surface 1910 of the shell 1902, and/or an occlusal surface 1912 of the shell 1902. One or more fibers 1904 can be positioned within and/or on the projection 1906 to reinforce the projection 1906. For instance, the fibers 1904 can be oriented in a direction substantially perpendicular to the bending direction of the projection 1906 when loaded, thereby reducing the amount of deformation of the projection 1906.

FIG. 19B illustrates another example of a projection 1914 that can be included in the dental appliance 1900. Similar to the projection 1906 of FIG. 19A, the projection 1914 can be a hook or similar structure that is configured to bear a load (e.g., from elastics, wires, etc.), except that the projection 1914 has a rounded, wider shape compared to the projection 1914. One or more fibers 1916 can be positioned within and/or on the projection 1914 to reinforce the projection 1914. For instance, the fibers 1916 can be oriented in a direction substantially perpendicular to the bending direction of the projection 1914 when loaded, thereby reducing the amount of deformation of the projection 1914.

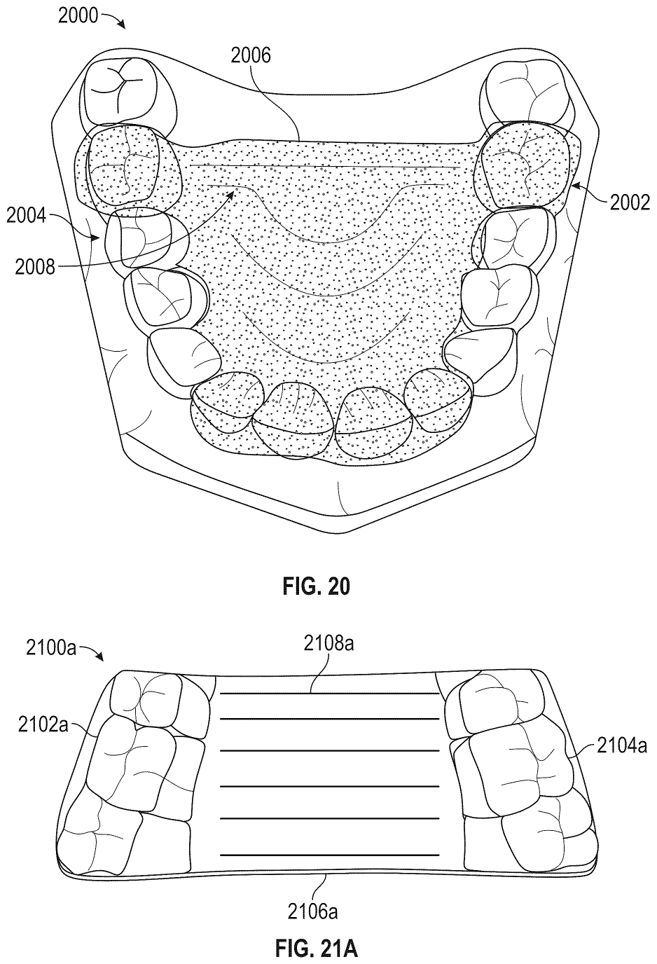

FIG. 20 illustrates an example dental appliance 2000 configured in accordance with embodiments of the present technology. In some embodiments, the dental appliance 2000 includes a first tooth engagement portion 2002 configured to receive one or more first teeth of a patient, a second tooth engagement portion 2004 configured to receive one or more second teeth of a patient, and a palatal portion 2006 between the first and second tooth engagement portions. In some embodiments, the dental appliance 2000 is a palatal expander that can be configured to exert a palatal expansion force on the patient's dental arches to cause expansion of the patient's palate. Alternatively, the dental appliance 2000 can be a palatal retainer configured to maintain the patient's palate at a target width (e.g., the target width to be achieved by a palatal expansion treatment plan). The dental appliance 2000 can be worn during any stage of a palatal expansion treatment plan, such as during palatal expansion or after the patient's palate has been expanded to a target width by a series of palatal expanders. In embodiments where the dental appliance 2000 is a palatal retainer, the palatal retainer may have the same or similar geometry as the final palatal expander of the treatment plan.

As illustrated, the first tooth engagement portion 2002 and the second tooth engagement portion 2004 may be configured to receive one or more posterior teeth of the patient's dentition. For example, each of the first tooth engagement portion 2002 and the second tooth engagement portion 2004 may include a tooth-receiving cavity for anchoring respective molar teeth and two tooth-receiving cavities for anchoring respective central and lateral incisors. The palatal portion 2006 may be configured to cover the patient's palate and span from the right side of the patient's arch to the left side of the patient's arch. The first tooth engagement portion 2002, the second tooth engagement portion 2004, and the palatal portion 2006 may be fabricated from predominantly polymeric material, e.g., in accordance with embodiments of the present technology.

In some embodiments, the dental appliance 2000 further includes one or more fibers 2008. The fibers 2008 may be positioned in or on the palatal portion 2006. For instance, the one or more fibers 2008 may extend across the patient's palate between the first tooth engagement portion 2002 and the second tooth engagement portion 2004. The fibers 2008 may be used to reinforce the palatal portion 2006. This may be advantageous, for example, to enhance the expansion or retention forces of the dental appliance 2000, e.g., by increasing or inhibiting movement of the patient's palate. Additionally or alternatively, the fibers 2008 may be positioned in or on one or more of the first tooth engagement portion 2002 or the second tooth engagement portion 2004. This may be advantageous, for example, to enhance the anchoring forces of the dental appliance 2000 on the patient's dentition.

The fibers 2008 may span a single layer of the dental appliance 2000, or may span a plurality of layers of the dental appliance 2000. For instance, the fibers 2008 may span multiple layers of the palatal portion 2006 of the dental appliance 2000. In some embodiments, the fibers 2008 may be contained entirely within the internal volume of the palatal portion 2006 and/or the first and second tooth engagement portions 2002, 2004, thus reducing or avoiding direct contact of the fibers 2008 with the patient's palate that may lead to pressure ulcers, patient discomfort, and/or other medical issues.

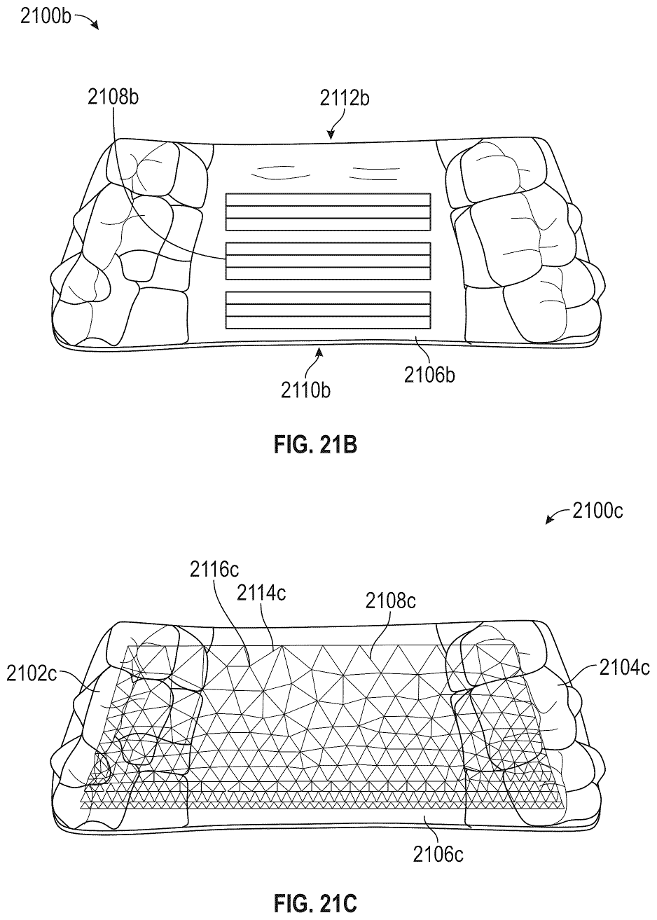

FIGS. 21A-21C illustrate example palatal expanders configured in accordance with embodiments of the present technology. Specifically, FIG. 21A illustrates a first palatal expander 2100a, FIG. 21B illustrates a second palatal expander 2100b, and FIG. 21C illustrates a third palatal expander 2100c. Referring to FIGS. 21A-21C collectively, the palatal expanders 2100a, 2100b, and 2100c can each be configured to exert a palatal expansion force on a patient's dental arch to cause expansion of the patient's palate. Expanding the size of the patient's palate can provide more room for the movement and positioning of the patient's teeth to alleviate crowding and other orthodontic issues.

Referring first to FIG. 21A, the first palatal expander 2100a can be a polymeric dental appliance having a first tooth engagement portion 2102a, a second tooth engagement portion 2104a, and a palatal portion 2106a between the first tooth engagement portion 2102a and the second tooth engagement portion 2104a. The first tooth engagement portion 2102a can be configured to receive one or more teeth at a first side of a patient's dental arch, and the second tooth engagement portion 2104a can be configured to receive one or more teeth at a second side of a patient's dental arch. In some embodiments, the first tooth engagement portion 2102a and the second tooth engagement portion 2104a are configured to receive some or all of the patient's posterior teeth, such as one or more molars and/or premolars. For example, the teeth received by the first tooth engagement portion 2102a and the second tooth engagement portion 2104a may be the three distalmost teeth on each side of the patient's dental arch.

The palatal portion 2106a can be configured to cover the patient's palate and span from the right side of the patient's arch to the left side of the patient's arch. The palatal portion 2106a can be fabricated from a predominantly polymer material, in accordance with embodiments of the present technology. In some embodiments, the palatal portion 2106a can be fabricated to include one or more fibers 2108a. For instance, the fibers 2108a may be configured to reinforce the first palatal expander 2100a, e.g., by increasing the stiffness, torsional rigidity, strength, tear resistance, creep resistance, and/or stability of the first palatal expander 2100a in a particular direction or area.

In some embodiments, the fibers 2108a are positioned in or on the palatal portion 2106a. For instance, the one or more fibers 2108a may extend across the patient's palate between the first tooth engagement portion 2102a and the second tooth engagement portion 2104a. The fibers may be used to reinforce the palatal portion 2106a. This may be advantageous, for example, to increase the expansion forces of the first palatal expander 2100a. Additionally or alternatively, the fibers 2108a may be positioned in or on one or more of the first tooth engagement portion 2102a or the second tooth engagement portion 2104a. This may be advantageous, for example, to increase the expansion forces of the first palatal expander 2100a on the patient's palate.

In some embodiments, the fibers 2108a are a plurality of continuous fibers 2108a that span the palatal portion 2106a, and the plurality of continuous fibers 2108a are parallel to one another. The plurality of continuous fibers 2108a may be positioned in a direction from the first engagement portion 2102a toward the second engagement portion 2104a, transverse from the midline of the patient's dentition. The plurality of continuous fibers 2108a can be spaced apart by any suitable distance, such as 2 mm, 5 mm, 10 mm, 20 mm, etc. In other embodiments, however, the plurality of continuous fibers 2108a may be angled relative to each other. For instance, some or all of the plurality of continuous fibers 2108a may extend in different directions, e.g., in the direction from the first engagement portion 2102a toward the second engagement portion 2104a as shown, in the anterior-posterior direction, in the mesial-distal direction, etc.

Referring next to FIG. 21B, the second palatal expander 2100b can be generally similar to the first palatal expander 2100a of FIG. 21A, except that the second palatal expander 2100b includes a plurality of fiber bundles 2108b. The plurality of fiber bundles 2108b may vary in one or more of fiber length, fiber diameter, amount of fibers, overall thickness, overall width, fiber material, or fiber properties (e.g., modulus, stress relaxation, strength, refractive index). In some embodiments, it may be desirable to have larger fiber bundles 2108b in a posterior region 2110b of the palatal portion 2106b and smaller fiber bundles 2108b in an anterior region 2112b of the palatal portion 2106b, since the posterior region 2110b may be configured to apply greater expansion forces than the anterior region 2112b. In other embodiments, however, the second palatal expander 2100b may include larger fiber bundles 2108b near the anterior region 2112b and smaller fiber bundles 2108b in the posterior region 2110b, or any other suitable configuration. Additionally or alternatively, some or all of the fiber bundles 2108b may have the same size as one another.

Referring next to FIG. 21C, the third palatal expander 2100c can be generally similar to the first palatal expander 2100a of FIG. 21A and the second palatal expander 2100b of FIG. 21B, except that the third palatal expander 2100c includes a fiber lattice structure 2108c. In some embodiments, the fiber lattice structure 2108c extends throughout the palatal portion 2106c from the first engagement portion 2102c to the second tooth engagement portion 2104c. The fiber lattice structure 2108c can be a 2D lattice including a plurality of 2D polygons formed from three or more edges 2114c joined at three or more vertices 2116c. For example, the 2D fiber lattice structure of FIG. 21C includes a plurality of triangular elements each having three edges 2114c and three vertices 2116c. Each vertex 2116c within the interior of the fiber lattice structure 2108c connects to six edges 2114c of six adjacent triangular lattice elements. Each edge 2114c of each triangular element is shared with an adjacent triangular element. Optionally, while the fiber lattice structure 2108c is depicted as a 2D lattice, the fiber lattice structure 2108c may alternatively be a 3D lattice extending through a plurality of layers of the palatal portion 2106c. The fiber lattice structure 2108c may be configured to strengthen the palatal portion 2106c, and/or provide increased expansion forces to the patient's palate.

For dental appliances that exhibit strong directionality, such as palatal expanders, fibers may only be present in the transpalatal arch area perpendicular to the sagittal plane, in some embodiments, e.g., as illustrated in 21A and 21B. Given that not all the transpalatal arch area may be on the same plane, for some layers or regions of the transpalatal arch, shorter fibers may be used. In some examples, it may be desirable to have transverse stiffness, in which case fibers may be selectively placed to avoid the crown area, such that they can easily flare open for easy appliance insertion and removal.

FIG. 22 illustrates another example dental appliance 2200 configured in accordance with embodiments of the present technology. The dental appliance 2200 can include a shell 2202 including a plurality of cavities 2203 for receiving a patient's teeth, and one or more fibers 2204 coupled to the shell. The fibers 2204 may be configured to reinforce the dental appliance 2200, e.g., by increasing the stiffness, torsional rigidity, strength, tear resistance, creep resistance, and/or stability of the dental appliance 2200 in a particular direction or area. The fibers 2204 may include fibers that are parallel to one another, fibers that are interwoven to form a lattice, and/or any other suitable arrangement of fibers. For example, the dental appliance 2200 can include fibers 2204 in some or all of the cavities 2203 that extend parallel to each other along a mesial-distal direction, e.g., to provide reinforcement while allow the tooth-receiving cavities 2203 to easily flare open in a buccal-lingual direction for easy insertion and removal of the dental appliance 2200. In some embodiments, the shell 2202 includes a palatal portion 2206, and fibers 2204 are positioned within or on the palatal portion 2206 in an interwoven configuration to enhance the stiffness of the palatal portion 2206.

In some embodiments, the shell 2202 includes one or more cutouts 2208. The cutouts 2208 may be configured to expose regions of the patient's dentition that are not intended to be treated by the dental appliance 2200 and/or be directly affected by a dental treatment (e.g., teeth that do not need to be repositioned, teeth that have been previously corrected, teeth that will be extracted, and/or teeth that will be treated separately). Thus, the cutouts 2208 may make it easier to place the dental appliance 2200 on the patient's dentition, since not all teeth need to be received within the shell 2202. As illustrated in FIG. 22, the cutouts 2208 may span one or more of the patient's pre-molars, molars, and/or canines on both sides of the dental arch, such that these teeth are exposed and do not directly receive forces from the dental appliance 2200. In other embodiments, however, the cutouts 2208 span one or more different teeth of the patient's dental arch. For instance, the cutouts 2208 may span the patient's incisors. In some embodiments, the fibers 2204 are positioned within or on the shell 2202 in regions adjacent to the cutouts 2208 (e.g., regions that are mesial, distal, and/or lingual to the cutouts 2208). This can advantageously improve the stiffness of the shell 2202, since the presence of the cutouts 2208 might otherwise render the shell 2202 too flexible for effective force application.

FIG. 23 illustrates another example dental appliance 2300 configured in accordance with embodiments of the present technology. The dental appliance 2300 can be generally similar to the dental appliance 2200 of FIG. 22, except that the shell 2302 of the dental appliance 2300 extends over the teeth without covering the palate of the patient. In some embodiments, the shell 2302 includes one or more cutouts 2306 that are configured to expose regions of the patient's dentition that are not intended to be treated by the dental appliance 2300 and/or be directly affected by a dental treatment (e.g., teeth that do not need to be repositioned, teeth that have been previously corrected, teeth that will be extracted, and/or teeth that will be treated separately). One or more fibers 2304 can be positioned within or on the shell 2302 in regions adjacent to the cutouts 2306 (e.g., regions that are mesial, distal, and/or lingual to the cutouts 2306) to reinforce the dental appliance 2300. In some embodiments, the fibers 2304 include interwoven fibers 2304 adjacent to the cutouts 2306 to increase the stiffness of the regions adjacent to the cutouts 2306, and parallel fibers 2304 at other locations of the shell 2302, e.g., proximate to the tooth-receiving cavities to allow the dental appliance 2300 to easily flare open for easy insertion and removal.

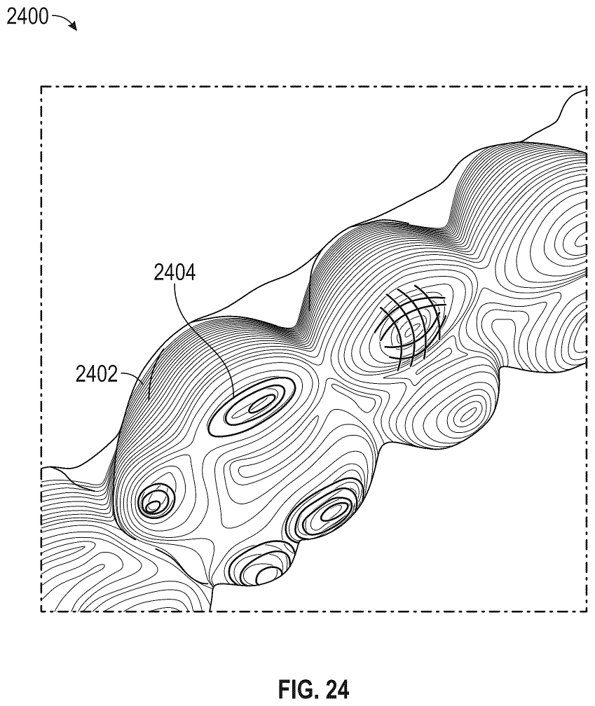

FIG. 24 illustrates a portion of another example dental appliance 2400 configured in accordance with embodiments of the present technology. The dental appliance 2400 can include a shell 2402 and one or more fibers 2404 positioned in or near an occlusal surface 2406 of the dental appliance 2400. As illustrated, the fibers 2404 can be positioned over or near molar cusps of the dental appliance 2400. However, the fibers 2404 may alternatively or additionally be positioned elsewhere on the occlusal surface 2406, such as over or near grooves, incisal edges, etc. In some embodiments, the fibers 2404 are configured to provide abrasion resistance to the dental appliance 2400. For instance, the fibers 2404 may improve the local hardness and/or strength of the dental appliance 2400 near biting surfaces, such that when the patient bites and/or grinds their teeth, the dental appliance 2400 is configured to withstand those forces without significant deformation and/or wear.

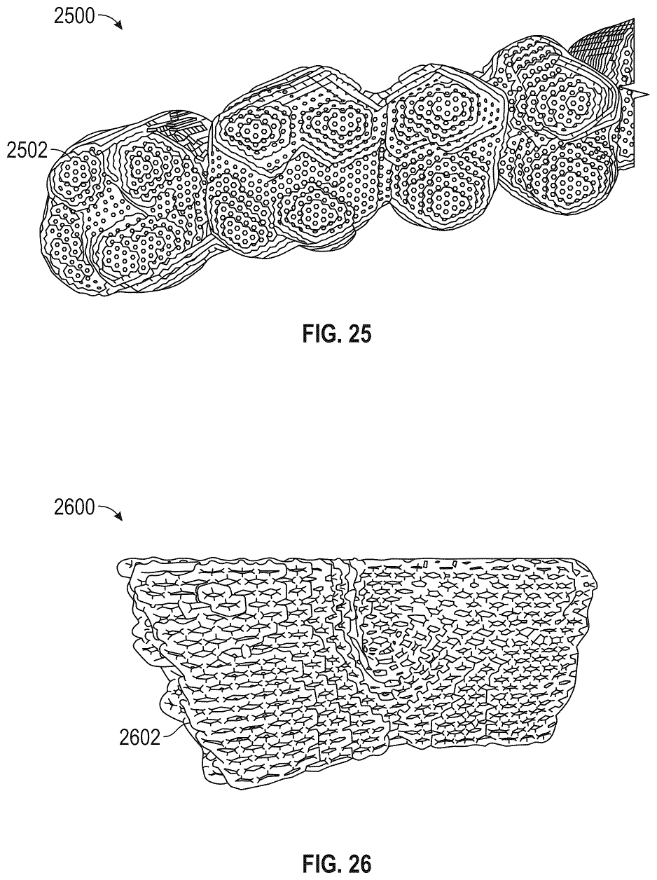

FIG. 25 illustrates a portion of an example dental appliance 2500 configured in accordance with embodiments of the present technology. In some embodiments, the dental appliance 2500 is or includes a cellular structure 2502 (e.g., a mesh, lattice, network) composed of a plurality of fibers. The fibers may be interconnected and/or interwoven to form the cellular structure 2502. The cellular structure 2502 may provide stiffness, torsional rigidity, strength, tear resistance, creep resistance, and/or stability to the dental appliance 2500. In some embodiments, the cellular structure 2502 spans the entirety of the dental appliance 2500. Alternatively, however, the cellular structure 2502 may span only certain portions of the dental appliance 2500, e.g., portions of the dental appliance 2500 that are configured to exert one or more forces on a patient's teeth when the dental appliance 2500 is worn by the patient. Further, the cellular structure 2502 may be homogenous (e.g., having the same strut thickness, pore size, material, and/or density) or heterogenous (e.g., having different strut thicknesses, pore sizes, materials, and/or density).

FIG. 26 illustrates an example palatal expander 2600 configured in accordance with embodiments of the present technology. In some embodiments, the palatal expander 2600 is formed of a cellular material 2602. The cellular material 2602 can be generally similar to the cellular structure 2502 of the dental appliance 2500 of FIG. 25. The cellular material 2602 may be or include one or more fibers configured to provide stiffness, torsional rigidity, strength, tear resistance, creep resistance, and/or stability to the palatal expander 2600. In some embodiments, the cellular material 2602 spans the entirety of the palatal expander 2600. Alternatively, however, the cellular material 2602 may span only certain portions of the palatal expander 2600, e.g., the palatal portion only, tooth engagement portions only, and/or other suitable portions. In some embodiments, the palatal portion of the palatal expander 2600 may be stiffer than tooth-engagement portions, or vice versa.

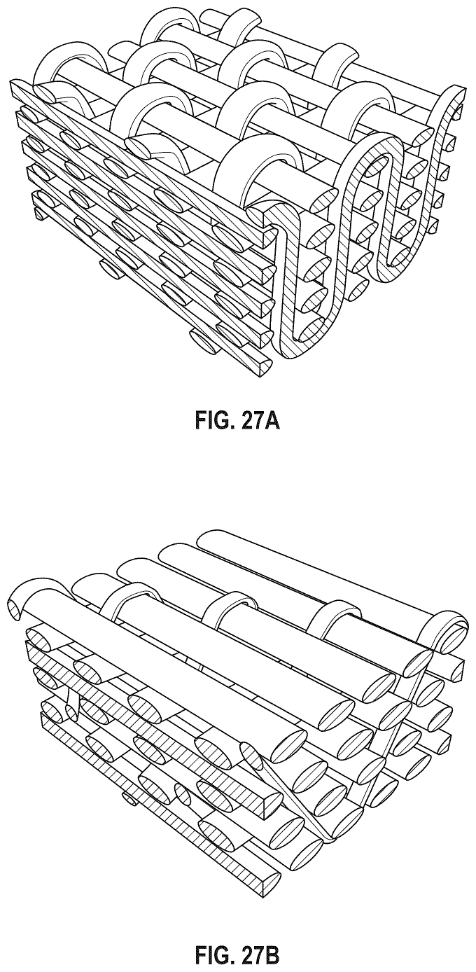

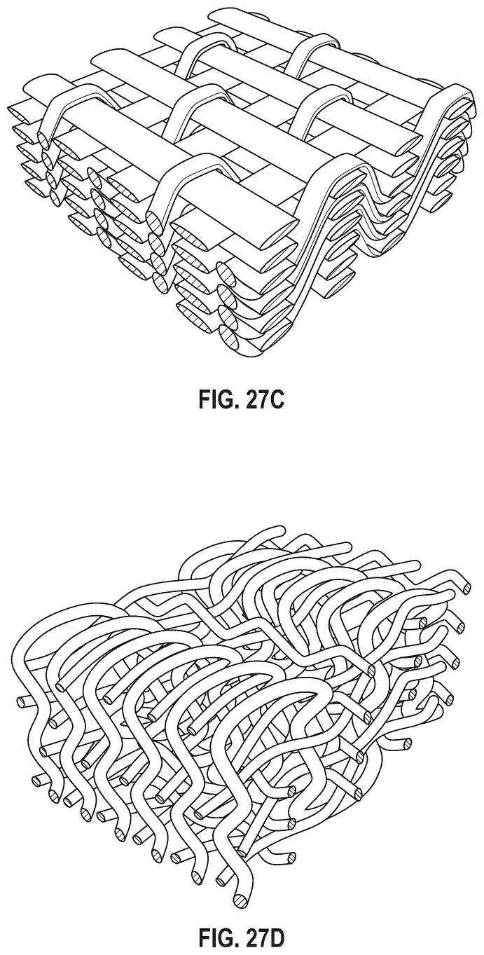

In embodiments where a dental appliance includes a cellular structure (e.g., the dental appliances of FIGS. 25 and 26), the cellular structure can be composed of a plurality of fibers that are interwoven and/or physically entangled with each other to form 2D and/or 3D structures, rather than being bonded and/or cross-linked to each other. For example, FIGS. 27A-27D illustrate examples of 3D structures composed of a plurality of interwoven fibers, in accordance with embodiments of the present technology. Various types of weaving patterns can be used, such as an orthogonal weave (FIG. 27A), a through-the-thickness angle interlock weave (FIG. 27B), a layer-to-layer angle interlock weave (FIG. 27C), and a fully interlaced weave (FIG. 27D). Such interwoven geometries may be achieved using multiple fiber systems that concurrently or sequentially deposit multiple fibers. Each fiber system may be independently movable (e.g., rotatable) to produce complex weave patterns.

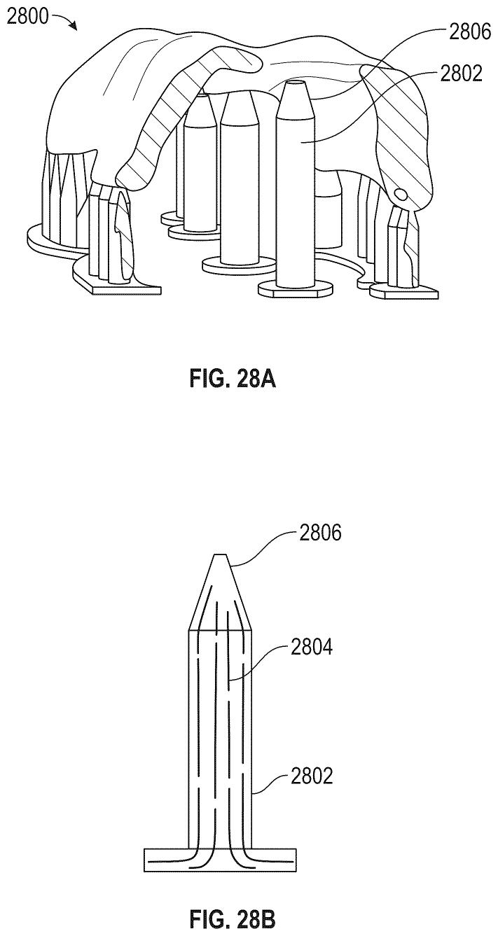

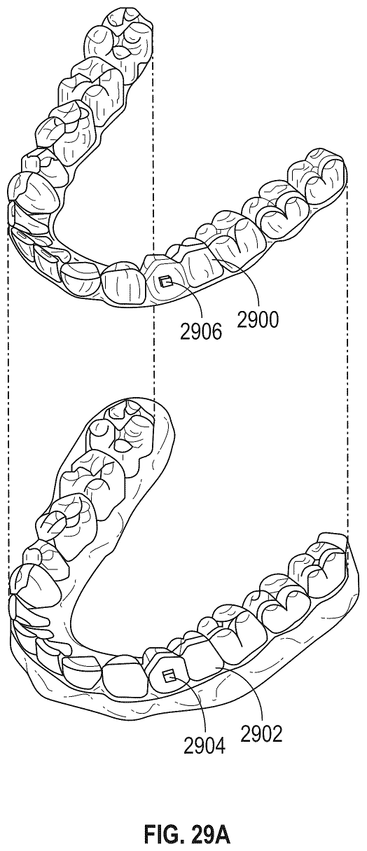

FIG. 28A illustrates an example dental appliance 2800 coupled to a plurality of support structures 2802 configured in accordance with embodiments of the present technology. In some embodiments, the dental appliance 2800 and the plurality of support structures 2802 are fabricated in the same additive manufacturing process, with the support structures 2802 being used to stabilize the dental appliance 2800 during fabrication. After fabrication, it may be desirable to remove the dental appliance 2800 from the plurality of support structures 2802. However, conventional support structures may easily fracture and/or break apart at undesired locations, leaving portions of the support structure attached to the dental appliance. Accordingly, it may be desirable to selectively reinforce the support structures 2802 to ensure that support structures 2802 fracture at the correct location, e.g., at or near the interface region 2806 between the dental appliance 2800 and the support structures 2802.

FIG. 28B is a close-up view of the support structures 2802 of FIG. 28A. As illustrated, the support structures 2802 may include a plurality of fibers 2804. The fibers 2804 may provide stiffness, torsional rigidity, strength, tear resistance, creep resistance, and/or stability to the support structures 2802. As shown in FIG. 28B, the fibers 2804 may terminate at or before the interface regions 2806 of the support structures 2802. This may provide preferential fracturing of the support structures 2802 at the interface regions 2806, rather than at a portion of the dental appliance 2800 or elsewhere in the support structure 2802. Alternatively, the entirety of the support structures 2802 including the interface regions 2806 may include fibers 2804, which may be beneficial for improving stability of the support structures 2802 and avoiding inadvertent fracture during manufacturing, particularly for taller and/or thinner support structures 2802.

Although certain embodiments of the present technology are described herein with respect to the use of fibers for mechanical reinforcement of additively manufactured objects such as dental appliances, this is not intended to be limiting, and the fibers described herein may alternatively or additionally be used for other purposes. For example, optically transparent fibers such as glass fibers can be used as a conduit for transmission of optical signals to and/or from devices coupled to the object, such as sensors (e.g., an electronic compliance indicator (ECI), imaging device). Moreover, optically transparent fibers may be used to direct light to target tissues for therapeutic purposes, e.g., optical emission of light from a light source (e.g., light-emitting diode (LED)) to certain soft tissues in the oral cavity may enhance bone remodeling.

### III. Additional Examples of Dental Appliances and Associated Methods

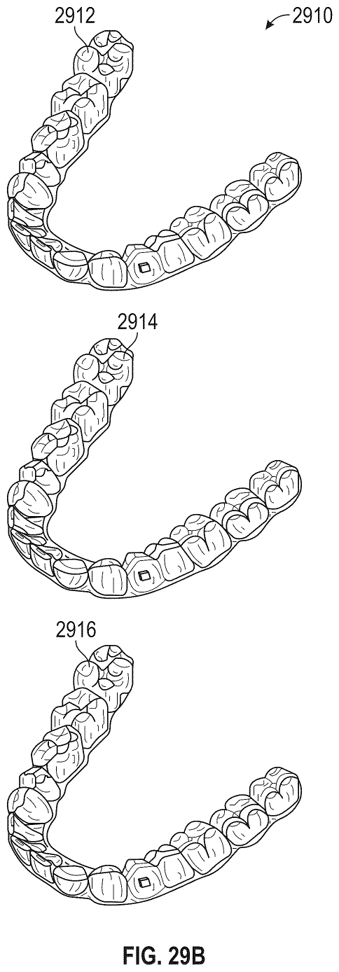

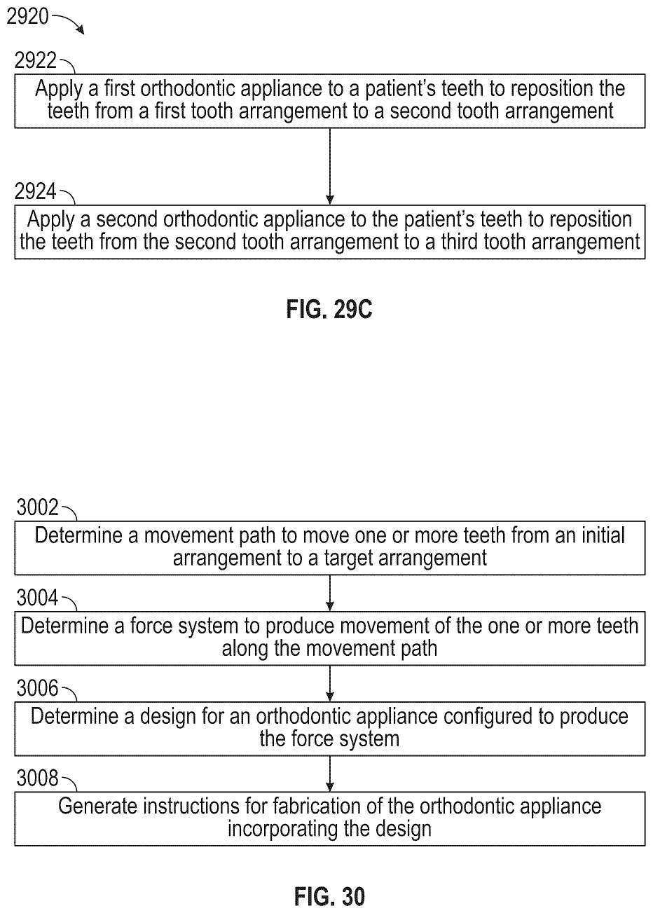

FIG. 29A illustrates a representative example of a tooth repositioning appliance 2900 configured in accordance with embodiments of the present technology. The appliance 2900 can be manufactured using any of the systems, methods, and devices described herein. The appliance 2900 (also referred to herein as an “aligner”) can be worn by a patient in order to achieve an incremental repositioning of individual teeth 2902 in the jaw. The appliance 2900 can include a shell (e.g., a continuous polymeric shell or a segmented shell) having teeth-receiving cavities that receive and resiliently reposition the teeth. The appliance 2900 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 2900 can fit over all teeth present in an upper or lower jaw, or less than all of the teeth. The appliance 2900 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 2900 can be a generic appliance configured to receive the teeth, but not necessarily shaped to match the topography of the patient's teeth. In some cases, only certain teeth received by the appliance 2900 are repositioned by the appliance 2900 while other teeth can provide a base or anchor region for holding the appliance 2900 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 2900 in place over the teeth. In some cases, however, it may be desirable or necessary to provide individual attachments 2904 or other anchoring elements on teeth 2902 with corresponding receptacles 2906 or apertures in the appliance 2900 so that the appliance 2900 can apply a selected force on the tooth. Representative examples of appliances, including those utilized in the Invisalign® System, are described in numerous patents and patent applications assigned to Align Technology, Inc. including, for example, in U.S. Pat. Nos. 6,450,2907, and 5,975,2993, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 62,930,450.

FIG. 29B illustrates a tooth repositioning system 2910 including a plurality of appliances 2912, 2914, 2916, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 2910 can include a first appliance 2912 corresponding to an initial tooth arrangement, one or more intermediate appliances 2914 corresponding to one or more intermediate arrangements, and a final appliance 2916 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 29C illustrates a method 2920 of orthodontic treatment using a plurality of appliances, in accordance with embodiments of the present technology. The method 2920 can be practiced using any of the appliances or appliance sets described herein. In block 2922, a first orthodontic appliance is applied to a patient's teeth in order to reposition the teeth from a first tooth arrangement to a second tooth arrangement. In block 2924, a second orthodontic appliance is applied to the patient's teeth in order to reposition the teeth from the second tooth arrangement to a third tooth arrangement. The method 2920 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 30 illustrates a method 3000 for designing an orthodontic appliance, in accordance with embodiments of the present technology. The method 3000 can be applied to any embodiment of the orthodontic appliances described herein. Some or all of the steps of the method 3000 can be performed by any suitable data processing system or device, e.g., one or more processors configured with suitable instructions.

In block 3002, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 3004, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 3004 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 3006, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 3008, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 3000 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 3000 may be performed with any suitable fabrication system or device, such as the embodiments described herein. Some of the steps may be optional, e.g., the process of block 3004 can be omitted, such that the orthodontic appliance is designed based on the desired tooth movements and/or determined tooth movement path, rather than based on a force system. Moreover, the order of the steps can be varied as desired.

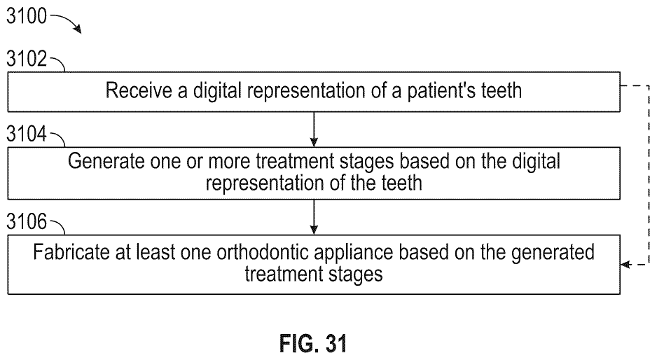

FIG. 31 illustrates a method 3100 for digitally planning an orthodontic treatment and/or design or fabrication of an appliance, in accordance with embodiments. The method 3100 can be applied to any of the treatment procedures described herein and can be performed by any suitable data processing system.

In block 3102, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 3104, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 3106, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 31, design and/or fabrication of an orthodontic appliance, and perhaps a particular orthodontic treatment, may include use of a representation of the patient's teeth (e.g., including receiving a digital representation of the patient's teeth (block 3102)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The present technology is further illustrated by the following non-limiting examples.

### Example 1: Fiber Reinforced Objects

This example demonstrates the improved material properties of objects reinforced with fibers.

Coupons composed of a photopolymerized resin with varying amount of bioglass fiber content (0 vol %, 10 vol %, 15 vol %, 17 vol %, 25 vol %, 31 vol %, and 35 vol %) were fabricated and tested. The bioglass fibers were composed of 50% SiO₂, 4% P₂O₅, 0.2% B₂O₃, 5.9% Na₂O, 12% K₂O, 22.6% CaO, and 5.3% MgO. Each of the coupons were subjected to a 3-point bending test at room temperature under dry conditions. Fiber-containing coupons were oriented so that the longitudinal axes of the fibers were perpendicular to the load direction.

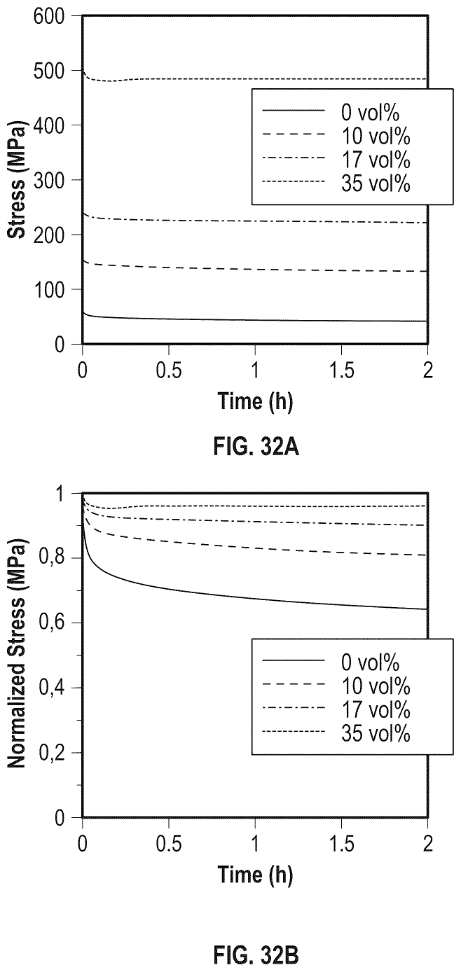

FIGS. 32A and 32B are graphs illustrating the stress relaxation of coupons (e.g., sample portions of dental appliances) having varying fiber content. Referring first to FIG. 32A, the measured stress within the coupon increased with increasing fiber content, thus indicating that the high fiber content coupons were stronger and able to sustain high bending loads more effectively than the lower fiber content coupons. Referring next to FIG. 32B, creep resistance increased with increasing fiber content, with higher fiber content coupons exhibiting a smaller drop in normalized stress over time compared to the low fiber content coupons.

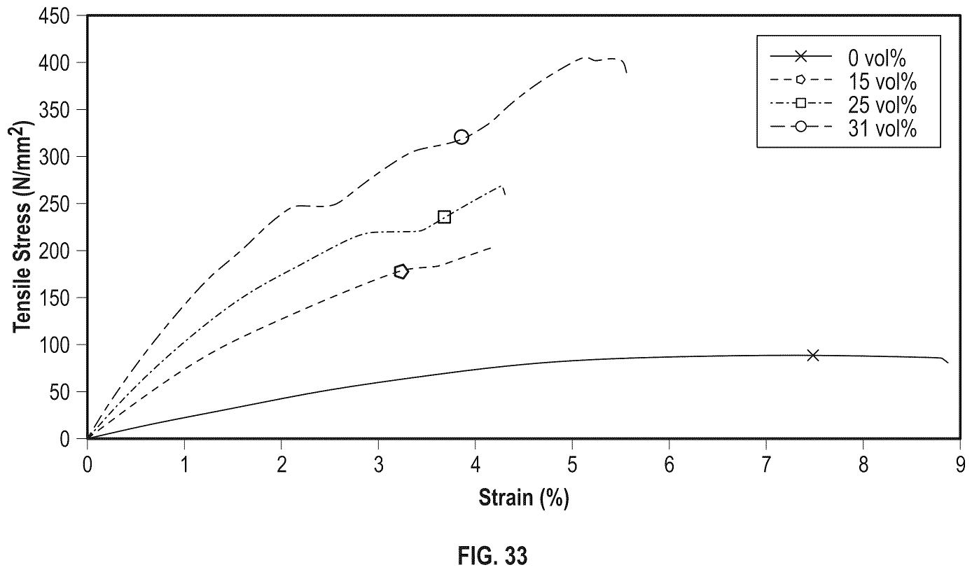

FIG. 33 is a graph illustrating the stress-strain response of coupons having varying fiber content. As illustrated, coupons with higher fiber content were stiffer than coupons with lower fiber content, as evidenced by the steeper slope of the stress-strain curves.

These results indicate that fiber reinforcement is an effective technique for improving the stiffness and creep resistance of materials used in additive manufacturing.

### ADDITIONAL EXAMPLES

The following examples are included to further describe some aspects of the present technology, and should not be used to limit the scope of the technology.

Example 1. A system for additive manufacturing, the system comprising:
a material source configured to deposit a curable material;
a first energy source configured to apply first energy to the curable material to form an object portion on a build platform;
a fiber source configured to deposit a fiber onto or into the object portion; and
a second energy source configured to apply second energy to affix the fiber to the object portion.

Example 2. The system of Example 1, wherein the fiber source comprises a nozzle configured to deposit the fiber onto or into the object portion.

Example 3. The system of Example 2, wherein the nozzle comprises a channel for depositing the fiber, the channel being angled relative to a surface of the build platform.

Example 4. The system of Example 2 or 3, wherein the second energy source is configured to output the second energy at or proximate to an outlet of the nozzle.

Example 5. The system of any one of Examples 2 to 4, wherein the nozzle is configured to move relative to the build platform to deposit the fiber in a plurality of locations onto or into the object portion.

Example 6. The system of Example 5, wherein the plurality of locations includes an upper surface of the object portion.

Example 7. The system of Example 5 or 6, wherein the plurality of locations includes a lateral surface of the object portion.

Example 8. The system of any one of Examples 2 to 7, further comprising a cutting element proximate to the nozzle, wherein the cutting element is configured to cut the fiber.

Example 9. The system of any one of Examples 1 to 8, wherein the object portion is at least partially cured before the fiber is deposited onto or into the object portion.

Example 10. The system of any one of Examples 1 to 9, wherein the fiber is deposited together with a second curable material.

Example 11. The system of Example 10, wherein the second curable material is the same as the curable material.

Example 12. The system of Example 10, wherein the second curable material is different than the curable material.

Example 13. The system of any one of Examples 10 to 12, wherein the second energy is configured to cure the second curable material to affix the fiber to the object portion.

Example 14. The system of any one of Examples 1 to 13, wherein the fiber is a continuous fiber.

Example 15. The system of any one of Examples 1 to 14, wherein the fiber comprises one or more biocompatible glass fibers.

Example 16. The system of any one of Examples 1 to 15, wherein the fiber has a diameter of less than or equal to 1000 microns.

Example 17. The system of any one of Examples 1 to 16, wherein the build platform is stationary, and wherein the first energy source is part of a printer assembly that is movable relative to the build platform.

Example 18. The system of Example 17, wherein the printer assembly comprises a carrier film, and wherein the material source is configured to deposit the curable material on the carrier film.

Example 19. The system of Example 17 or 18, wherein the fiber source and the second energy source are coupled to the printer assembly.

Example 20. The system of Example 17 or 18, wherein the fiber source and the second energy source are separate from the printer assembly.

Example 21. The system of any one of Examples 1 to 20, further comprising a transport mechanism configured to transport the build platform between the material source and the fiber source.

Example 22. The system of any one of Examples 1 to 21, wherein at least one of the first energy or the second energy comprises light energy.

Example 23. The system of any one of Examples 1 to 22, wherein the curable material comprises a photopolymerizable resin.

Example 24. The system of any one of Examples 1 to 23, wherein the curable material has a viscosity in the range of 0.05 Pa·s to 100 Pa·s at a temperature within a range from 20° C. to 160° C., 40° C. to 140° C., or from 50° C. to 120° C.

Example 25. The system of any one of Examples 1 to 24, wherein the object portion is a portion of a dental appliance.

Example 26. The system of Example 25, wherein the dental appliance is an aligner, a retainer, or a palatal expander.

Example 27. The system of Example 25 or 26, wherein the fiber is enclosed within an internal volume of the dental appliance.

Example 28. The system of Example 25 or 26, wherein the fiber is located on an external surface of the dental appliance.

Example 29. The system of any one of Examples 25 to 28, wherein the portion of the dental appliance is configured to apply a force to one or more teeth.

Example 30. A method comprising:
depositing a curable material;
applying first energy to the curable material to form an object portion on a build platform;
depositing a fiber onto or into the object portion; and
applying second energy to the fiber to affix the fiber to the object portion.

Example 31. The method of Example 30, wherein the fiber is deposited onto or into the object portion via a nozzle.

Example 32. The method of Example 31, wherein the nozzle comprises a channel for depositing the fiber, the channel being angled relative to a surface of the build platform.

Example 33. The method of Example 31 or 32, further comprising outputting the second energy at or proximate to an outlet of the nozzle.

Example 34. The method of any one of Examples 31 to 33, further comprising moving the nozzle relative to the build platform to deposit the fiber in a plurality of locations onto or into the object portion.

Example 35. The method of Example 34, wherein the plurality of locations includes an upper surface of the object portion.

Example 36. The method of Example 34 or 35, wherein the plurality of locations includes a lateral surface of the object portion.

Example 37. The method of any one of Examples 30 to 36, further comprising cutting the fiber.

Example 38. The method of any one of Examples 30 to 37, wherein the object portion is at least partially cured before the fiber is deposited onto or into the object portion.

Example 39. The method of any one of Examples 30 to 38, wherein the fiber is deposited together with a second curable material.

Example 40. The method of Example 39, wherein the second curable material is the same as the curable material.

Example 41. The method of Example 39, wherein the second curable material is different than the curable material.

Example 42. The method of any one of Examples 39 to 41, wherein the second energy is configured to cure the second curable material to affix the fiber to the object portion.

Example 43. The method of any one of Examples 30 to 42, wherein the fiber is a continuous fiber.

Example 44. The method of any one of Examples 30 to 43, wherein the fiber comprises one or more biocompatible glass fibers.

Example 45. The method of any one of Examples 30 to 44, wherein the fiber has a diameter of less than or equal to 1000 microns.

Example 46. The method of any one of Examples 30 to 45, wherein at least one of the first energy or the second energy comprises light energy.

Example 47. The method of any one of Examples 30 to 46, wherein the curable material comprises a photopolymerizable resin.

Example 48. The method of any one of Examples 30 to 47, wherein the curable material has a viscosity in the range of 0.05 Pa·s to 100 Pa·s at a temperature within a range from 20° C. to 160° C., 40° C. to 140° C., or from 50° C. to 120° C.

Example 49. The method of any one of Examples 30 to 48, wherein the object portion is a portion of a dental appliance.

Example 50. The method of Example 49, wherein the dental appliance is an aligner, a retainer, or a palatal expander.

Example 51. The method of Example 49 or 50, wherein the fiber is enclosed within an internal volume of the dental appliance.

Example 52. The method of Example 49 or 50, wherein the fiber is located on an external surface of the dental appliance.

Example 53. The method of any one of Examples 49 to 52, wherein the portion of the dental appliance is configured to apply a force to one or more teeth.

Example 53.1. The method of any one of Examples 30 to 53, wherein the fiber is deposited after the first energy is applied to the curable material.

Example 53.2. The method of any one of Examples 30 to 53.1, wherein the first energy and the second energy are applied from the same energy source.

Example 53.3. The method of any one of Examples 30 to 53.2, wherein the first energy and the second energy comprise the same wavelength.

Example 54. A dental appliance formed according to the method of any one of Examples 30 to 53.3.

Example 55. A dental appliance comprising:
a shell composed of a plurality of additively manufactured polymer layers, wherein the shell comprises a plurality of cavities shaped to receive a patient's dentition; and
a fiber coupled to a portion of the shell to reinforce the portion, wherein the fiber comprises a desired length, and wherein the fiber is composed of a material that is optically transparent and biocompatible.

Example 56. The dental appliance of Example 55, wherein the desired length exceeds a predetermined length.

Example 57. The dental appliance of Example 55 or 56, wherein the desired length exceeds a predetermined length to effectively strengthen or stiffen a material matrix of the portion of the shell.

Example 58. The dental appliance of any one of Examples 55 to 57, wherein the desired length exceeds a predetermined length, and the predetermined length is based on a tensile strength of the fiber, a diameter of the fiber, a shear strength between the fiber and a material matrix of the portion of the shell, or a combination thereof.

Example 59. The dental appliance of any one of Examples 55 to 58, wherein the desired length exceeds a predetermined length, and the predetermined length is based on a product of a tensile strength of the fiber and a diameter of the fiber.

Example 60. The dental appliance of any one of Examples 55 to 59, wherein the desired length exceeds a predetermined length, and the predetermined length is based on a ratio of a tensile strength of the fiber and a shear strength between the fiber and a material matrix of the portion of the shell, a diameter of the fiber and the shear strength between the fiber and the material matrix of the portion of the shell, or a combination thereof.

Example 61. The dental appliance of any one of Examples 55 to 60, wherein the desired length exceeds 1 mm, 2 mm, 3 mm, 4 mm, 5 mm, 6 mm, 7 mm, 8 mm, 9 mm, or 10 mm.

Example 62. The dental appliance of any one of Examples 55 to 61, wherein the portion of the shell has a material matrix composed of the plurality of additively manufactured polymer layers.

Example 63. The dental appliance of any one of Examples 55 to 62, wherein the fiber comprises a conformal fiber following one or more geometrical contours of the portion of the dental appliance.

Example 64. The dental appliance of any one of Examples 55 to 63, wherein the length of the fiber is greater than or equal to 10 mm.

Example 65. The dental appliance of any one of Examples 55 to 64, wherein the dental appliance does not include any fibers having a length less than or equal to 1 mm.

Example 66. The dental appliance of any one of Examples 55 to 65, wherein the material comprises a biocompatible glass.

Example 67. The dental appliance of any one of Examples 55 to 66, wherein the material is biodegradable.

Example 68. The dental appliance of any one of Examples 55 to 67, wherein the fiber comprises a diameter less than or equal to 400 microns.

Example 69. The dental appliance of Example 68, wherein the fiber comprises a diameter within a range from 5 microns to 25 microns.

Example 70. The dental appliance of any one of Examples 55 to 69, wherein the shell comprises a polymeric material, and wherein the fiber and the polymeric material have the same or a similar refractive index.

Example 71. The dental appliance of any one of Examples 55 to 70, wherein the fiber is positioned at or near a gingival edge of the shell.

Example 72. The dental appliance of any one of Examples 55 to 71, wherein the fiber is positioned at or near one or more cavities that receive one or more canines or lateral incisors of the patient's dentition.

Example 73. The dental appliance of any one of Examples 55 to 72, wherein the fiber is positioned at or near an interproximal region of the shell.

Example 74. The dental appliance of any one of Examples 55 to 73, wherein the fiber is positioned at or near a palatal portion of the shell.

Example 75. The dental appliance of any one of Examples 55 to 74, wherein the fiber is positioned at or near a posterior portion of the shell.

Example 76. The dental appliance of any one of Examples 55 to 75, wherein the fiber is positioned at or near an anterior portion of the shell.

Example 77. The dental appliance of any one of Examples 55 to 76, wherein the fiber is positioned at or near an attachment, precision cut, button, hook, precision wing, occlusal block, power ridge, or bite ramp of the shell.

Example 78. The dental appliance of any one of Examples 55 to 77, wherein the fiber is one of a plurality of fibers coupled to the shell.

Example 79. The dental appliance of Example 78, wherein the plurality of fibers are substantially parallel with each other.

Example 80. The dental appliance of Example 78, wherein the plurality of fibers are interwoven with each other.

Example 81. The dental appliance of any one of Examples 55 to 80, wherein the fiber is enclosed within an internal volume of the shell.

Example 82. The dental appliance of any one of Examples 55 to 80, wherein the fiber is located on an external surface of the shell.

Example 83. The dental appliance of Example 82, wherein the fiber is located on an occlusal surface of the shell.

Example 84. The dental appliance of Example 82, wherein the fiber is located on a buccal surface of the shell.

Example 85. The dental appliance of Example 82, wherein the fiber is located on a lingual surface of the shell.

Example 86. The dental appliance of any one of Examples 55 to 85, wherein the shell comprises a second portion that does not include any fiber.

Example 87. The dental appliance of Example 86, wherein the fiber is configured to increase one or more of stiffness, torsional rigidity, strength, durability, stress relaxation resistance, tear resistance, creep resistance, or abrasion resistance of the portion of the shell relative to the second portion of the shell.

Example 88. The dental appliance of any one of Examples 55 to 87, wherein the dental appliance is an aligner, retainer, palatal expander, or attachment placement device.

Example 89. The dental appliance of any one of Examples 55 to 88, wherein the plurality of additively manufactured layers comprises a plurality of cured resin layers.

Example 90. The dental appliance of any one of Examples 55 to 89, wherein the cavities are configured to reposition the patient's dentition from a first arrangement toward a second arrangement.

Example 91. The dental appliance of any one of Examples 55 to 90, wherein the cavities are configured to maintain a current tooth arrangement of the patient's dentition.

Example 92. A method comprising:
fabricating a plurality of additive manufacturing layers to form a portion of an appliance shell, wherein the appliance shell comprises a plurality of cavities shaped to receive a patient's dentition; and
fabricating a fiber coupled to a portion of the shell to reinforce the portion, wherein the fiber comprises a desired length, and wherein the fiber is composed of a material that is optically transparent and biocompatible.

Example 93. The method of Example 92, further comprising determining the desired length.

Example 94. The method of Example 92 or 93, further comprising:
identifying a predetermined length to effectively strengthen or stiffen a material matrix of the portion of the shell, and
using the predetermined length as a minimum value to identify the desired length.

Example 95. The method of Example 92 or 93, further comprising:
identifying a predetermined length, wherein the predetermined length is based on a tensile strength of the fiber, a diameter of the fiber, a shear strength between the fiber and a material matrix of the portion of the shell, or a combination thereof, and
using the predetermined length to identify the desired length.

Example 96. The method of Example 92 or 93, further comprising:
identifying a predetermined length, wherein the predetermined length is based on a product of a tensile strength of the fiber and a diameter of the fiber, and
using the predetermined length to identify the desired length.

Example 97. The method of Example 92 or 93, further comprising:
identifying a predetermined length, wherein the predetermined length is based on: a ratio of a tensile strength of the fiber and a shear strength between the fiber and a material matrix of the portion of the shell, a diameter of the fiber and the shear strength between the fiber and the material matrix of the portion of the shell, or some combination thereof; and
using the predetermined length to identify the desired length.

Example 98. The method of any one of Examples 92 to 97, wherein the desired length exceeds 1 millimeter mm, 2 mm, 3 mm, 4 mm, 5 mm, 6 mm, 7 mm, 8 mm, 9 mm, or 10 mm.

Example 99. The method of any one of Examples 92 to 98, wherein the portion of the shell has a material matrix composed of the plurality of additively manufactured polymer layers.

Example 100. The method of any one of Examples 92 to 99, further comprising:
identifying one or more geometrical contours of the portion of the shell, and
depositing the fiber in conformal fiber filaments that follow the contours of the portion of the shell.

Example 101. The method of any one of Examples 92 to 100, wherein the fiber comprises a conformal fiber pattern that follows one or more geometrical contours of the portion of the shell.

Example 102. The method of any one of Examples 92 to 101, wherein the length of the fiber is greater than or equal to 10 mm.

Example 103. The method of any one of Examples 92 to 102, wherein the shell and the fiber are part of a dental appliance, and wherein the dental appliance does not include any fibers having a length less than or equal to 1 mm.

Example 104. The method of any one of Examples 92 to 103, wherein the material comprises a biocompatible glass.

Example 105. The method of any one of Examples 92 to 104, wherein the material is biodegradable.

Example 106. The method of any one of Examples 92 to 105, wherein the fiber comprises a diameter less than or equal to 400 microns.

Example 107. The method of Example 106, wherein the fiber comprises a diameter within a range from 5 microns to 25 microns.

Example 108. The method of any one of Examples 92 to 107, wherein the shell comprises a polymeric material, and wherein the fiber and the polymeric material have the same or a similar refractive index.

Example 109. The method of any one of Examples 92 to 108, wherein the fiber is positioned at or near a gingival edge of the shell.

Example 110. The method of any one of Examples 92 to 109, wherein the fiber is positioned at or near one or more cavities that receive one or more canines or lateral incisors of the patient's dentition.

Example 111. The method of any one of Examples 92 to 110, wherein the fiber is positioned at or near an interproximal region of the shell.

Example 112. The method of any one of Examples 92 to 111, wherein the fiber is positioned at or near a palatal portion of the shell.

Example 113. The method of any one of Examples 92 to 112, wherein the fiber is positioned at or near a posterior portion of the shell.

Example 114. The method of any one of Examples 92 to 113, wherein the fiber is positioned at or near an anterior portion of the shell.

Example 115. The method of any one of Examples 92 to 114, wherein the fiber is positioned at or near an attachment, precision cut, button, hook, precision wing, occlusal block, power ridge, or bite ramp of the shell.

Example 116. The method of any one of Examples 92 to 115, further comprising fabricating an additional fiber substantially parallel to the fiber.

Example 117. The method of any one of Examples 92 to 116, further comprising fabricating an additional fiber interwoven with the fiber.

Example 118. The method of any one of Examples 92 to 117, wherein the fiber is enclosed within an internal volume of the shell.

Example 119. The method of any one of Examples 92 to 118, wherein the fiber is located on an external surface of the shell.

Example 120. The method of Example 119, wherein the fiber is located on an occlusal surface of the shell.

Example 121. The method of Example 119, wherein the fiber is located on a buccal surface of the shell.

Example 122. The method of Example 119, wherein the fiber is located on a lingual surface of the shell.

Example 123. The method of any one of Examples 92 to 122, wherein the shell comprises a second portion that does not include any fiber.

Example 124. The method of Example 123, wherein the fiber is configured to increase one or more of stiffness, torsional rigidity, strength, durability, stress relaxation resistance, tear resistance, creep resistance, or abrasion resistance of the portion of the shell relative to the second portion of the shell.

Example 125. The method of any one of Examples 92 to 124, wherein the shell and the fiber are part of an aligner, retainer, palatal expander, or attachment placement device.

Example 126. The method of any one of Examples 92 to 125, wherein fabricating the shell comprises fabricating the shell from a plurality of resin layers.

Example 127. The method of any one of Examples 92 to 126, wherein the cavities are configured to reposition the patient's dentition from a first arrangement toward a second arrangement.

Example 128. The method of any one of Examples 92 to 127, wherein the cavities are configured to maintain a current tooth arrangement of the patient's dentition.

Example 129. The method of any one of Examples 92 to 128, wherein the additive manufacturing process comprises applying energy to a curable material in a layer-by-layer manner to form the shell from a plurality of additively manufactured layers.

Example 130. The method of Example 129, wherein the plurality of additively manufactured layers comprise a series of sequentially photopolymerized layers.

Example 131. The method of Example 129 or 130, wherein the curable material comprises a photopolymerizable resin.

Example 132. The method of any one of Examples 129 to 131, wherein the curable material has a viscosity in the range of 0.05 Pa·s to 100 Pa·s at a temperature within a range from 20° C. to 160° C., 40° C. to 140° C., or from 50° C. to 120° C.

Example 133. A dental appliance comprising:
a shell composed of a plurality of additively manufactured polymer layers, wherein the shell comprises a plurality of cavities shaped to receive a patient's dentition; and
a plurality of transparent fibers coupled to a portion of the shell to reinforce the portion, wherein:
   each of the plurality of transparent fibers comprise a desired length,
   each of the plurality of transparent fibers is composed of a material that is optically transparent and biocompatible,
   the plurality of transparent fibers comprises a conformal fiber pattern that follows one or more geometrical contours of the portion of the dental appliance,
   the desired length exceeds a predetermined length, and
   the predetermined length is based on a ratio of a tensile strength of the fiber and a shear strength between the fiber and a material matrix of the portion of the shell, a diameter of the fiber and the shear strength between the fiber and the material matrix of the portion of the shell, or a combination thereof.

Example 134. A method comprising:
identifying a predetermined length for a fiber, wherein the predetermined length is based on: a ratio of a tensile strength of the fiber and a shear strength between the fiber and a material matrix of a polymer, a diameter of the fiber and the shear strength between the fiber and the material matrix of the polymer, or a combination thereof; using the predetermined length to identify a desired length for the fiber within a dental appliance;
fabricating a plurality of additive manufacturing layers from the polymer to form an appliance shell from the polymer, wherein the appliance shell comprises a plurality of cavities shaped to receive a patient's dentition; and
fabricating from the fiber a plurality of transparent fibers in a conformal fiber pattern that follows one or more geometrical contours of the portion of the dental appliance, wherein:
   the plurality of transparent fibers are coupled to a portion of the shell to reinforce the portion;
   each of the plurality of transparent fibers comprise the desired length,
   each of the plurality of transparent fibers is composed of a material that is optically transparent and biocompatible; and
   the plurality of transparent fibers comprises a conformal fiber pattern following one or more geometrical contours of the portion of the dental appliance.

Example 135. A method comprising:
depositing a curable material;
applying first energy to the curable material to form an object portion on a build platform;
depositing a fiber onto or into the object portion, wherein the fiber is optically transparent and biocompatible; and
applying second energy to the fiber to affix the fiber to the object portion.

Example 136. The method of Example 135, wherein the fiber is deposited onto or into the object portion via a nozzle.

Example 137. The method of Example 136, wherein the nozzle comprises a channel for depositing the fiber, the channel being angled relative to a surface of the build platform.

Example 138. The method of any one of Examples 135 to 137, further comprising cutting the fiber.

Example 139. The method of any one of Examples 135 to 138, wherein the fiber is deposited onto or into an upper surface of the object portion.

Example 140. The method of any one of Examples 135 to 139, wherein the fiber is deposited onto or into a lateral surface of the object portion.

Example 141. The method of any one of Examples 135 to 140, further comprising depositing the fiber together with a second curable material.

Example 142. The method of any one of Examples 135 to 141, wherein the fiber comprises one or more continuous biocompatible glass fibers.

Example 143. The method of any one of Examples 135 to 142, wherein the fiber has a diameter of less than or equal to 1000 microns.

Example 144. The method of any one of Examples 135 to 143, wherein the object portion is a portion of a dental appliance.

Example 145. A system for additive manufacturing, the system comprising:
a material source configured to deposit a curable material;
a first energy source configured to apply first energy to the curable material to form an object portion on a build platform;
a fiber source configured to deposit a fiber onto or into the object portion, wherein the fiber is optically transparent and biocompatible; and
a second energy source configured to apply second energy to affix the fiber to the object portion.

Example 146. The system of Example 145, wherein the fiber source comprises a nozzle configured to deposit the fiber onto or into the object portion.

Example 147. The system of Example 146, wherein the nozzle comprises a channel for depositing the fiber, the channel being angled relative to a surface of the build platform.

Example 148. The system of Example 146 or 147, further comprising a cutting element proximate to the nozzle, wherein the cutting element is configured to cut the fiber.

Example 149. The system of any one of Examples 145 to 148, wherein the fiber is deposited onto or into an upper surface of the object portion.

Example 150. The system of any one of Examples 145 to 149, wherein the fiber is deposited onto or into a lateral surface of the object portion.

Example 151. The system of any one of Examples 145 to 150, wherein the fiber comprises one or more continuous biocompatible glass fibers.

Example 152. The system of any one of Examples 145 to 151, wherein the fiber has a diameter of less than or equal to 1000 microns.

Example 153. The system of any one of Examples 145 to 152, wherein the object portion is a portion of a dental appliance.

Example 154. A dental appliance comprising:
a shell composed of a plurality of additively manufactured polymer layers, wherein the shell comprises a plurality of cavities shaped to receive a patient's dentition; and a fiber coupled to a portion of the shell to reinforce the portion, wherein the fiber comprises a desired length, and wherein the fiber is composed of a material that is optically transparent and biocompatible.

### CONCLUSION

Although many of the embodiments are described above with respect to systems, devices, and methods for fabrication of dental appliances, the technology is applicable to other applications and/or other approaches, such as fabrication of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-33.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
depositing a curable material;
applying first energy to the curable material to form an object portion on a build platform;
depositing a fiber onto or into the object portion, wherein the fiber is optically transparent and biocompatible; and
applying second energy to the fiber to affix the fiber to the object portion.

2. The method of claim 1, wherein the fiber is deposited onto or into the object portion via a nozzle.

3. The method of claim 2, wherein the nozzle comprises a channel for depositing the fiber, the channel being angled relative to a surface of the build platform.

4. The method of claim 1, further comprising cutting the fiber.

5. The method of claim 1, wherein the fiber is deposited onto or into an upper surface of the object portion.

6. The method of claim 1, wherein the fiber is deposited onto or into a lateral surface of the object portion.

7. The method of claim 1, further comprising depositing the fiber together with a second curable material.

8. The method of claim 1, wherein the fiber comprises one or more continuous biocompatible glass fibers.

9. The method of claim 1, wherein the fiber has a diameter of less than or equal to 1000 microns.

10. The method of claim 1, wherein the object portion is a portion of a dental appliance.

11. A system for additive manufacturing, the system comprising:
a material source configured to deposit a curable material;
a first energy source configured to apply first energy to the curable material to form an object portion on a build platform;
a fiber source configured to deposit a fiber onto or into the object portion, wherein the fiber is optically transparent and biocompatible; and
a second energy source configured to apply second energy to affix the fiber to the object portion.

12. The system of claim 11, wherein the fiber source comprises a nozzle configured to deposit the fiber onto or into the object portion.

13. The system of claim 12, wherein the nozzle comprises a channel for depositing the fiber, the channel being angled relative to a surface of the build platform.

14. The system of claim 12, further comprising a cutting element proximate to the nozzle, wherein the cutting element is configured to cut the fiber.

15. The system of claim 11, wherein the fiber is deposited onto or into an upper surface of the object portion.

16. The system of claim 11, wherein the fiber is deposited onto or into a lateral surface of the object portion.

17. The system of claim 11, wherein the fiber comprises one or more continuous biocompatible glass fibers.

18. The system of claim 11, wherein the fiber has a diameter of less than or equal to 1000 microns.

19. The system of claim 11, wherein the object portion is a portion of a dental appliance.

20. A dental appliance comprising:
a shell composed of a plurality of additively manufactured polymer layers, wherein the shell comprises a plurality of cavities shaped to receive a patient's dentition; and
a fiber coupled to a portion of the shell to reinforce the portion, wherein the fiber comprises a desired length, and wherein the fiber is composed of a material that is optically transparent and biocompatible.
